(19) United States
(12) Patent Application Publication
(10) Pub. No.: US 2021/0008541 A1
(43) Pub. Date: Jan. 14, 2021

(54) INSTRUMENT AND METHODS FOR AUTOMATED SAMPLE PREPARATION FOR MICROORGANISM IDENTIFICATION AND DIFFERENTIATION

(71) Applicant: Accelerate Diagnostics, Inc., Tucson, AZ (US)

(72) Inventors: Kevin Marshall, Tucson, AZ (US); Austin Ashby, Tucson, AZ (US); Josh Harrison, Tucson, AZ (US); Steven W. Metzger, Tucson, AZ (US); Wayne Showalter, Tucson, AZ (US); Erik Molina, Tucson, AZ (US); Jamie Roberson, Tucson, AZ (US)

(21) Appl. No.: 16/908,516

(22) Filed: Jun. 22, 2020

Related U.S. Application Data
(60) Provisional application No. 62/864,402, filed on Jun. 20, 2019.
(60) Provisional application No. 62/965,563, filed on Jan. 24, 2020.

(51) Int. Cl. B01L 3/02

(52) U.S. Cl. CPC B01L 3/021; B01L 2300/042; B01L 2200/04; B01L 2400/0409

(57) ABSTRACT

Systems and methods for automated biological sample preparation for use in rapid identification and antimicrobial susceptibility testing of microorganisms, such as bacteria and fungi, are provided.

### RELATED APPLICATIONS

This application claims the benefit of U.S. Provisional Patent Application Nos. 62/864,402, filed Jun. 20, 2019, and 62/965,563, filed Jan. 24, 2020, both of which are hereby incorporated by reference in their entirety.

### FIELD

This disclosure generally relates to microbial sample preparation.

### BACKGROUND

Patient samples, such as respiratory, urine, and wound exudate samples, are the primary biological starting point for assessing the etiology of a patient's disease and determining the appropriate therapy course for treating that disease. A key to reducing morbidity and mortality is initiating the proper therapeutic treatment of a critically ill patient at the appropriate dosage regimen as soon as possible. The historically weak link in this process is cultivation of a large enough microbial population to enable identification of pathogen(s) present and to determine which antimicrobial compounds the pathogen(s) will respond to therapy. To improve patient survival odds, it is crucial to reduce the assay time required to properly identify microorganism(s) in a patient sample and assess their drug sensitivity.

In many instances, patient samples contain multiple types of microorganisms, such as mixtures of bacteria from differing genera, species, and even strains. Samples containing more than one type of microorganism are also known as “polymicrobial” samples. Diagnostic accuracy is traditionally expressed in terms of sensitivity and specificity. Sensitivity may refer to the probability of assigning a diagnostic test as positive when it is in fact, positive (the true positive rate); specificity may refer to the rate of obtaining true negative test results (the true negative rate). Current methods of identifying unknown microorganisms are prone to failure in both false positive and false negative modes. These difficulties with sensitivity and specificity are typically fostered by factors that impede sample detection, such as noise, crosstalk, borderline resistance, and the like. Traditional analysis methods often trade sensitivity of detection for the specificity of microorganism identification. In other applications, the reverse is true, prioritizing sensitivity over accurate microorganism identification. But to maximize efficiency, and thus improve the odds of achieving a better treatment outcome for the patient, both sensitivity and specificity need to be enhanced in balance when using a rapid, automated testing system.

Traditional methods for identification (ID) and antimicrobial susceptibility testing (AST) of organisms from clinical specimens typically require overnight subculturing to isolate individual species prior to biochemical assay-based identification, followed by growing isolated organisms in the presence of various antimicrobials to determine susceptibilities. Molecular identification methods can provide organism identification in a few hours directly from clinical specimens as well as resistance marker detection, but these methods do not provide the antimicrobial susceptibility information required by clinicians to inform treatment decisions. Studies demonstrating the feasibility of using various sample types, including direct-from-patient whole blood and respiratory samples, have been reported, but sample preparation techniques require further refinement. Current rapid molecular-based diagnostic methods only report identification and genotypic resistance marker results. While available in a couple of hours, these results only provide a partial answer. This leaves the clinician to prescribe overly-broad spectrum empiric therapy while waiting two to four days for conventional antibiotic susceptibility test results before adjusting therapy. The availability of an antimicrobial susceptibility test result in five (5) hours or less, as opposed to a few days, could potentially decrease morbidity and mortality in critically ill patients due to delays in administration of appropriate therapy. In addition, rapid de-escalation from broad-spectrum empiric therapies to targeted, specific antimicrobials could assist antimicrobial stewardship efforts to decrease the emergence and spread of multi-drug resistant organisms (MDROs). But to truly achieve ID and AST workflow efficiencies, the preparation of samples subjected to these downstream tests must be improved.

Sample preparation is an important step in the process involved in fast and accurate identification and antimicrobial susceptibility assessment of patient infections. Direct-from-patient samples can be particularly difficult to work with, because they may contain debris, antibiotics from failed treatments, and other substances that may interfere with testing procedures. For example, respiratory samples such as bronchoalveolar lavage (BAL) or mini-BAL specimens can contain many different compounds, including—but not limited to—saline, lymphocytes, eosinophils, neutrophils, epithelial cells, bacterial cells, mucin, blood and the like that can impair microbial cell detection, identification, and growth by automated instrument systems. In addition, samples may contain drugs and antibiotics administered to a patient prior to sample collection that can further confound sample analysis. Given that respiratory specimens have a variety of viscosities and are comprised of many different compounds, a sample clean-up system is necessary to effectively prepare respiratory samples for further processing and analysis. Likewise, other patient specimen types may contain similar matter that may impair or otherwise confound their analysis.

### SUMMARY

An automated sample preparation system has been developed, which removes inhibitory substances from samples that would otherwise interfere with processing downstream in automated identification and/or antimicrobial susceptibility instruments. In certain implementations, the automated sample preparation system comprises integrated features that enable rapid, self-contained sample cleaning using centrifugation techniques. In some implementations, patient samples, such as respiratory samples, are manipulated by the automated sample preparation system to achieve, inter alia, optimal sample pelleting and resuspension, and sample viscosity normalization. The automated sample preparation system harnesses a capsule rotor design for optimal sample recovery. Testing of the automated sample preparation system identified a correlation between the optical density of a sample and its recovery upon the completion of sample manipulation. In certain implementations, the automated instrument is designed with safety in mind, such that the self-contained unit may be run outside of a biosafety cabinet. In other implementations, it also features as an internal standard allowing the user to assess sample loss during the preparation process.

Additionally, in some implementations, the modular design of the automated sample preparation system creates a platform for fluid exchange, providing a sample in a buffered solution that may be transferred to an automated sample analysis platform for analysis, such as the Accelerate Pheno™ system brand of automated microbial identification and antimicrobial susceptibility instrumentation. This allows for, inter alia, higher cell capture and retention with electrokinetic concentration (EKC) or other methodology used to immobilize bacteria during certain forms of sample analysis.

A manual spin and resuspension procedure, in which fluids are exchanged and inhibitory substances removed from a sample, is laborious and time-consuming. The automated sample preparation system described herein provides automated sample processing via a suite of features including an internal pipette, spindle drive with customizable speeds, software to allow for customizing an assay, as well as a disposable consumable kit and capsule rotor. This instrument system allows the user to load a capsule rotor and reagent cartridge, and thereafter begin an assay that cleans the sample and presents the sample to the user in a form ready for analysis. The user may then load the prepped sample into a sample analysis platform, such as a kit for use in an automated sample analysis system. Thus, the automated sample preparation system will greatly reduce the burden and complexity currently associated with working up respiratory or other specimens for clinical analysis in busy hospital and reference laboratories. Furthermore, this automated sample preparation instrument system will remove the variability associated with manual preparation that arises between individual operators or technicians.

Although various embodiments of an automated sample preparation system find use in processing respiratory samples, automated sample preparation systems disclosed herein has many potential uses. Such uses include—but are not limited to—processing of other sample types, concentrating bacteria in a variety of sample types such as blood, cerebral spinal fluid, wound fluid, saliva, and urine, and preparing samples that can be presented to various molecular diagnostic platforms for downstream analysis, such as MALDI-TOF mass spectroscopy systems.

In various embodiments, an automated sample preparation system is described. The automated sample preparation system comprises: (a) a centrifuge station having a capsule rotor seat shaped to receive a capsule rotor and to cause the capsule rotor to rotate at high speeds during centrifuging, the centrifuge station having a vertical common rotation axis and a chamber member that can be moved along the vertical common rotation axis to open and close an area surrounding the capsule rotor during centrifuging; (b) a rotatable stage having a reagent cartridge receiving area configured to receive a removable reagent cartridge, the rotatable stage being controllably rotatable independently of the capsule rotor seat about the vertical common rotation axis, wherein the reagent cartridge receiving area is positioned radially outward of the capsule rotor seat; (c) a pipettor unit having a base and a movable pipetting section, wherein the movable pipetting section is positioned above the rotatable stage such that the rotatable stage can be rotated to align the reagent cartridge receiving area below the movable pipetting section, wherein the movable pipetting section is controllably movable horizontally between at least first and second pipetting positions aligned above the reagent cartridge receiving area and the capsule rotor seat, respectively, wherein the movable pipetting section is further moveable vertically at the first and second pipetting positions to withdraw and deliver liquid; (d) a capper mechanism having a movable distal end that is controllably movable in a vertical direction along the vertical common rotation axis between a lowered position in which the movable distal end uncaps and recaps the capsule rotor and a raised position in which the movable distal end is raised to a height above the pipettor unit, wherein the capper mechanism has a movement mechanism for moving the movable distal end that is stationarily mounted at a position radially outward of the capsule rotor and the rotatable stage; and (e) a control circuit with a controller programmed to control operation of the centrifuge station, rotatable stage pipettor unit and capper mechanism during operation of the automated sample preparation system.

In various embodiments, the automated sample preparation system is adapted to receive a capsule rotor, wherein the capsule rotor is shaped to be received in the capsule rotor seat and has an opening at an upper end, through which reagent and/or sample can be received, and wherein the capsule rotor comprises an internal annular shelf

In various embodiments, the rotatable stage comprises a sample container receiving area positioned radially outward of the capsule rotor seat and configured to receive a removable sample container, and wherein the pipettor unit is controllably movable in the horizontal plane between a third pipetting position above the sample vial receiving area and the second pipetting position above the capsule rotor seat in sample transfer operations.

In various embodiments, the rotatable stage comprises a sample container receiving area positioned radially outward of the capsule rotor seat and configured to receive a removable sample container.

In various embodiments, the system, in addition to having a first capper mechanism for capping and uncapping the rotor capsule, further comprises a second capper mechanism configured to uncap and recap the sample container.

In various embodiments, the automated sample preparation system further comprises a reagent cartridge shaped to be received in the reagent cartridge receiving area of the rotatable stage, wherein the reagent cartridge comprises a plurality of reagent receiving wells having different reagents contained therein, and wherein at least some of the reagent wells are arranged in a circumferential pattern rotatable into alignment with the pipettor unit.

In various embodiments of the automated sample preparation system, the pipettor unit is further configured to controllably transfer waste liquid from the capsule rotor to a well on the reagent cartridge.

In various embodiments, the automated sample preparation system further comprises an arc-shaped door, wherein the arc-shaped door is movable from a closed position to an open position to allow an operator to access the capsule rotor seat and the rotatable stage.

In various embodiments, the movable pipetting section is movable horizontally by rotation about a vertical axis.

In various embodiments, the automated sample preparation system further comprises at least one of: a barcode reader configured to read a barcode of at least one of a sample container, a reagent cartridge and/or a capsule rotor; or an RFID tag reader/writer configured to read an RFID tag of at least one of the sample container, the reagent cartridge and/or the capsule rotor, and to re-write the RFID tag to indicate a change in status of the sample container, the reagent cartridge and/or the capsule rotor.

In various embodiments, the pipettor unit is configured for controllably ejecting a used pipette tip and automatically engaging a new pipette tip.

In various embodiments, the system further comprises a reagent cartridge having spaces for a new pipette tips and used pipette tips.

In various embodiments, the automated sample preparation system further comprises a controllably movable door having an open position providing an operator with access to the rotatable stage and the capsule rotor seat and a closed position providing a closed internal environment within the automated sample preparation system.

In various embodiments, the automated sample preparation system further comprises an air filter for removing contaminants from air in the internal environment before the air is exhausted outside the internal environment.

Various embodiments disclosed herein provide an automated method of sample preparation using an automated sample preparation system recited in the foregoing paragraphs, comprising: (a) placing a capsule rotor in a capsule rotor seat; (b) introducing a sample into the capsule rotor; (c) placing a removable reagent cartridge in the receiving area; (d) pipetting one or more reagents from a removable reagent cartridge and into the capsule rotor; and (e) rotating the capsule rotor at a high rate of speed.

In various embodiments, pipetting one or more reagents from a removable reagent cartridge comprises: (i) rotating a rotatable stage comprising a reagent cartridge, (ii) moving a movable pipetting section, or both, to align a pipette tip with a reagent well, (iii) lowering the movable pipetting section so the pipette tip is in fluid contact with reagent in the reagent well, (iv) drawing liquid into the pipette tip, and (v) raising the pipettor unit.

In various embodiments, steps (i)-(iv) are performed once.

In various embodiments, steps (i)-(iv) are repeated one to ten times, e.g., one to six times, one to five times, or one to four times.

In various embodiments, pipetting a liquid into the capsule rotor comprises: (x) moving the movable pipetting section to align the pipette tip over the capsule rotor, (y) lowering the pipettor unit until the pipette tip is within, or a short distance above, the capsule rotor, and (z) delivering the liquid to the capsule rotor.

In various embodiments, steps x, y, and z are performed once.

In various embodiments, steps x, y, and z are repeated one to ten times, e.g., one to six times, one to five times, or one to four times.

In various embodiments, the method further comprises: pipetting a waste liquid from the capsule rotor.

In various embodiments, the method further comprises removing or replacing a cap on the capsule rotor with a capper mechanism.

In various embodiments, an automated sample preparation system comprises: (a) a centrifuge station having a capsule rotor seat shaped to receive a capsule rotor and to cause the capsule rotor to rotate at high speeds during centrifuge operations, the centrifuge station having a vertical rotation axis and a chamber member that can be moved along the vertical rotation axis to open and close an area surrounding the capsule rotor during centrifuging; (b) a stage having a reagent cartridge receiving area with a removable reagent cartridge and a sample container receiving area with a removable sample container; (c) a pipettor unit having a base and a movable pipetting section, wherein the movable pipetting section is controllably movable in a horizontal plane perpendicular to the vertical rotation axis among at least first, second and third pipetting positions aligned above the reagent cartridge, the capsule rotor seat and the sample container, respectively, wherein the movable pipetting section is moveable vertically at the first, second and third pipetting positions to withdraw and deliver liquid; (d) a capper mechanism having a movable distal end that is controllably movable in a vertical direction along the vertical rotation axis between a lowered position in which the movable distal end contacts and caps the capsule rotor and a raised position in which the movable distal end is raised to a height below the pipettor unit; and (e) a control circuit with a controller programmed to control operation of the centrifuge station, pipettor unit and capper mechanism during operation of the automated sample preparation system.

In various embodiments of the system, the pipettor unit and the capper mechanism are configured to move together towards and away from the stage along a horizontal track.

In various embodiments, the pipettor unit and the capper mechanism are configured to move vertically together along a vertical track.

In various embodiments, the stage has a rounded forward side, the stage comprises a partially cylindrical shape and the vertical rotation axis is positioned away from a geometric center of the partial cylindrical shape.

In various embodiments, the system further comprises the capsule rotor, wherein the capsule rotor is shaped to be received in the capsule rotor seat and has an opening at an upper end through which reagent and/or sample can be received, wherein the capsule rotor comprises an internal annular shelf.

In various embodiments, the pipettor unit is further configured to controllably transfer waste liquid from the capsule rotor to a well on the reagent cartridge.

In various embodiments, the system further comprises an arc-shaped door, wherein the arc-shaped door is movable from a closed position to an open position to allow an operator to access the capsule rotor seat and the rotatable stage.

In various embodiments, the movable pipetting section is movable horizontally by translation and rotation about a vertical axis.

In various embodiments, the system further comprises at least one of: a barcode reader configured to read a barcode of at least one of a sample container, a reagent cartridge and/or a capsule rotor; or an RFID tag reader/writer configured to read an RFID tag of at least one of the sample container, the reagent cartridge and/or the capsule rotor and to re-write the RFID tag to indicate a change in status of the sample container, the reagent cartridge and/or the capsule rotor.

In various embodiments, the pipettor unit is configured for controllably ejecting a used pipette tip and automatically engaging a new pipette tip.

In various embodiments, the stage comprises a reagent cartridge having spaces for new pipette tips and used pipette tips.

In various embodiments, the system further comprises a controllably movable door having an open position, providing an operator with access to the stage and the capsule rotor seat, and a closed position providing a closed internal environment within the automated sample preparation system.

In various embodiments, the system further comprises an air filter for removing contaminants from air in the internal environment before the air is exhausted outside the internal environment

In various embodiments, an automated method of sample preparation using a system of the foregoing paragraphs comprises: (a) placing a capsule rotor in a capsule rotor seat; (b) introducing a sample into the capsule rotor; (c) placing a removable reagent cartridge in the receiving area; (d) pipetting one or more reagents from a removable reagent cartridge and into the capsule rotor; and (e) rotating the capsule rotor at a high rate of speed.

In various embodiments, pipetting one or more reagents from a removable reagent cartridge comprises: (1) aligning a pipette tip with a reagent well by: (a) moving a pipettor unit in the Z direction (vertically upward, downward, or both), Y direction (laterally, horizontally), or both; (b) rotating a pivoting arm; or (c) both a and b; (2) lowering the pipettor unit so the pipette tip is in fluid contact with reagent in a reagent well; (3) drawing liquid from the reagent well into the pipette tip; and (4) raising the pipettor unit.

In various embodiments, steps (1)-(3) are performed once.

In various embodiments, steps (1)-(3) are repeated one to ten times, e.g., one to six times, one to five times, or one to four times.

In various embodiments, pipetting a liquid into the capsule rotor comprises: (1) aligning a pipette tip with a capsule rotor by: (a) moving a pipettor unit in the Z direction (vertically upward, downward, or both), Y direction (laterally, horizontally), or both; (b) rotating a pivoting arm; or (c) both a and b; (2) lowering the pipettor unit so the pipette tip is within, or a short distance above, the capsule rotor; (3) delivering the liquid to the capsule rotor; and (4) raising the pipettor unit.

In various embodiments, steps (1)-(3) of the foregoing sentence are performed once.

In various embodiments, steps (1)-(3) of the foregoing sentences are they are repeated one to ten times, e.g., one to six times, one to five times, or one to four times.

In various embodiments, the method comprises pipetting a waste liquid from the capsule rotor.

In various embodiments, the method comprises removing or replacing a cap on the capsule rotor with a capper mechanism.

In various embodiments, an automated sample preparation system comprises: (a) a centrifuge station having a capsule rotor seat that is controllably rotatable about a vertical rotation axis, wherein the centrifuge station is stationarily mounted, and wherein the capsule rotor seat is shaped to receive a capsule rotor and to cause the capsule rotor to rotate at high speeds during centrifuge operations; (b) a translating stage having a reagent cartridge receiving area configured to receive a removable reagent cartridge, the translating stage being controllably movable in two directions along an operation path among at least a load position, a centrifuging position aligned with the centrifuge station and a pipetting position; (c) a pipettor unit having a stationary base and a movable pipetting section, wherein the translating stage in the pipetting position is positionable below the movable pipetting section such that pipetting actions can be carried out between the reagent cartridge and the capsule rotor; (d) a capper mechanism having a movable distal end that is controllably movable in a vertical direction along the vertical rotation axis between a lowered position in which the movable distal end is positioned for uncapping and recapping the capsule rotor and a raised position in which the movable distal end is raised to a height above the translating stage; (e) a control circuit with a controller programmed to control operation of the centrifuge station, translating stage, and pipettor unit during operation of the automated sample preparation system.

In various embodiments, the system comprises the capsule rotor, wherein the capsule rotor is shaped to be received in the capsule rotor seat and has an opening at an upper end through which reagent and/or sample can be received, wherein the capsule rotor comprises an internal annular shelf.

In various embodiments, the system comprises at least one of: a barcode reader configured to read a barcode of at least one of a sample container, a reagent cartridge and/or a capsule rotor; or an RFID tag reader/writer configured to read an RFID tag of at least one of the sample container, the reagent cartridge and/or the capsule rotor and to re-write the RFID tag to indicate a change in status of the sample container, the reagent cartridge and/or the capsule rotor.

In various embodiments, the pipettor unit is configured for controllably ejecting a used pipette tip and automatically engaging a new pipette tip.

In various embodiments, the system comprises a reagent cartridge having spaces for new pipette tips and used pipette tips.

In various embodiments, the system further comprises a closed internal environment within the automated sample preparation system and an air filter for removing contaminants from air in the internal environment before the air is exhausted outside the internal environment.

In various embodiments a method of sample preparation using a system of the foregoing paragraphs comprises: (a) placing a capsule rotor in a capsule rotor seat; (b) introducing a sample into the capsule rotor; (c) placing a removable reagent cartridge in the receiving area; (d) pipetting one or more reagents from a removable reagent cartridge and into the capsule rotor; and (e) rotating the capsule rotor at a high rate of speed. In various embodiments, the pipetting one or more reagents from a removable reagent cartridge comprises: (i) moving the translating stage forward and back along a path; and (ii) raising and lowering a pipettor unit to allow the pipettor unit access to different reagent wells.

In various embodiments, steps (i) and (ii) are performed once.

In various embodiments, steps (i) and (ii) are repeated one to ten times, e.g. one to five times, or one to four times.

In various embodiments, pipetting one or more reagents into the capsule rotor comprises: (x) moving the translating stage along the path to align a pipette tip with the capsule rotor, and (y) delivering the sample into the capsule rotor.

In various embodiments, steps (x) and (y) are performed once.

In various embodiments, steps (x) and (y) are repeated one to ten times, e.g., one to five times or one to four times.

Various embodiments disclosed herein provide an automated sample preparation system comprising: (a) a centrifuge station having a capsule rotor seat that is controllably rotatable about a vertical rotation axis, wherein the centrifuge station is stationarily mounted about a single-sided drive, and wherein the capsule rotor seat is shaped to receive a capsule rotor housed in a capsule rotor apron and to cause the capsule rotor to rotate at high speeds within the capsule rotor apron during centrifuge operations while maintaining the apron in a stationary position; (b) a chamber member that can be moved along the vertical rotation axis to open and close an area surrounding the capsule rotor during centrifuging; (c) a translating stage having a reagent cartridge receiving area configured to receive a removable reagent cartridge, the translating stage being controllably movable in two directions along an operation path among at least a load/unload position, a centrifuging position aligned with the centrifuge station, a pipetting position and one or more uncapping/recapping positions; (d) a pipettor unit having a stationary base and a movable pipetting section, wherein the translating stage in the pipetting position is positionable below the movable pipetting section such that pipetting actions can be carried out between the reagent cartridge and the capsule rotor with the pipettor moving in one or more of a Z-axis direction and a θ angle in a plane perpendicular to the Z-axis; (e) at least two capper mechanisms each having a movable distal end that is controllably movable in a vertical direction between a lowered position in which the movable distal end is positioned for uncapping and recapping the capsule rotor or a sample container and a raised position in which the movable distal end is raised to a height above the translating stage; and (f) a control circuit with a controller programmed to control operation of the centrifuge station, translating stage, and pipettor unit during operation of the automated sample preparation system.

In various embodiments, the system further comprises the capsule rotor and apron, wherein the capsule rotor is shaped to be received and rotatably supported by the capsule apron and has an opening at an upper end through which reagent and/or sample can be received, wherein the capsule rotor comprises an internal annular shelf

In various embodiments, the system further comprises: a barcode reader configured to read a barcode of at least one of a sample container, a reagent cartridge and/or a capsule rotor; and an RFID tag reader/writer configured to read an RFID tag of at least one of the sample container, the reagent cartridge and/or the capsule rotor and to re-write the RFID tag to indicate a change in status of the sample container, the reagent cartridge and/or the capsule rotor.

In various embodiments, the pipettor unit is configured for controllably ejecting a used pipette tip and automatically engaging a new pipette tip.

In various embodiments, the system comprises a reagent cartridge having spaces for new pipette tips, used pipette tips and fluid waste.

In various embodiments, the system further comprises a closed internal environment within the automated sample preparation system, and an air filter for removing contaminants from air in the internal environment before the air is vacuum exhausted outside the internal environment.

In various embodiments, the system further comprises one or more cooling fans and an optional heating unit configured to control a temperature of the chamber.

In various embodiments, the temperature of the chamber is controlled by one or more of a thermoelectric device or liquid cooling device.

In various embodiments, at least one of the two capper mechanisms comprises a pair of grippers configured (e.g., biased) to passively encompass a capsule rotor cap when the capsule rotor is placed into position via movement of the translating stage, the pair of grippers being controllable to move vertically upward to remove the capsule rotor cap and vertically downward to install the capsule rotor cap.

In various embodiments, the system further comprises one or more reflective fiber optic LED units configured to indicate a location of the capsule rotor cap in relationship to the pipettor.

In various embodiments, the system further comprises an electrical shunt system configured to decelerate the capsule rotor upon completion of centrifuge operations by dissipating energy.

In various embodiments, an automated method of sample preparation using a system as described above, comprises: (a) placing a capsule rotor in a capsule rotor seat; (b) introducing a sample into the capsule rotor; (c) placing a removable reagent cartridge in the receiving area; (d) pipetting one or more reagents from a removable reagent cartridge and into the capsule rotor; and (e) rotating the capsule rotor at a high rate of speed. In various embodiments, pipetting one or more reagents from a removable reagent cartridge comprises: (i) moving the translating stage forward and back along a path; and (ii) raising and lowering a pipettor unit to allow the pipettor unit access to different reagent wells.

In various embodiments, steps (i) and (ii) are performed once; in other embodiments, they are repeated. In various embodiments, pipetting one or more reagents into the capsule rotor comprises: (i) moving the translating stage along the path to align a pipette tip with the capsule rotor, and (ii) delivering the sample into the capsule rotor.

In various embodiments, steps (i) and (ii) are performed once.

In various embodiments, steps (i) and (ii) are repeated one to ten times, e.g. one to five times or one to four times.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter is pointed out with particularity and claimed distinctly in the concluding portion of the specification. A more complete understanding, however, may best be obtained by referring to the detailed description and claims when considered in connection with the following drawing figures:

FIG. 1 is a perspective view of an instrument according to a first implementation, showing selected portions of its interior;

FIG. 2 is a side elevation view of the instrument of FIG. 1;

FIGS. 3 and 4 are additional perspective views of the instrument of FIG. 1 illustrating different operating positions;

FIG. 5 is a top plan view of the instrument of FIG. 1;

FIG. 6 is a perspective view of an instrument according to a second implementation, showing selected portions of its interior;

FIG. 7 is a side elevation view of the instrument of FIG. 6;

FIG. 8 is a top plan view of the instrument of FIG. 6;

FIG. 9 is a perspective view of an instrument according to a third implementation showing selected portions of its interior;

FIG. 10 is a side elevation view of the instrument of FIG. 9 illustrating a load position;

FIG. 11 is a side elevation view of the instrument of FIG. 9 illustrating a pipette position;

FIG. 12 is a side elevation view of the instrument of FIG. 9 illustrating a capsule drive position;

FIG. 13 is a perspective view of an exemplary capsule rotor;

FIG. 14 is a side elevation view of the capsule rotor of FIG. 13;

FIGS. 15A, 15B and 15C are sectioned views in elevation showing alternative internal configurations of the capsule rotor of FIG. 13;

FIGS. 16 and 17 are perspective views of an instrument according to a fourth different implementation, showing selected portions of its interior, including a translating stage (shuttle);

FIGS. 18, 19 and 20 are perspective, side elevation and section views of the capsule rotor assembly of FIGS. 16 and 17;

FIGS. 21a-21d are additional perspective views that are similar to FIG. 16 but show the shuttle in different positions during operation of the instrument;

FIGS. 22a and 22b are perspective and enlarged views, respectively, showing a first capping device;

FIGS. 23a and 23b are perspective and enlarged views, respectively, showing a second capping device;

FIG. 24 is an enlarged perspective view of a portion of the instrument showing the first and second capping devices;

FIG. 25 is a schematic block diagram of a shunt circuit for the centrifuging motor;

FIG. 26 is a comparison of means of loss in supernatant across run conditions;

FIG. 27 is the standard deviation of loss in supernatant across run conditions;

FIGS. 28A-28B are bar graphs of contriving matrix saline and artificial sputum matrix groups for several microorganisms using manual preparation with artificial sputum matrix (ASM), preparation with ASM using a system described herein, and preparation with saline using a system described herein;

FIGS. 29A-29B are dot plots of average growing clones across spin number and methods;

FIGS. 30A-30D are dot plots of average growing clones across spin number and methods using normalized mucus pools;

FIGS. 31A-31D are dot plots of average growing clones across prep method using mucus pools of varying optical densities;

FIG. 32 is a dot plot of average growing clones across prep method using mucus pools of varying optical densities;

FIG. 33 is a dot plot of the contriving matrix 2X and 4X RAM groups;

FIG. 34 is a comparison of means of recovery in resuspension across run conditions;

FIG. 35 is the standard deviation of recovery in resuspension across run conditions;

FIG. 36 is a dot plot of shelf, trough and normal capsules average growing clone recovery;

FIG. 37 is a dot plot of shelf, trough and normal capsules bead count recovery;

FIG. 38 is a dot plot comparing the average growing clones' bacterial recovery between rinse and wash approach;

FIG. 39 is a dot plot of bead counts in resuspension across FM instruments;

FIG. 40 is a dot plot of the average glowing clones in final resuspension;

FIG. 41 is a dot plot of bead counts in final resuspension;

FIGS. 42A-42H depict images of samples PITT_634, BAN_3158, PITT_626 and PITT_632 from Table 6;

FIGS. 43A-43H depict images of samples PITT_623, PITT_619, PITT_628 and BAN_3161 from Table 6;

FIGS. 44A-44H depict images of samples TRI_146, BAN_3177, BAN_3178 and PITT_644 from Table 6;

FIGS. 45A-45H depict images of samples PITT_650, PITT_647, PITT_658 and IND_042 from Table 6;

FIGS. 46A-46J depict images of samples PITT_672, PITT_676, BAN_3231, BAN_3244 and BAN_3237 from Table 6;

FIGS. 47A-47H depict images of samples BAN_2159, BAN_2161, BAN_2167 and BAN_2169 from Table 10;

FIGS. 48A-48H depict images of samples BAN_2182, BAN_2195, BAN_2207 and BAN_2208 from Table 10;

FIGS. 49A-49H depict images of samples BAN_2210, BAN_2214, BAN_2215 and BAN_2221 from Table 10;

FIGS. 50A-50H depict images of samples BAN_2222, BAN_2224, BAN_2225 and BAN_2227 from Table 10;

FIGS. 51A-51H depict images of samples BAN_2228, BAN_2237, BAN_2238 and BAN_2239 from Table 10; and

FIGS. 52A-52F depict images of samples BAN_2242, BAN_2244 and BAN_2252 from Table 10.

### DETAILED DESCRIPTION

The detailed description of exemplary embodiments makes reference to the accompanying drawings, which show exemplary embodiments by way of illustration and their best mode. While these exemplary embodiments are described in sufficient detail to enable those skilled in the art to practice the invention, it should be understood that other embodiments may be realized and that logical, chemical, and mechanical changes may be made without departing from the spirit and scope of the inventions. Thus, the detailed description is presented for purposes of illustration only and not of limitation. For example, unless otherwise noted, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

### System Hardware and Features

Described herein are illustrative implementations of an automated sample preparation system, also referred to herein as an instrument, for preparing biological samples.

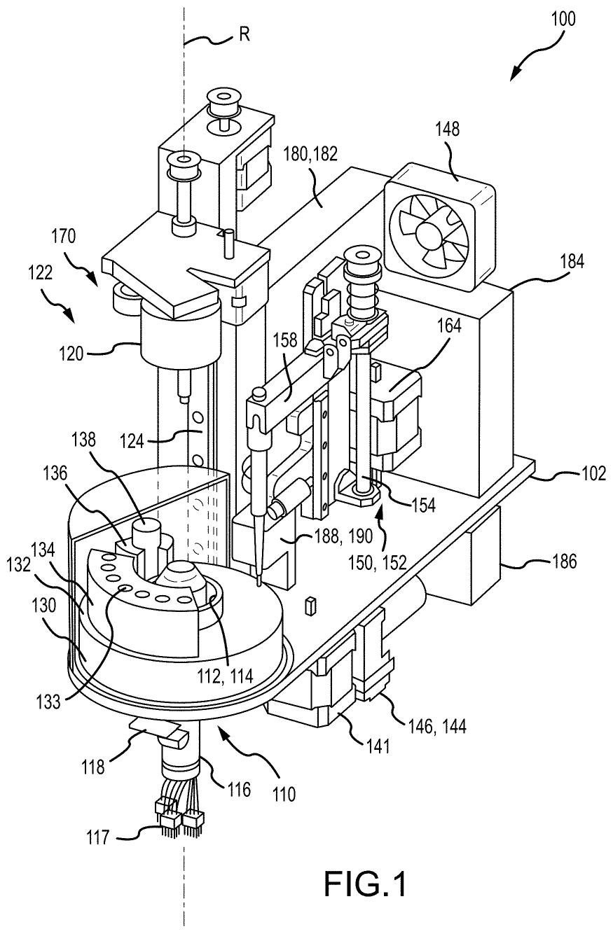

FIG. 1 is a perspective view of a first implementation of an instrument 100, which is illustrated without any housing and with selected components omitted for sake of illustration. The instrument 100 has a base member 102 (platform), and various components are arranged above and below the base member 102.

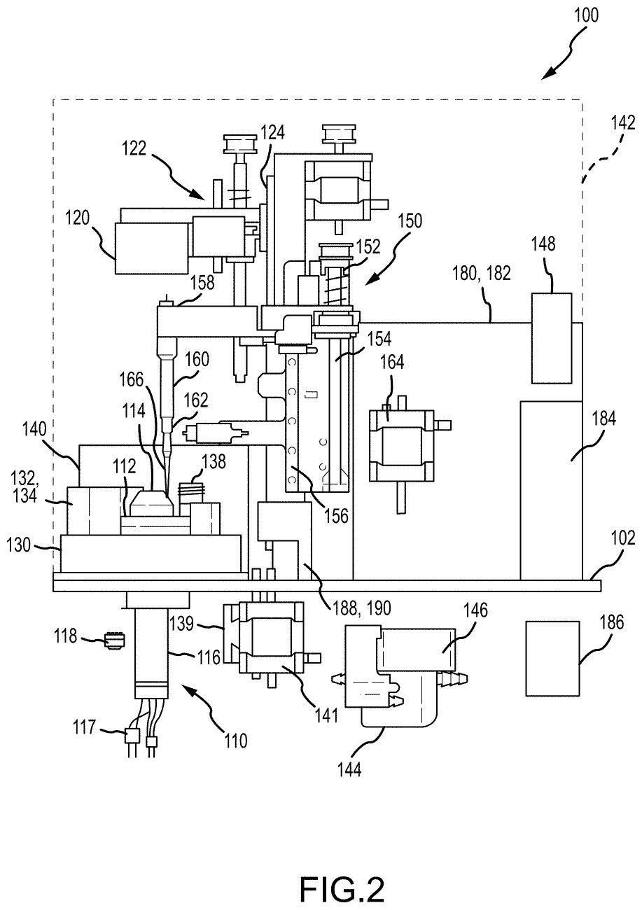

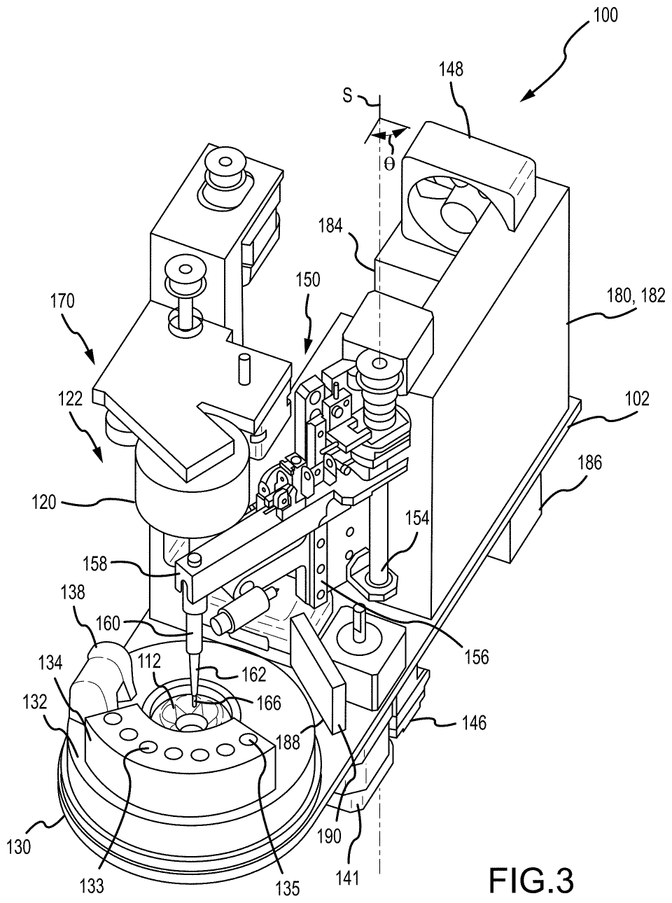

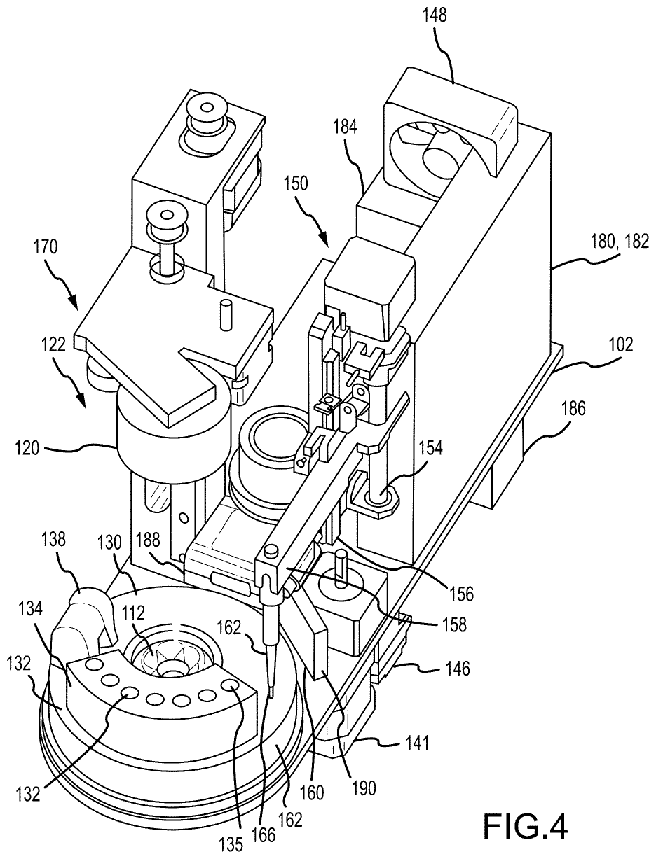

At the forward end of the instrument 100, there is a centrifuge station 110 positioned to have a vertical axis of rotation R (also described as the Z direction). The base member 102 extends generally horizontally, and thus is perpendicular to the vertical axis of rotation R. As shown in FIGS. 1 and 2, a capsule rotor 114, which may be any container suitable for containing a sample during rotation at high speeds (centrifuging) is received in a capsule rotor seat 112, which is in turn controllably rotatable at high speeds by a centrifuging motor 116, i.e., during centrifuging. In the implementation of FIGS. 1-5, the centrifuging motor 116 is positioned below the capsule rotor seat 112, which can be accessed from above, such as above the base member 102. FIGS. 3 and 4 show the capsule rotor seat 112 in slightly more detail and without the capsule rotor 114.

The instrument 100 has a chamber member 120 that can be lowered from an open position as shown in FIGS. 1-3 to a closed position (not shown) in which the chamber member 120 forms an upper member enclosing the capsule rotor 114. In the closed position of the chamber member 120, the capsule rotor 114 is effectively enclosed within a chamber and can be subject to centrifuging operations, e.g., rotating the capsule rotor 114 in the capsule rotor seat 112 at high speeds by the centrifuging motor 116, with less risk that any of the contents of the capsule rotor 114 would be inadvertently ejected within the instrument, which could cause inadvertent contamination and/or entail costly and time consuming clean up steps. The chamber member 120 is movable vertically along the axis R with a chamber member movement mechanism 122. A guide rail 124 for the chamber member movement mechanism 122 is positioned radially outward of a rotatable stage 130, which is described below in more detail.

For clarity in illustration, several of the connections between components, including fluid, electrical and data connections, are omitted from the drawings. For example, the centrifuge motor 116 is connected to a source of electrical power, as described in greater detail below, via the electrical connectors 117. Also, the centrifuge station 110 can have an accelerometer 118 configure to detect operating conditions of the centrifuge station 110. For example, the accelerometer 118 can be configured to detect a condition indicating that the capsule rotor 114 is rotating in an out-of-balance condition, as well as other types of potentially unsafe or less than optimal conditions.

Also, at the forward end of the instrument 100, the stage 130 is positioned to have its axis of rotation coincident with the vertical axis of rotation R. Although the stage 130 in this implementation shares the same axis R with the centrifuge station 110, the rotation of the capsule rotor 114 and the rotation of the stage 130 are independent of each other. Relative to the shared axis R, the stage 130 occupies an area radially outward of the capsule rotor 114. In the illustrated implementation, the stage 130 has a generally annular shape with a cylindrical outer surface, flat upper and lower surfaces and a cylindrical inner surface defining a center opening around the capsule rotor seat 112, but other shapes are also possible. For example, it would be possible for the stage 130 to only partially surround the capsule rotor seat 112.

The stage 130 provides a space for reagents and/or one or more samples to be staged for use during operation of the instrument. In the illustrated implementation, the stage 130 has a removable reagent cartridge 134, which is received in a reagent cartridge receiving area 132. Optionally, the stage 130 may also have a sample container 138 (vial) receivable in a sample container receiving area 136. In other implementations, the reagent cartridge 134 can be configured to receive the sample container 138. For example, the sample container receiving area 136 may be incorporated into the reagent cartridge 134 or the sample container 138 may itself be incorporated into the reagent cartridge 134.

In the illustrated implementation, the stage 130 is controllably rotatable, such as with as a rotatable stage motor 139. The operation of the stage 130 can be controlled such that the stage is rotated in cooperation with the operation and/or movement of other components, as is described below in more detail.

The instrument 100 can be fitted with a door, such as the door 140, which is moved on a circumferentially shaped path. The door 140 can be controllably movable between at least open and closed positions. When the door 140 is in the open position, an operator can insert items into or remove items from the instrument, e.g., capsule rotors, reagent cartridges and/or sample vials. When the door 140 is in the closed position, an internal environment 142 within the instrument 100, as shown schematically by the dashed line in FIG. 2, is defined. The door 140 may be arc-shaped, though other configurations are also possible.

The instrument 100 can have various additional features within the internal environment 142. For example, the instrument 100 can include an air pump 144 operable to generate a positive pressure within the internal environment 142 and a filter 146 (e.g., a HEPA filter) to filter contaminants from air. In addition, the instrument 100 can have a fan 148 for exhausting air from the environment 142 to outside of the environment 142. The instrument 100 can also have a motor 141 to drive the door 140.

In the implementation of FIGS. 1-5, the instrument 100 has a pipettor unit 150 with a fixed end 152 and a movable pipetting section 158. The pipetting section 158 is controllably movable between locations, such as with a pipette unit motor 164 as shown. The allows the pipetting section 158 to automatically transfer (i.e., withdraw and deliver) precise amounts of liquid from and to various locations, as described herein.

In the illustrated implementation, the movable pipetting section 158 has a distal end 160 onto which a pipette tip 166 may be installed, into which liquid may be drawn (loaded) and from which liquid may be expelled (unloaded). The distal end 160 may comprise a pipette tip changing device 162 for ejecting a used, and installing a new, pipette tip 166.

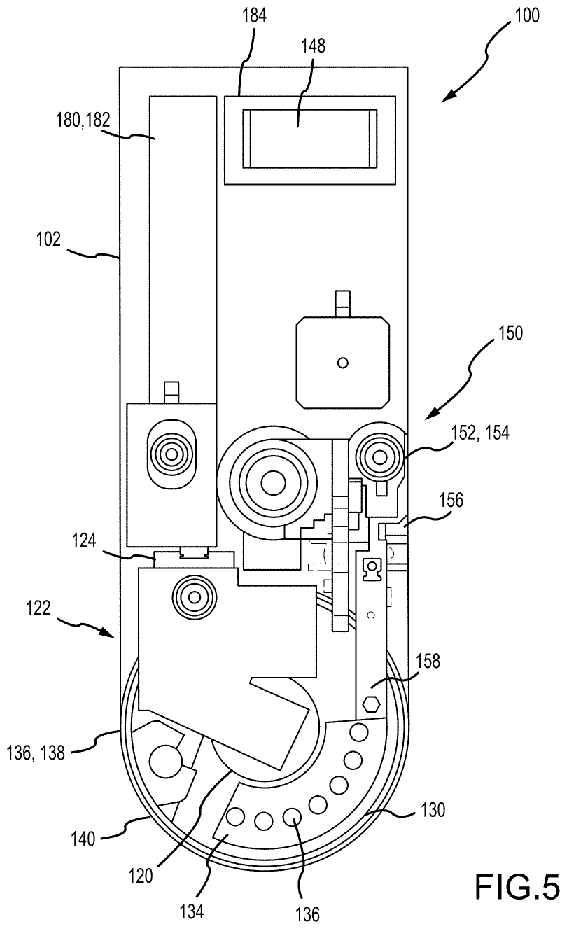

As can be seen from FIG. 5, the reagent cartridge 134 has been rotated via the rotatable stage 130 so that one of the reagent wells 133 in the reagent cartridge 134 is nearly in alignment with the end of the pipetting section 158. When final alignment is achieved, the stage 130 is kept stationary, and the distal end 160 of the pipettor unit 150 is lowered by using a ball screw 154 (or similar linear motion device) vertically along a guide rail 156 until a pipette tip 166 is in contact with reagent in the reagent cartridge 134. After the pipette tip 166 is loaded with reagent (liquid is drawn into the pipette tip 166), the pipettor unit 150 can be raised and the movable pipetting section 158 can be moved to another location, e.g., to a location aligned with the capsule rotor 114. In FIG. 3, the movable pipetting section 158 is shown with the distal end 160 aligned with the capsule rotor seat 112 (the distal capsule rotor 114 has been omitted for clarity).

More specifically, the distal end 160 is raised and lower as required using a ball screw 154 and guide rail 156, and the distal end 160 is moved laterally (generally in a horizontal plane) by rotation of the movable pipetting section 158 about a vertical axis of rotation S, through an angle θ (also referred to as rotation about a θ axis). Thus, the pipettor unit 150 can be controllably raised and lowered and the movable pipetting section 158 may be moved from at least a first location, e.g., aligned with one of reagent wells 133 in the reagent cartridge 134 (or above the reagent cartridge receiving space) to a second location, e.g., aligned with the capsule rotor 114, for the purposes of delivering liquid (e.g., sample, reagent(s), or both) to, and withdrawing liquid (e.g., supernatant, waste liquid) from, the capsule rotor 114. It is noted that waste liquid, for example, used or excess liquid from the capsule rotor 114 following centrifuging operations, can be moved from the capsule rotor 114 to a waste well 135, which may be an otherwise unused reagent well 133 on the reagent cartridge 134 or a waste container separate from the reagent cartridge 134, using the pipettor unit 150 in the same manner. In implementations having a sample container 138, there is a third such location aligned with the sample container 138, and movement of the pipettor unit 150 and pipetting section 158 can occur between any two of the three locations—namely, aligned with one of reagent wells 136 in the reagent cartridge 134, aligned with the capsule rotor 114, or aligned with a sample container 138. In implementations having a sample container 138 and a waste container, there is a fourth such location aligned with the sample container 138, and movement of the pipettor unit 150 and pipetting section 158 can occur between any of the possible locations—namely, aligned with one of reagent wells 136 in the reagent cartridge 134, aligned with the capsule rotor 114, aligned with a sample container 138, or aligned with a waste well (waste container).

A capper mechanism 170 may be provided to automatically uncap and cap the sample container 138, the sample rotor 114, or both. For example, the capper mechanism 170 may be lowered from a raised position (shown in FIG. 1) to a lowered position in contact with the sample container 138, and a cap of the sample container 138 may be removed, and then the capper mechanism 170 may be returned to the raised position while the cap is retained. The cap may have a snap fit or other type of connection with the sample container 138. Thereafter, the capper mechanism 170 can be controlled to be lowered into contact with the opened sample container 138 and caused to reinstall the cap on it, and then returned to the raised position. Although not shown, the instrument 100 can be provided with a second capper mechanism configured to automatically uncap and recap the capsule rotor 114, if desired.

In some implementations, the instrument 100 has a barcode reader 188 and a RFID tag reader/writer 190, which are shown schematically at the same location in the figures. In one implementation, the barcode reader 188 is used to read a barcode from the sample container 138. The RFID tag reader/writer is configured to read an RFID tag from the reagent cartridge 134 and to update a reagent cartridge tag to indicate that the cartridge 134 has been used.

As also shown in FIG. 1, the instrument 100 may have a circuit board 180 or other form of circuit, which is shown schematically, which includes at least a control circuit 182, also shown schematically, for the controlling operation of the major components and for coordinating steps and movements of operation. For example, the control circuit 182 can be configured to control the centrifuge station 110, the chamber member movement mechanism 122, the stage 130, the door 140, the pipettor unit 150, the capper mechanism 170, the barcode reader 188 and/or the RFID tag reader/writer 190. FIGS. 3 and 4 show an alternative location for the circuit board 180 and control circuit 182 on the opposite side of the instrument 100.

The instrument 100 can include one or more power supplies 184, which are shown schematically in FIG. 1. The centrifuge station 110 may be configured to have a dedicated power supply. Electrical inputs 186, including to a source of electrical power for the instrument 100, are shown schematically.

A method of sample preparation using an instrument 100 (e.g., as illustrated in FIGS. 1-5) may comprise: placing a capsule rotor in a capsule rotor seat; introducing a sample into the capsule rotor; pipetting one or more reagents from a removable reagent cartridge and into the capsule rotor; and rotating the capsule rotor at a high rate of speed (centrifuging). In various embodiments, introducing a sample into the capsule rotor may comprise: (a) placing the sample in the capsule rotor before the capsule rotor is introduced into the capsule rotor seat; or (b) pipetting the sample from a sample container and into the capsule rotor after the capsule rotor is placed in the capsule rotor seat.) The method may include removing a supernatant from the capsule rotor. The method may also include resuspending a pellet in the capsule rotor by repeating pipetting of one or more reagents from the removable reagent cartridge and into the capsule rotor. Once the pellet is resuspended, the capsule rotor may again be rotated at a high rate of speed (centrifuged). This cycle of pipetting reagents into the capsule rotor, centrifugation, and waste removal may be repeated as many times as necessary to remove or dilute inhibiting substances that may be in the original sample.

Pipetting one or more reagents from a removable reagent cartridge may include rotating a rotatable stage comprising a reagent cartridge, moving a movable pipetting section, or both, to align a pipette tip with a reagent well, lowering the movable pipetting section so the pipette tip is in fluid contact with reagent in the reagent well, and drawing liquid into the pipette tip, after which the pipettor unit may be raised. This procedure may be performed once or may be repeated as many times as necessary to draw as many reagents, of whatever volume, into the pipette tip, so long as the total volume drawn into the pipette tip does not exceed the capacity of the pipette tip. Pipetting a liquid into the capsule rotor may comprise moving the movable pipetting section to align the pipette tip over the capsule rotor, lowering the pipettor unit until the pipette tip is within, or a short distance above, the capsule rotor, and delivering the liquid to the capsule rotor. The cycle of pipetting one or more reagents from a removable reagent cartridge and into the capsule rotor may be performed once or may be repeated as many times as necessary to deliver the desired quantity of liquid to the capsule rotor. After all reagent(s) have been delivered to the capsule rotor, the pipettor unit may be moved out of the way.

Centrifuging the sample in contact with the reagents results in separation of a pellet at the bottom of the capsule from a supernatant, which may be considered a waste liquid. The method may also include pipetting waste liquid from the capsule rotor and disposing the waste in a waste well. Pipetting waste liquid from the capsule rotor and disposing the waste in a waste well may comprise moving a movable pipetting section to align a pipette tip over the capsule rotor, lowering the pipettor unit until the pipette tip is in fluid contact with liquid in the capsule rotor, drawing liquid into the pipette tip, raising the pipettor unit, moving the movable pipetting section and optionally rotating the rotatable stage to align the pipette tip with a waste well, lowering the pipettor unit to position the pipette tip within or a short distance above the waste well, and delivering the liquid to the waste well from the pipette tip. This procedure may be performed once or may be repeated as many times as necessary to remove the desired amount of waste liquid from the capsule rotor.

One or more steps of introducing the sample into the capsule rotor, pipetting the one or more reagents from a removable reagent cartridge into the capsule rotor, performing centrifuging operations on the sample (centrifuging the sample) by rotating the capsule rotor at a high rate of speed, pipetting waste liquid from the capsule rotor and disposing the waste into a waste well may be automated. That is, one or more of these steps may be performed by executing a set of instructions stored in a computer-readable storage medium, which instructions, upon execution by a computer system, cause the computer system to perform the recited steps.

In some implementations, the method may include removing a cap, replacing a cap, or both, on the capsule rotor, e.g., with a capper mechanism. The capper mechanism may be lowered from a raised position until it is in contact with a cap of the capsule rotor. The capper mechanism may then remove the cap and move to a raised position, still holding the cap. The capper mechanism may then replace the cap on the capsule rotor, e.g. after the sample, reagent(s), or both, are placed in the capsule rotor. Removing a cap, replacing a cap, lowering the capper mechanism, raising the capper mechanism, or combinations thereof, may be automated—i.e., one or more steps may be performed by executing a set of instructions stored in a computer-readable storage medium, which instructions, upon execution by a computer system, cause the computer system to perform the recited steps.

In some implementations, a sample may be introduced into the capsule rotor before the capsule rotor is placed in the capsule rotor seat. In some other implementations, the sample may be placed in the capsule rotor by a pipettor unit, which may be automated. The sample initially may be in a separate sample container or in a sample container incorporated into a removable reagent cartridge. In either case, one or more reagents may be placed in the capsule rotor by a pipettor unit, as described above. Once sample and one or more reagents are in the capsule rotor and the pipettor unit is moved out of the way, the capper mechanism may then place the cap back on the capsule rotor. Once the capper mechanism is moved out of the way, a chamber member may be lowered, a door may be closed, or both. Then, the capsule rotor containing the sample, one or more reagents, or both, may be subjected to centrifuging operations (centrifuged) by rotating the capsule rotor at high speeds, thereby achieving centrifugation. One or more steps of moving the pipettor arm into location over a desired reagent in the reagent cartridge, lowering the pipettor until the distal end of the pipettor arm is in contact with the reagent, loading the reagent in the pipettor arm, raising the pipettor arm, moving the pipettor to a position aligned with the capsule rotor, lowering the pipettor arm, and emptying the pipettor arm into the capsule rotor, moving the pipettor unit out of the way, placing a cap on the capsule rotor, lowering a chamber member, and closing a door may be automated, e.g., one or more of these steps may be performed by executing a set of instructions stored in a computer-readable storage medium, which instructions, upon execution by a computer system, cause the computer system to perform the recited steps.

The method may comprise one, two, three, four, five, six, or more cycles of reagent placement, centrifugation, and waste removal and disposal. As an illustration, the method may comprise, with a pipettor unit, placing sample in the capsule rotor and placing a first reagent in the capsule rotor, rotating the capsule rotor at high speeds a first time, with the pipettor, removing a first waste liquid from the capsule rotor and disposing of the waste liquid in a waste well, with the pipettor placing a second reagent in the capsule rotor (e.g., resuspending the pellet), rotating the capsule rotor at high speeds a second time, and optionally removing a second waste liquid from the capsule rotor. The cycle of removing a waste liquid from the capsule rotor and disposing of the waste liquid in a waste well, placing a next reagent in the capsule rotor (e.g., resuspending the pellet), and rotating the capsule rotor at high speeds another time, may be repeated as many times as necessary to effect cleanup, e.g., once, twice, thrice, four times, five times, six times, or more. The method may also include discarding one or more pipette tips, placing one or more new pipette tips on a distal end of a pipettor unit, or both. For example, separate pipette tips may be used for sample, one or more reagents, and waste liquid removal.

Any of the foregoing implementations of a method of sample preparation may be automated. Thus, the system may comprise a computer-readable storage medium (e.g., a non-transitory computer-readable storage medium) including instructions, which upon execution cause a computer system to perform any of the foregoing methods. In some implementations, the computer-readable storage medium may include instructions, which upon execution cause a computer system to pipette a sample, one or more reagents, or both from a removable reagent cartridge and into a capsule rotor and rotate the capsule rotor at a high rate of speed (perform centrifuging operations). In some implementations, instructions, upon execution, cause a computer system to pipette a sample from a separate sample container or a reagent cartridge into a capsule rotor, pipette one or more reagents from a removable reagent cartridge and into the capsule rotor, and rotate the capsule rotor at a high rate of speed (perform centrifuging operations). The computer-readable storage medium may further comprise instructions, which upon execution cause a computer system to raise a chamber member, lower the chamber member, or both. The computer-readable storage medium may further comprise instructions, which upon execution cause a computer system to control a capper mechanism. The computer-readable storage medium may comprise instructions, which upon execution cause a computer system to open a door, close the door, or both. The instructions may cause the computer system to pipette waste liquid from a capsule rotor and dispose of the waste liquid in a waste well. The instructions may cause a computer system to control one or more fans, operate one or more resistive heating elements, operate one or more cooling elements, or combinations of two or more thereof. The instructions may cause a computer system to control an RFID tag reader/writer, a barcode reader, or both.

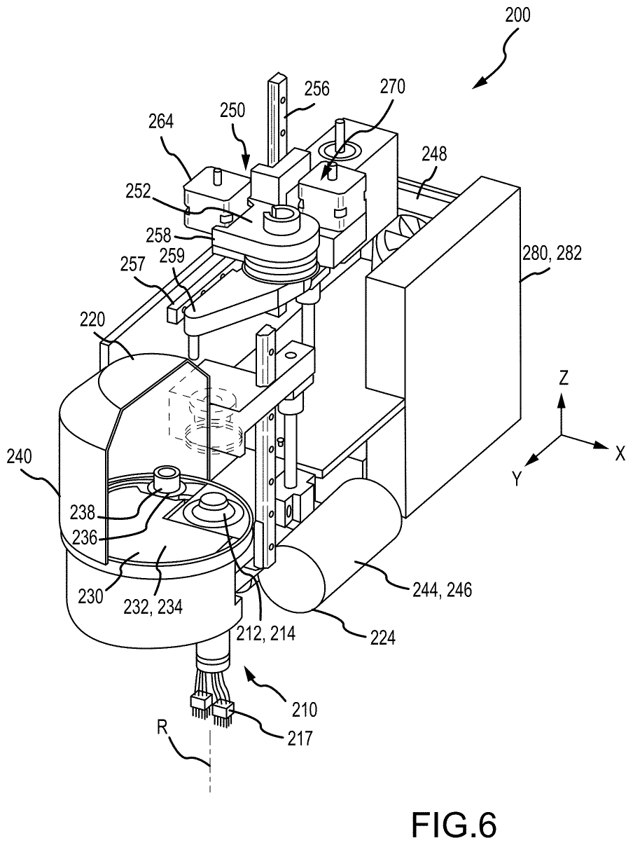

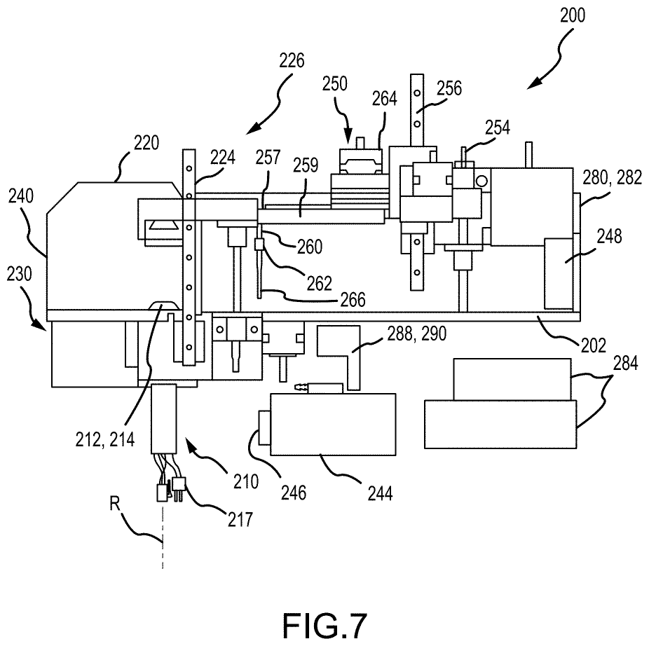

FIGS. 6-8 show a second implementation of an instrument 200. Components having the same or similar function as in the instrument 100 described above are numbered with the same reference number, plus 100.

The instrument 200 has a base member 202 or platform, and various components are arranged above and below the base member 202. The instrument 200 may also comprise a chamber member 220. The chamber member 220 may be movable with a chamber member movement mechanism 222. A guide rail 224 for the chamber member movement mechanism 222 may be positioned outward of the stage 230. The stage 230 is stationary. Thus, the reagent cartridge receiving space 232 and the reagent cartridge 234 (which is depicted schematically but may comprise a plurality of wells, as depicted in FIG. 1-6), are also stationary. The centrifuge station 210 is not centered within the stage 230, but instead is in a quadrant of the open area of the stage 230, which can provide more space for operators to insert and remove items when the door 240 is in the open position as shown. The centrifuge station 210 may also have electrical connectors 217 to provide electrical power to the centrifuge station.

The instrument 200 can include an air pump 244 operable to generate a positive pressure, as described above, and a filter 246 (e.g., a HEPA filter) to filter contaminants from air. In addition, the instrument 200 can have a fan 248 for exhausting air, as described above.

In the instrument 200, the pipettor unit 250 and the capper mechanism 270 both move vertically (in the Z direction) up and down along a vertical guide rail 256 and horizontally (in the Y direction) towards and away from the stage 230 along a horizontal guide rail 257.

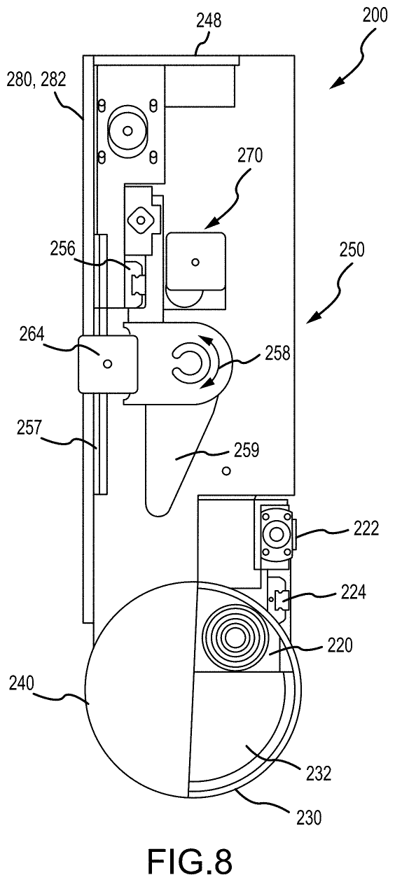

The pipettor unit 250 has a fixed end 252 and a pivoting arm 259 and pivot drive 258. The pivot drive can cause the pivoting arm 259 to rotate or pivot as shown (FIG. 8) to align the distal end 260 with first, second and third locations (e.g., capsule rotor 214, sample container 238, and reagent cartridge receiving space 232) on the stage 230 for pipetting to and from the capsule rotor 214 (seated in a capsule rotor seat 212), the reagent cartridge 234 (which is shown schematically but contains a plurality of wells), and the sample container 238 and sample container receiving area 232 (as best shown in FIG. 6). The distal end 260 of pipettor unit 250 may be raised and lowered using, e.g., a ball screw 254 or similar linear motion device, as described above. The distal end 260 may comprise a pipette tip changing device 262 for ejecting a used, and installing a new, pipette tip 266, on the end of the distal end 260.

The capper mechanism 270 can be moved into alignment with the sample container 238, lowered to uncap it and raised with the cap retained to allow for subsequent operations. A second capper mechanism 264 can be provided for uncapping and capping the capsule rotor.

The instrument 200 may have a circuit board 280, which may include at least a control circuit 282 for controlling operation of the major components and for coordinating steps and movements of operation. The instrument 200 may also include one or more power supplies 284. The instrument 200 may also include a barcode reader 288, an RFID tag reader/writer 290, or both.

A method of sample preparation using an instrument 200, (e.g., as illustrated in FIGS. 6-8) may comprise: placing a capsule rotor in a capsule rotor seat; introducing a sample into the capsule rotor; pipetting one or more reagents from a removable reagent cartridge and into the capsule rotor; and rotating the capsule rotor at a high rate of speed (centrifuging). In various embodiments, introducing a sample into the capsule rotor may comprise: (a) placing the sample in the capsule rotor before the capsule rotor is introduced into the capsule rotor seat; or (b) pipetting the sample from a sample container and into the capsule rotor after the capsule rotor is place in the capsule rotor seat.) The method may include removing a supernatant from the capsule rotor. The method may also include resuspending a pellet in the capsule rotor by repeating pipetting of one or more reagents from the removable reagent cartridge and into the capsule rotor. Once the pellet is resuspended, the capsule rotor may again be rotated at a high rate of speed (centrifuged). This cycle of pipetting reagents into the capsule rotor, centrifugation, and waste removal may be repeated as many times as necessary to remove or dilute inhibiting substances that may be in the original sample.

Pipetting one or more reagents from a removable reagent cartridge may comprise: (1) aligning a pipette tip with a reagent well by: (a) moving a pipettor unit in the Z direction (vertically upward, downward, or both), Y direction (laterally, horizontally), or both; (b) rotating a pivoting arm; or (c) both a and b; (2) lowering the pipettor unit so the pipette tip is in fluid contact with reagent in a reagent well; and (3) drawing liquid from the reagent well into the pipette tip; and (4) raising the pipettor unit. Pipetting steps 1-4 may be performed once or may be repeated as many times as necessary to draw as many reagents, of whatever volume, as desired into the pipette tip, so long as the total volume drawn into the pipette tip does not exceed the capacity of the pipette tip. Pipetting a liquid into the capsule rotor may comprise: (1) aligning a pipette tip with a capsule rotor by: (a) moving a pipettor unit in the Z direction (vertically upward, downward, or both), Y direction (laterally, horizontally), or both; (b) rotating a pivoting arm; or (c) both a and b; (2) lowering the pipettor unit so the pipette tip is within, or a short distance above, the capsule rotor; (3) delivering the liquid to the capsule rotor; and (4) raising the pipettor unit. The cycle of pipetting one or more reagents from a removable reagent cartridge and into the capsule rotor may be performed once or may be repeated as many times as necessary to deliver the desired quantity of liquid to the capsule rotor. After all reagent(s) have been delivered to the capsule rotor, the pipettor unit may be moved out of the way.

Centrifuging the sample in contact with the reagents results in separation of a pellet at the bottom of the capsule from a supernatant, which may be considered a waste liquid. The method may also include pipetting waste liquid from the capsule rotor and disposing the waste in a waste well. Pipetting waste liquid from the capsule rotor and disposing the waste liquid in a waste well may comprise: (1) aligning a pipette tip with a capsule rotor by: (a) moving a pipettor unit in the Z direction (vertically upward, downward, or both), Y direction (laterally, horizontally), or both; (b) rotating a pivoting arm; or (c) both a and b; (2) lowering the pipettor unit so the pipette tip is in fluid contact with liquid in the capsule rotor; (3) drawing the waste liquid into the pipette tip; (4) raising the pipettor unit; (5) aligning a pipette tip with a waste well by (a) moving the pipettor unit in a Y direction, rotating the pivoting arm, or both; (6) lowering the pipettor unit until the pipette tip is within, or a short distance above, a waste well; and (7) delivering the waste liquid to the waste well from the pipette tip. This procedure may be performed once or may be repeated as many times as necessary to remove the desired amount of waste liquid from the capsule rotor.

One or more steps of introducing the sample into the capsule rotor, pipetting the one or more reagents from a removable reagent cartridge into the capsule rotor, performing centrifuging operations on the sample (centrifuging the sample) by rotating the capsule rotor at a high rate of speed, pipetting waste liquid from the capsule rotor and disposing the waste into a waste well may be automated. That is, one or more of these steps may be performed by executing a set of instructions stored in a computer-readable storage medium, which instructions, upon execution by a computer system, cause the computer system to perform the recited steps.

In some implementations, the method may include removing a cap, replacing a cap, or both, on the capsule rotor, e.g., with a capper mechanism. The capper mechanism may be lowered from a raised position until it is in contact with a cap of the capsule rotor. The capper mechanism may then remove the cap and move to a raised position, still holding the cap. The capper mechanism may then replace the cap on the capsule rotor, e.g. after the sample, reagent(s), or both, are placed in the capsule rotor. Removing a cap, replacing a cap, lowering the capper mechanism, raising the capper mechanism, or combinations thereof, may be automated. That is, one or more steps may be performed by executing a set of instructions stored in a computer-readable storage medium, which instructions, upon execution by a computer system, cause the computer system to perform the recited steps.

In some implementations, a sample may be introduced into the capsule rotor before the capsule rotor is placed in the capsule rotor seat. In some other implementations, the sample may be placed in the capsule rotor by a pipettor unit, which may be automated. The sample initially may be in a separate sample container or in a sample container incorporated into a removable reagent cartridge. In either case, one or more reagents may be placed in the capsule rotor by a pipettor unit, as described above. Once sample and one or more reagents are in the capsule rotor and the pipettor unit is moved out of the way, the capper mechanism may then place the cap back on the capsule rotor. Once the capper mechanism is moved out of the way, a chamber member may be lowered, a door may be closed, or both. Then, the capsule rotor containing the sample, one or more reagents, or both, may be subjected to centrifuging operations (centrifuged) by rotating the capsule rotor at high speeds, thereby achieving centrifugation. One or more steps of moving the pipettor arm into location over a desired reagent in the reagent cartridge, lowering the pipettor until the distal end of the pipettor arm is in contact with the reagent, loading the reagent in the pipettor arm, raising the pipettor arm, moving the pipettor to a position aligned with the capsule rotor, lowering the pipettor arm, and emptying the pipettor arm into the capsule rotor, moving the pipettor unit out of the way, placing a cap on the capsule rotor, lowering a chamber member, and closing a door may be automated, e.g., one or more of these steps may be performed by executing a set of instructions stored in a computer-readable storage medium, which instructions, upon execution by a computer system, cause the computer system to perform the recited steps.

The method may comprise one, two, three, four, five, six, or more cycles of reagent placement, centrifugation, and waste removal and disposal. As an illustration, the method may comprise, with a pipettor unit, placing sample in the capsule rotor and placing a first reagent or combination of reagents in the capsule rotor, rotating the capsule rotor at high speeds a first time, with the pipettor, removing a first waste liquid from the capsule rotor and disposing of the waste liquid in a waste well, with the pipettor placing a second reagent in the capsule rotor (e.g., resuspending the pellet), rotating the capsule rotor at high speeds a second time, and optionally removing a second waste liquid from the capsule rotor. The cycle of removing a waste liquid from the capsule rotor and disposing of the waste liquid in a waste well, placing a next reagent in the capsule rotor (e.g., resuspending the pellet), and rotating the capsule rotor at high speeds another time, may be repeated as many times as necessary to effect cleanup, e.g., once, twice, thrice, four times, five times, six times, or more. The method may also include discarding one or more pipette tips, placing one or more new pipette tips on a distal end of a pipettor unit, or both. For example, separate pipette tips may be used for sample, one or more reagents, and waste liquid removal.

Any of the foregoing implementations of a method of sample preparation may be automated. Thus, the system may comprise a computer-readable storage medium (e.g., a non-transitory computer-readable storage medium) including instructions, which upon execution cause a computer system to perform any of the foregoing methods. In some implementations, the computer-readable storage medium may include instructions, which upon execution cause a computer system to pipette a sample, one or more reagents, or both from a removable reagent cartridge and into a capsule rotor and rotate the capsule rotor at a high rate of speed (perform centrifuging operations). In some implementations, instructions, upon execution, cause a computer system to pipette a sample from a separate sample container or a reagent cartridge into a capsule rotor, pipette one or more reagents from a removable reagent cartridge and into the capsule rotor, and rotate the capsule rotor at a high rate of speed (perform centrifuging operations). The computer-readable storage medium may further comprise instructions, which upon execution cause a computer system to raise a chamber member, lower the chamber member, or both. The computer-readable storage medium may further comprise instructions, which upon execution cause a computer system to control a capper mechanism. The computer-readable storage medium may comprise instructions, which upon execution cause a computer system to open a door, close the door, or both. The instructions may cause the computer system to pipette waste liquid from a capsule rotor and dispose of the waste liquid in a waste well. The instructions may cause a computer system to control one or more fans, operate one or more resistive heating elements, operate one or more cooling elements, or combinations of two or more thereof. The instructions may cause a computer system to control an RFID tag reader/writer, a barcode reader, or both.

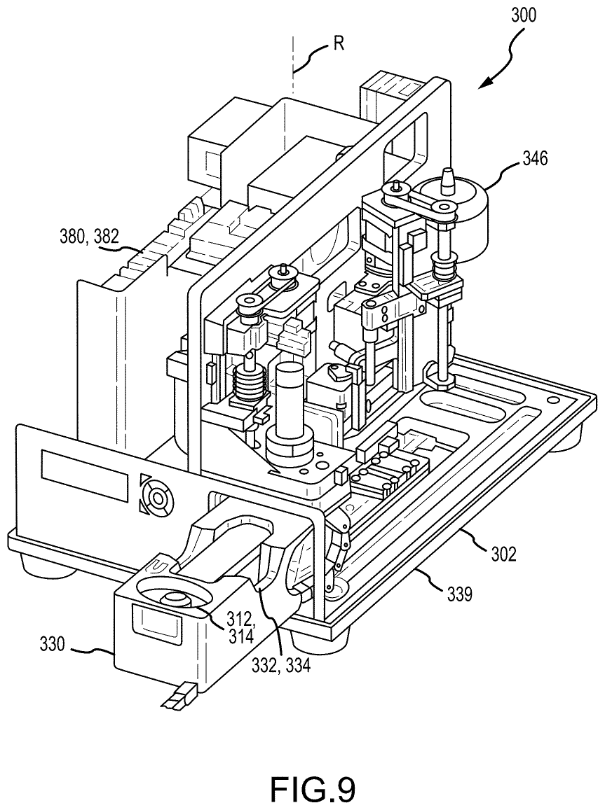

FIGS. 9-12 show a third implementation of an instrument 300. Components having the same or similar function as in the instrument 100 described above are numbered with the same reference number, plus 200.

The instrument 300 comprises a base member 302 and various components are arranged above and below the base member 302. The instrument 300 comprises a centrifuge station 310, as described above.

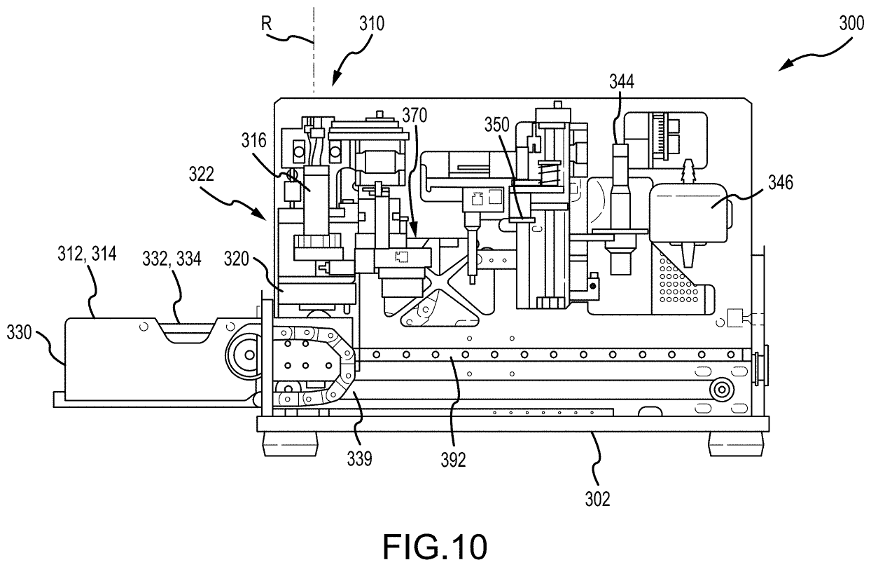

In the instrument 300, the translating stage 330 is controlled to translate back and forth along a defined path 392 as various phases of operation are completed. Referring to FIGS. 9 and 10, the translating stage 330 (shuttle), which is shown in the load position, has a capsule rotor seat 312 for receiving and holding the capsule rotor 314 and a reagent cartridge receiving area 332 for receiving and holding the reagent cartridge 334. Although not shown, a sample container can also be provided in the translating stage 330. The translating stage 330 is controllably moved along the path 392 by a shuttle movement mechanism 339.

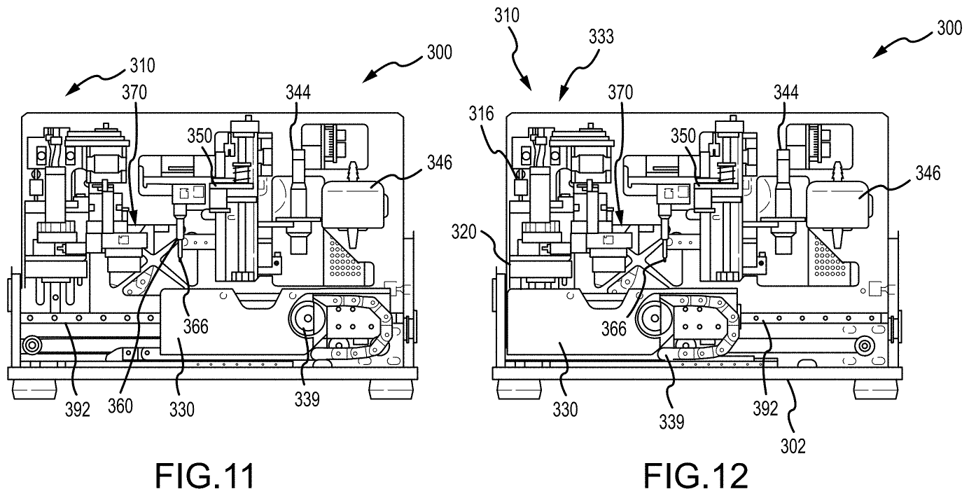

In FIG. 11, the translating stage 330 has been moved from left to right to transition from the load position (FIG. 10) to the pipette position. A pipette tip 366 on the distal end 360 of the pipettor unit 350 may be aligned above the capsule rotor 314 in preparation to be lowered for distributing reagent (or sample) into the capsule rotor 314. The translating stage 330 can be moved forward and back along the path 392 to allow the pipettor unit 350 to access different reagent wells and other locations (e.g., for waste and pipette caps) on the reagent cartridge 334.

In FIG. 12, the translating stage 330 has been moved from right to left to transition from the pipette position to the capsule drive (centrifuging) position. In FIG. 12, the capsule rotor 314 is aligned as shown with the chamber member 320. Subsequently, the chamber member 320 is lowered into position relative to the capsule rotor 314 (not shown) with a chamber member movement mechanism 333 so that centrifuging can be commenced. In the instrument 300, the centrifuge motor 316 extends vertically above the capsule rotor 314 (as opposed to below it in the instruments 100 and 200). The instrument 300 may comprise an air pump 344 operable to generate a positive pressure, as described above, and a filter 346 (e.g., a HEPA filter) to filter contaminants from the air.

If desired, one or more capping mechanisms 370 can be provided to uncap and cap the sample container and/or the capsule rotor 314.

The instrument 300 may have a circuit board 380, which may comprise at least a control circuit 382, as described above.

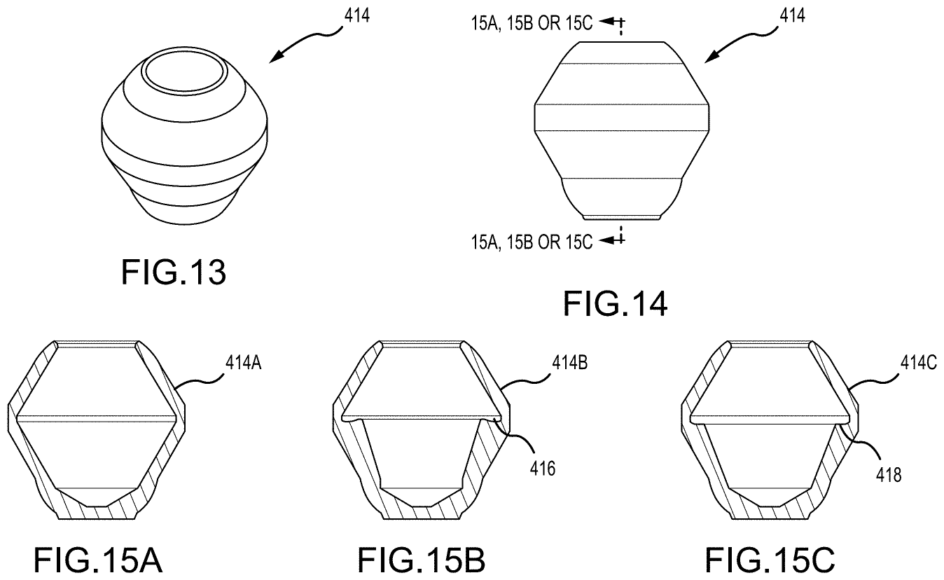

Referring to FIG. 13, a representative capsule rotor 414 that can be used with any of the instruments described above for centrifuging is shown. FIG. 14 is a side elevation view of the capsule rotor 414. FIGS. 15A, 15B and 15C are sectioned views in elevation showing alternative internal configurations 414A, 414B and 414C, respectively, of the capsule rotor 414.

The internal configuration 414A is also referred to herein as the normal configuration or design. The internal configuration 414B has a peripheral trough 416 and is referred to herein as the trough configuration or design. The internal configuration 414C has a peripheral shelf 418, referred to herein as the shelf configuration or design.

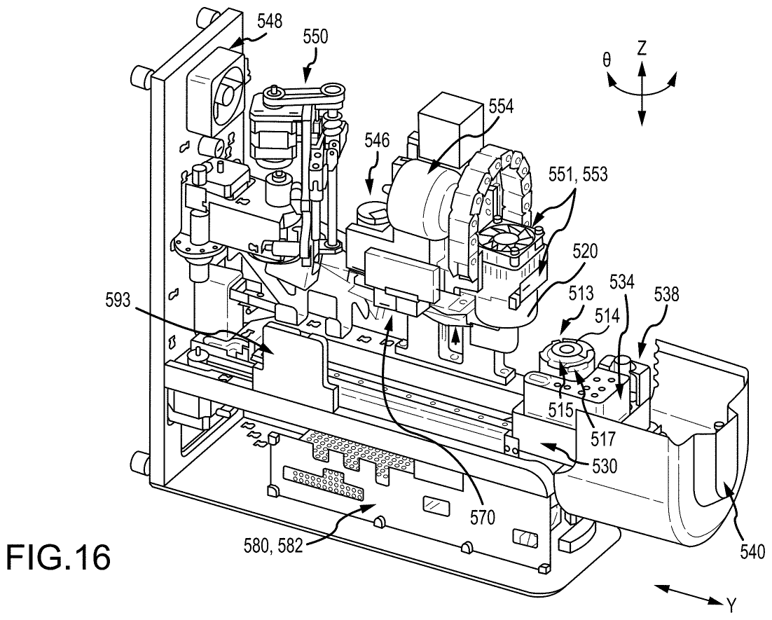

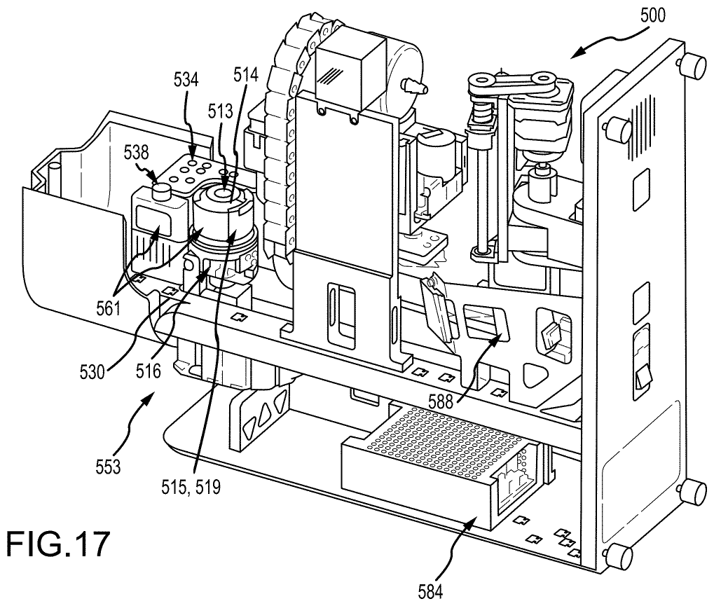

FIGS. 16-17 show a fourth implementation of an instrument 500. Components having the same or similar function as in the instrument 100 described above are numbered with the same reference number, plus 400.

In the instrument 500, the translating stage 530 (shuttle) is controlled to translate back and forth along a path (or track) 592, which is defined as extending in the Y direction, as various phases of operation are completed. Sensors, including fiber optic LED units (not shown), can be used to assist in achieving precise controllable movements of the translating stage 530 and other moving components of the instrument 500.

Referring to FIGS. 16 and 17, the instrument 500 is shown with its outer housing removed for ease of illustration. A door 540 can be pivoted to an open position as shown, such as in a manual or automatic operation. The translating stage 530 is shown in its load/unload position, which is the position closest to the door 540.

Within the translating stage 530, there are defined areas in which the reagent cartridge 534 and the sample container 538 are received, as shown.

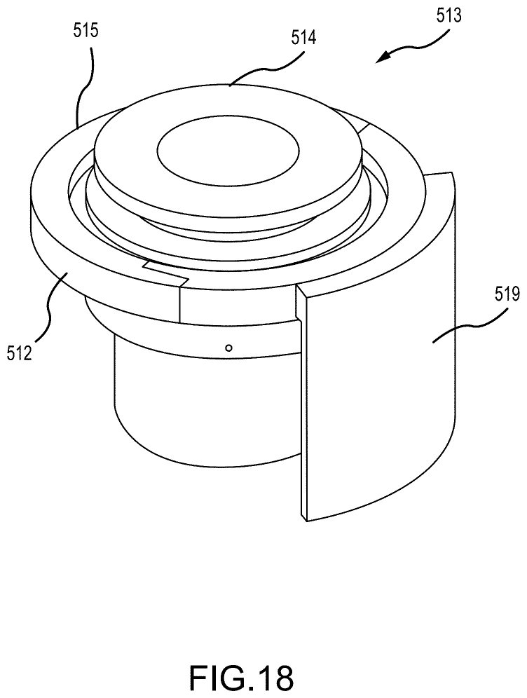

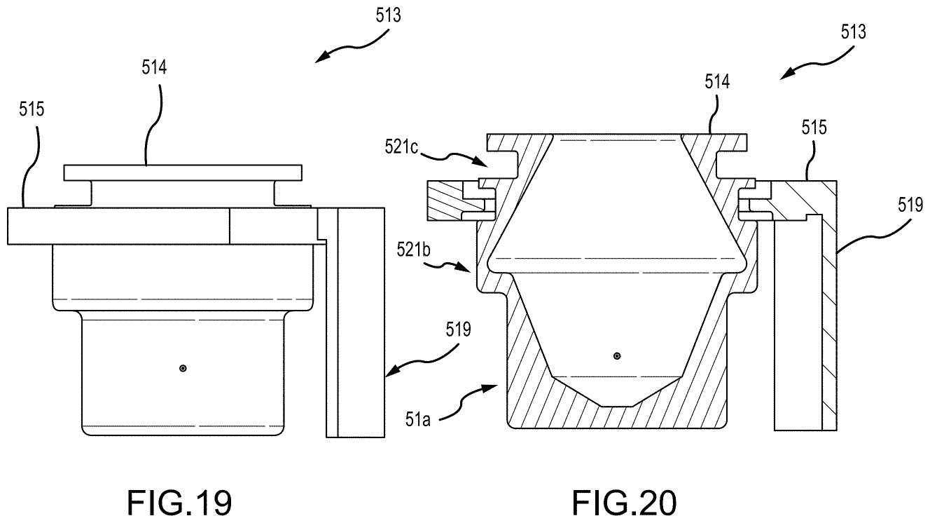

The capsule rotor 514, which can be configured as a capsule rotor assembly 513 in this implementation, is also positioned in a defined area of the translating stage 530, (see capsule rotor assembly 513 in FIGS. 18-20). Specifically, the capsule rotor assembly 513 has an apron 515 or other structure that at least partially surrounds the centrally positioned capsule rotor 514. The apron 515, which remains stationary, supports the capsule rotor for high speed rotation relative to the apron 515. The apron 515 can be configured so that it remains coupled to the capsule rotor during normal use, and it is not easily disconnected from the capsule rotor. In this way the capsule rotor assembly 513 can be conveniently manipulated as a single assembly rather than multiple separate pieces.

Also, the apron 515 or other stationary structure can provide a convenient location on which to include a label to identify the specimen in the capsule rotor 514. The apron 515 remains stationary during centrifuging, whereas the high speeds at which the capsule is rotated can make it difficult to keep a label attached to capsule rotor 514 in a reliable way. The apron 515 is designed to remain coupled to the capsule rotor 514 during normal use, and it may be configured to provide an easy visual indication if it has been uncoupled from its respective capsule rotor. In this way, the label applied to the apron 515 can be more reliable as an accurate indicator of the coupled capsule rotor 514 and the sample contained therein.

The label or tag can be a bar code or other machine-readable indicia to allow easy and accurate identification. The capsule rotor label and the sample vial label, e.g., as shown as 561 in FIG. 17, may have the same or coordinated information. A bar code reader and writer 588 can be incorporated into the instrument to prepare labels and communicate the information contained within the labels. An RFID reader 593 (shown in FIG. 16) may also be incorporated, thereby enabling the instrument to recognize consumable kits and/or components thereof and to track their use. Handwritten labels may be accommodated, including with optional imaging thereof.

Further details of the capsule rotor assembly 513 and its configuration are described in connection with FIGS. 18, 19 and 20. As shown in FIGS. 18-20, the apron 515 can be provided in two pieces that fit together to form a rim 512 surrounding and rotatably supporting the capsule rotor 514. The apron 515 can have a suitable label area 519, such as at the side of the assembly as shown, so that a user can access it to apply the label as described above. The label area 519 is also designed to remain visible to a user during use of the instrument and subsequent handling.

Referring to FIG. 20, which shows a cross-section of the capsule rotor assembly 513 in elevation, the capsule rotor 514 can have any suitable internal configuration, such as a peripheral shelf or shelf configuration similar to the internal configuration 414C shown in FIG. 15C.

The capsule rotor 514 can have an external configuration designed to facilitate engagement of the capsule rotor 514 with other components. First, the capsule rotor 514 can have a stepped outer diameter with a lead-in section 521a of a smaller diameter and an engagement section 521b of a larger diameter. The capsule rotor 514 can also be configured with a lip 521c near its upper end. In other embodiments, the capsule rotor has an external geometry similar to the examples in FIG. 13, 14, 15A, 15B, or 15C, or a similar suitable geometry.

As shown in FIG. 16, the capsule rotor assembly 513 is received in a capsule rotor assembly receiver 517. Specifically, the rotor assembly receiver 517 is designed to retain the apron 515 in a stationary position so that the capsule rotor 514 can be rotated at high speed relative to the apron 515 during centrifuging.

Referring to FIG. 17, the centrifuging is carried out with a centrifuging motor 516 configured as a single-sided drive and mounted below the rotor assembly receiver 517. The centrifuging motor 516 is coupled to and travels with the translating stage 530. Because the drive is single-sided in the instrument 500, the capsule rotor 514 can be rotated during centrifuging without requiring precisely aligned supporting points from above and below the capsule rotor. As a result, the single-sided drive can be configured to occupy less space than dual-sided drives. Also, it has been found that the single-sided drive produces less vibration, which is beneficial generally as well in use of the instrument in settings where such vibration can detract from the performance and reliability of other systems, such as other nearby instruments and equipment. Further, the single-sided drive is quieter than dual-sided drives during operation.

During initial loading, the user places the capsule rotor assembly 513 in the rotor assembly receiver 517, which can be configured to exert a force to draw the capsule rotor 514 downwardly and into engagement with the drive, so that the engagement section 521b is engaged. Alternatively, the user can manually press the capsule rotor 514 downwardly to engage it with the drive. The label area 519 of the apron 515 remains visible as shown in FIG. 17 when the capsule rotor 514 is engaged and generally throughout the operation sequence.

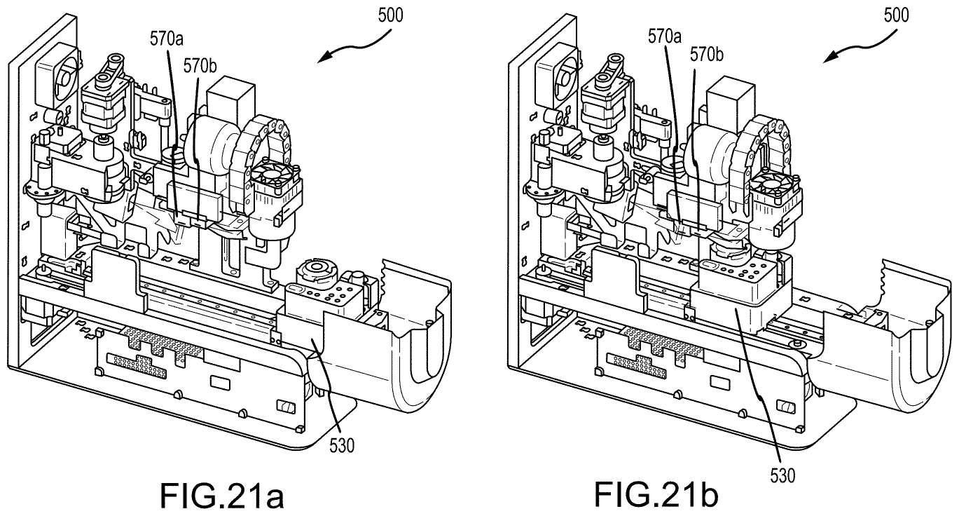

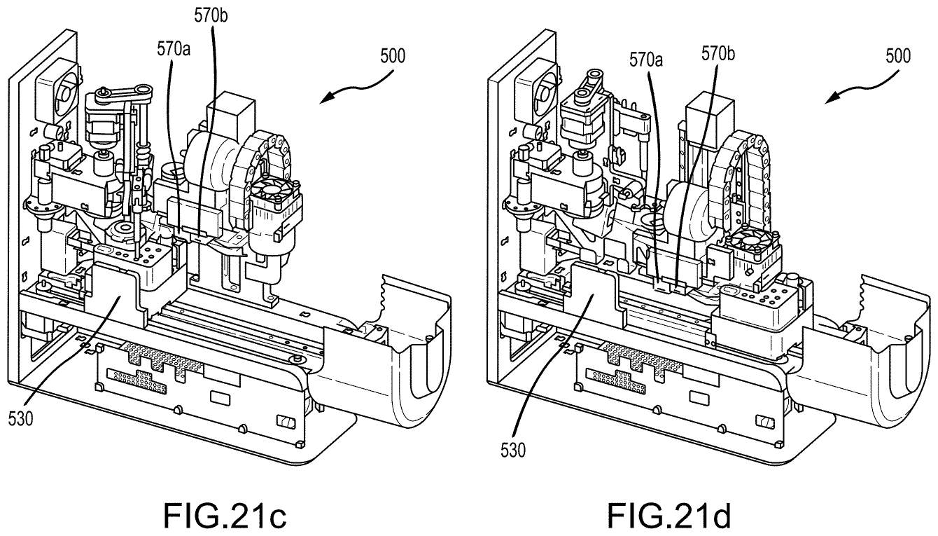

According to one operation sequence, the loading operation described above is followed by one or more cap removal operations. Referring to FIGS. 21a-21d, the translating stage 530 is moved from its load/unload position (FIGS. 16, 17 and 21a) to a capsule rotor cap removal position as shown in FIG. 21b, with the translating stage 530 positioned under one or more capping devices 570a, 570b. In the illustrated implementation, there are two separately operated capping devices 570a, 570b, but it is also possible to configure the instrument with a single capping device or more than two capping devices.

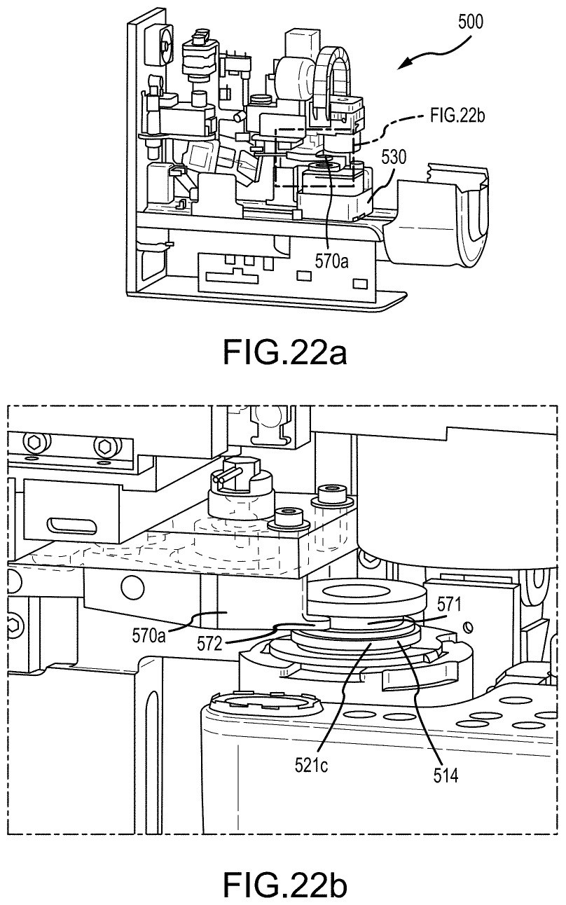

FIGS. 22a and 22b show the first capping device 570a in greater detail. The first capping device 570a is configured to remove a cap 571, which is shown in its fully installed position just prior to removal in FIG. 22b, from the capsule rotor 514. As shown in FIGS. 22a and 22b, the capping device 570a has a pair of jaws or grippers 572 that open in the direction of the door 540 and are controllable to move into engagement under a lip of the cap 571 as shown. The movements can include movement in the vertical or Z direction downwardly to the level of a lip of the cap 571 as shown, and then movement of the shuttle in the Y direction to cause the grippers to pass around the lip engage the cap 571 (i.e., driving the grippers around the lip). The capping device 570a can then be withdrawn upwardly to remove the cap from the capsule rotor 514. The translating stage 530 can then be controlled to move to another position for its next function.

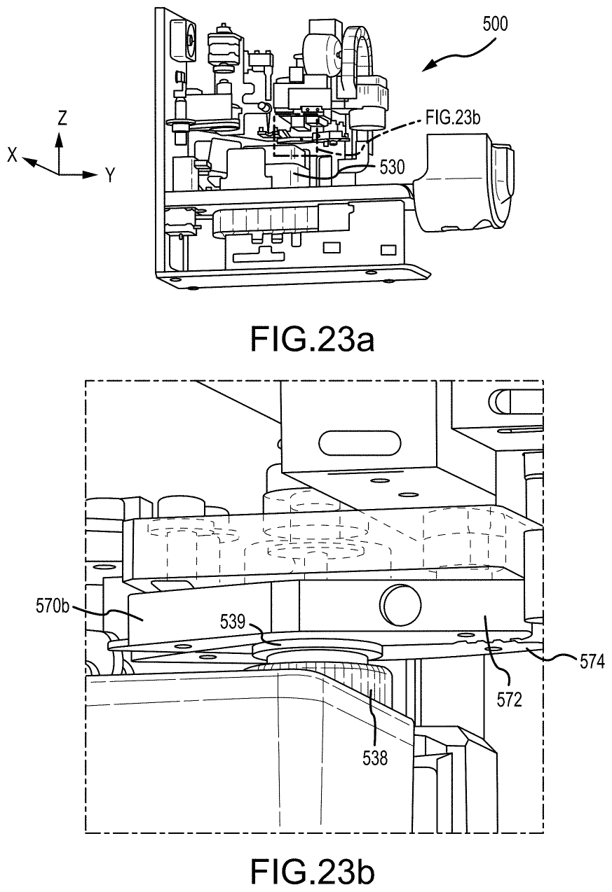

FIGS. 23a and 23b show the second capping device 570b in more detail. The capping device 570b is spaced from the capping device 570a along the Y direction and is also offset from it in the X direction, consistent with the positions of the sample container 538 and the capsule rotor 514 relative to each other within the translating stage 530. The capping device 570b has a pair of jaws or grippers 572, 574 as shown in FIG. 23b that are controllable to engage a cap 539 on the sample container 538 as shown, which can include movement in the vertical or Z direction downwardly to the to the level of the cap 539 as shown. In the illustrated implementation, the translating stage 530 is moved to the position shown in FIG. 23a, which drives the grippers 572, 574 around the cap 539. The grippers 572, 574 of the capping device 570b can be positioned to open in a direction opposite the door, i.e., opposite the grippers 572, 574 of the capping device 570b. The capping device 570b can be withdrawn upwardly to remove the cap 539 from the sample container 538. The translating stage 530 can then be controlled to move to another position for its next function.

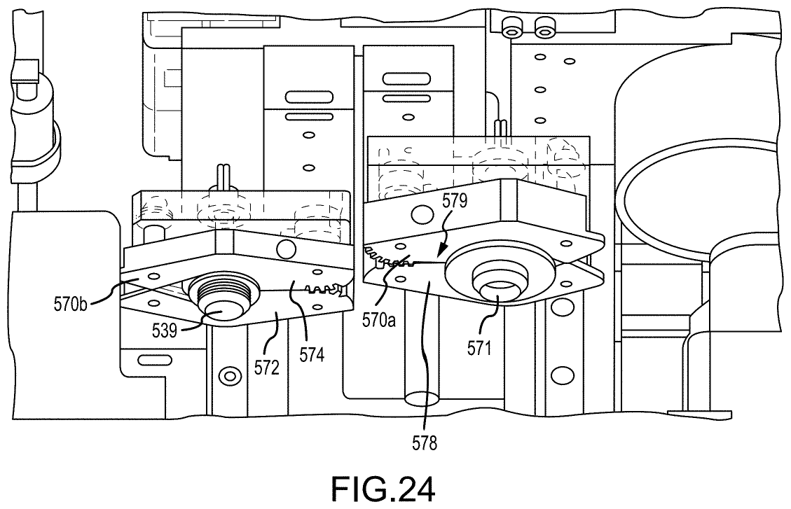

FIG. 24 is a detailed view of a portion of the instrument 500 showing the capping device 570a with the cap 571 retained in its grippers 578, 579 and the capping device 570b with the cap 539 retained in its grippers 572, 574, respectively. The steps described above can generally be reversed to replace the caps 539, 571, on the capsule rotor 514 and sample container, respectively. In addition, once the cap 571 has been inserted in the capsule rotor 514, the translating stage 530 can be moved to align a flat portion of the grippers 572, 574 of the capping device 570a with the cap 571, and a vertical downward movement of the grippers 572, 574 can be used to “tamp” or urge the cap 571 into a fully seated position. Similarly, once the cap 539 has been inserted on the sample container 538, the translating stage 530 can be moved to align a flat portion of the grippers 572, 574 of the capping device 570b with the cap 539, and a vertical downward movement of the grippers 572, 574 can be used to “tamp” or urge the cap 539 into a fully seated position.

Following cap removal, the translating stage 530 can be controlled to move to the pipetting position shown in FIG. 21c. In the instrument 500, the pipettor unit 550 can be moved from its at-rest position (FIG. 16) downwardly (i.e., along a Z axis) to the position shown in FIG. 21c to access the reagent cartridge 534, the sample container 538 and/or the capsule rotor 514. As also shown, the pipettor unit 550 is rotatable in a θ direction, such that most or all necessary locations can be accessed without moving the translating stage 530. As also described above, optional reflective fiber optic LED units (not shown) can be mounted to indicate a location of the capsule rotor/capsule rotor cap and/or the sample container/sample container cap relative to the pipettor unit 550, as well to coordinate other movements between various components.

In the pipetting position, specimen can be transferred from the sample container 538 and delivered to the capsule rotor 514. One or more reagents can be transferred in selected quantities from respective reagent cartridge locations to the capsule rotor 514. Each transfer can be carried out with a fresh pipette tip retrieved from the reagent cartridge. Used pipette tips can be ejected into a location on the reagent cartridge, on the translating stage 530 or another desired location. Waste sample and waste reagent can be received in one or more wells of the reagent cartridge or another suitable area.

Thereafter, the translating stage 530 is moved to the centrifuging position shown in FIG. 21d. The chamber 520 is lowered into contact with the apron 515, and the drive is controlled to rotate the capsule rotor 514 according to a specified schedule.

The instrument 500 can be configured with additional heating and cooling devices to regulate environmental conditions. In addition to the fan 548 at the rear of the instrument, a fan 551 is positioned over the chamber 520 as shown in FIG. 16. There is also an additional fan 553 positioned on the translating stage 530 near the centrifuging motor 516, which assists in cooling the bearings of the centrifuging motor 516, which in turn also helps to cool the chamber 520. A cooling element 553 can be positioned near the chamber 520 for selectively cooling the chamber 520. In addition, the chamber 520 can be fitted with a resistive heating element to selectively heat the chamber 520 and the capsule rotor 514 and its contents.

The instrument 500 has a compact footprint. For example, the footprint of the instrument 500 is considerably smaller than the footprint of the instrument 300 shown in FIGS. 9-12. In various embodiments, two instances of the instrument 500 positioned side by side can be accommodated within the footprint of one conventional ID/AST system. The single-sided drive of the centrifuging motor 516 and the linear movement of the translating stage 530 contribute to an overall compact footprint, which requires less bench space in a typical laboratory setting where instruments of other kinds and other activities must also be accommodated. Moreover, the pipettor 550 that is configured to stroke in the Z direction and rotate in the 0 direction, without requiring movement in the Y direction, is more compact.

Also, the door 540 in the instrument 500 can be configured for manual actuation. Although not required, the manual door 540 serves to reduce the complexity of instrument functions and decreases the size of the housing needed for the instrument. In a preferred configuration, a notch in the door 540 permits a user to manually open the door 540 for loading and unloading. The door 540 can have a safeguarding magnet serving to keep the door closed when loading or unloading is not taking place until the translating stage 530 is controlled to move away from the door 540. Movement of the translating stage 530 during operation can be accompanied by a signal to lock the door 540.

Also, the circuit board or circuit boards can use dual-sided circuit board architecture to reduce their size.

In the instrument 300 as shown, e.g., in FIG. 9, large support bearings are positioned on each side of the dual-sided drive for the capsule rotor. In various embodiments of the instrument 500, a pair of preloaded bearings are coupled together by a fastener to form a spindle. These bearings are housed in a single component as opposed to in two components at two spaced apart locations. The capsule rotor 514 is retained without an upper support, which reduces tolerance needs and tolerance stack ups. Wobbling that may arise with the two-sided drives is also reduced. The single-sided drive typically does not require the tuning required for two-sided drives, which makes the instrument 500 easier to manufacture.

As stated, the instrument 500 produces less vibration. The instrument 500 can be fitted with lower profile feet than the instrument 300 shown in FIG. 9. The instrument 500 can be positioned near another instrument, e.g., a separate ID/AST system, without negatively affecting its imaging or other precision functions.

In the instrument 500, environmental control in and around the chamber 520 is improved. Temperature fluctuations, particularly overheating, are addressed by providing for more air movement, such as by providing additional fans, including the fans 551 and 553 as described. An optional heating element, e.g., a resistive heating element, may be also be used. The temperature of the environment within the instrument is maintained within a specific range. For example, the instrument temperature may be kept within a range that is conducive to incubating and growing microorganisms in a sample, such as a cleansed sample located in the capsule rotor 514. In addition, waste heat emanating from the motor(s) and other device operating within the instrument can be used. Temperature control may be achieved using a thermoelectric device, and/or the instrument may employ liquid cooling technologies. Programmed automatic temperature control can be implemented such that heating and cooling are triggered to prevent the instrument from falling below or exceeding selected minimum and maximum temperature values.

As in other embodiments, and according to another aspect of environmental control, the capsule rotor 514 may be sealed within the capsule chamber 520 prior to spinning the capsule rotor 514. A vacuum pump 546 may be used to pull air from the chamber 520 through a filter 554 and exhaust it.

Consumable components, such as the capsule rotor 514, the sample container 538, reagent cartridges, pipette tips and the like may be arranged into a disposable kit. The kit may comprise buffers and other materials necessary to cleanse or otherwise prepare samples. The reagent kit may also serve as a reservoir for waste, as described above.

The sample container may be any suitable container for holding biological samples, such as a tube, cuvette or a vial. In a preferred embodiment, the sample is introduced into a vial that is a component of a disposable consumable kit and tagged with a bar code label or other indicia. The sample vial may also be compatible with, and may be transferred to, a downstream sample testing platform such as one capable of performing identification of microorganisms in the sample, antimicrobial susceptibility, genotypic testing of microorganisms, and the like.

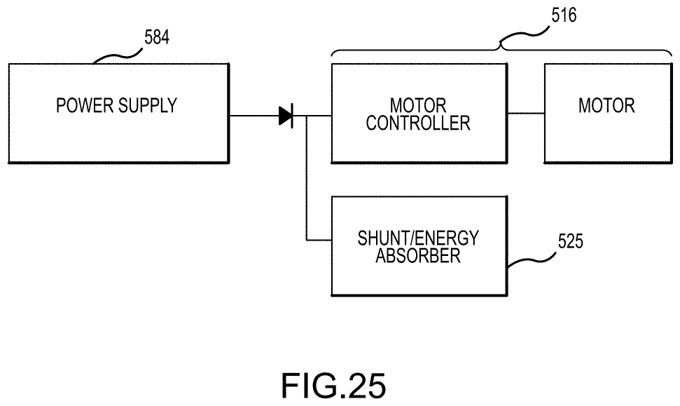

As shown in FIG. 25, the centrifuging motor 516 can be configured with an optional shunt 525 or other energy absorbing circuit element that serves to dissipate excess electrical energy produced by the motor's deceleration from high speed rotation. The regenerative energy generated by the rotation of the motor and its load above a selected limit can be directed to sink to the shunt 525 instead of to the motor's internal resistance, servo drive and power supply 584. In this way, the shunt 525 can be configured to protect components of the motor, circuit board(s) (including the main electrical control board 582) and control circuit 580.

Methods of Sample Preparation Using an Automated Sample Preparation System

A method of sample preparation using an instrument, such as instrument 300 or 500 may comprise: placing a capsule rotor in a capsule rotor seat; introducing a sample into the capsule rotor; pipetting one or more reagents from a removable reagent cartridge and into the capsule rotor; and rotating the capsule rotor at a high rate of speed (centrifuging).

In various embodiments, introducing a sample into the capsule rotor may comprise: (a) placing the sample in the capsule rotor before the capsule rotor is introduced into the capsule rotor seat; or (b) pipetting the sample from a sample container and into the capsule rotor after the capsule rotor is place in the capsule rotor seat.

The method may include removing a supernatant from the capsule rotor.

The method may also include resuspending a pellet in the capsule rotor by repeating pipetting of one or more reagents from the removable reagent cartridge and into the capsule rotor. Once the pellet is resuspended, the capsule rotor may again be rotated at a high rate of speed (centrifuged). This cycle of pipetting reagents into the capsule rotor, centrifugation, and waste removal may be repeated as many times as necessary to remove or dilute inhibiting substances that may be in the original sample.

In various embodiments, pipetting one or more reagents from a removable reagent cartridge may comprise moving the translating stage forward and back along a path and raising and lowering a pipettor unit to allow the pipettor unit access to different reagent wells. Pipetting may be performed once or may be repeated as many times as necessary to draw as many reagents, of whatever volume, as desired into the pipette tip, so long as the total volume drawn into the pipette tip does not exceed the capacity of the pipette tip. Pipetting one or more reagents into the capsule rotor may comprise moving the translating stage along the path to align a pipette tip with the capsule rotor and delivering the sample into the capsule rotor. The cycle of pipetting one or more reagents from a removable reagent cartridge and into the capsule rotor may be performed once or may be repeated as many times as necessary to deliver the desired quantity of liquid to the capsule rotor. After all reagent(s) have been delivered to the capsule rotor, the pipettor unit may be raised to move it out of the way.

Centrifuging may be carried out by moving the translating stage to a capsule drive (centrifuging) position. A chamber member may be lowered into position. The capsule rotor may then be rotated at high rates of speed to effect centrifuging the contents of the capsule rotor (sample and reagent(s)). After centrifugation, the chamber member may be raised. Then the translating stage may be moved to another position for unloading the capsule rotor, or the translating stage may be moved to a pipetting position to permit disposal of waste liquid (supernatant) from the capsule rotor before the translating stage is moved to another position for unloading the capsule rotor.

Thus, the method may also include pipetting waste liquid from the capsule rotor and disposing the waste in a waste well. Pipetting waste liquid from the capsule rotor and disposing the waste liquid in a waste well may comprise moving the translating stage along the path to align a pipette tip with the capsule rotor, lowering a pipettor unit to bring the pipette tip into fluid contact with the supernatant, drawing waste liquid into the pipette tip, raising the pipettor unit and moving the translating stage along the path to align the pipette tip with a waste well, lowering the pipettor unit so the pipette tip is within or a short distance above a waste well, and depositing the waste liquid in the waste well. The pipettor unit may then be raised out of the way. The waste removal procedure may be performed once or may be repeated as many times as necessary to remove the desired amount of waste liquid from the capsule rotor.

One or more steps of introducing the sample into the capsule rotor, pipetting the one or more reagents from a removable reagent cartridge into the capsule rotor, performing centrifuging operations on the sample (centrifuging the sample) by rotating the capsule rotor at a high rate of speed, pipetting waste liquid from the capsule rotor and disposing the waste into a waste well may be automated. For example, one or more of these steps may be performed by executing a set of instructions stored in a computer-readable storage medium, which instructions, upon execution by a computer system, cause the computer system to perform the recited steps.

In some implementations, the method may include removing a cap, replacing a cap, or both, on the capsule rotor, e.g., with a capper mechanism. The capper mechanism may be lowered from a raised position until it is in contact with a cap of the capsule rotor. The capper mechanism may then remove the cap and move to a raised position, still holding the cap. The capper mechanism may then replace the cap on the capsule rotor, e.g. after the sample, reagent(s), or both, are placed in the capsule rotor. Removing a cap, replacing a cap, lowering the capper mechanism, raising the capper mechanism, or combinations thereof, may be automated. For example, one or more steps may be performed by executing a set of instructions stored in a computer-readable storage medium, which instructions, upon execution by a computer system, cause the computer system to perform the recited steps.

In some implementations, a sample may be introduced into the capsule rotor before the capsule rotor is placed in the capsule rotor seat. In some other implementations, the sample may be placed in the capsule rotor by a pipettor unit, which may be automated. The sample initially may be in a separate sample container or in a sample container incorporated into a removable reagent cartridge. In either case, one or more reagents may be placed in the capsule rotor by a pipettor unit, as described above. Once sample and one or more reagents are in the capsule rotor and the pipettor unit is moved out of the way, the capper mechanism may then place the cap back on the capsule rotor. Once the capper mechanism is moved out of the way, a chamber member may be lowered, a door may be closed, or both. Then, the capsule rotor containing the sample, one or more reagents, or both, may be subjected to centrifuging operations (centrifuged) by rotating the capsule rotor at high speeds, thereby achieving centrifugation. One or more steps of moving the pipettor arm into location over a desired reagent in the reagent cartridge, lowering the pipettor until the distal end of the pipettor arm is in contact with the reagent, loading the reagent in the pipettor arm, raising the pipettor arm, moving the pipettor to a position aligned with the capsule rotor, lowering the pipettor arm, and emptying the pipettor arm into the capsule rotor, moving the pipettor unit out of the way, placing a cap on the capsule rotor, lowering a chamber member, and closing a door may be automated. For example, one or more of these steps may be performed by executing a set of instructions stored in a computer-readable storage medium, which instructions, upon execution by a computer system, cause the computer system to perform the recited steps.

The method may comprise one, two, three, four, five, six, seven, or more cleanup cycles, i.e., cycles of reagent placement, centrifugation, and waste removal and disposal. As an illustration, the method may comprise, with a pipettor unit, placing sample in the capsule rotor and placing a first reagent or combination of reagents in the capsule rotor, rotating the capsule rotor at high speeds a first time, with the pipettor, removing a first waste liquid from the capsule rotor and disposing of the waste liquid in a waste well, with the pipettor placing a second reagent in the capsule rotor (e.g., resuspending the pellet), rotating the capsule rotor at high speeds a second time, and optionally removing a second waste liquid from the capsule rotor. The cycle of removing a waste liquid from the capsule rotor and disposing of the waste liquid in a waste well, placing a next reagent in the capsule rotor (e.g., resuspending the pellet), and rotating the capsule rotor at high speeds another time, may be repeated as many times as necessary to effect cleanup, e.g., once, twice, thrice, four times, five times, six times, or more. The method may also include discarding one or more pipette tips, placing one or more new pipette tips on a distal end of a pipettor unit, or both. For example, separate pipette tips may be used for sample, one or more reagents, and waste liquid removal.

Any of the foregoing implementations of a method of sample preparation may be automated. Thus, the system may comprise a computer-readable storage medium (e.g., a non-transitory computer-readable storage medium) including instructions, which upon execution cause a computer system to perform any of the foregoing methods. In some implementations, the computer-readable storage medium may include instructions, which upon execution cause a computer system to pipette a sample, one or more reagents, or both from a removable reagent cartridge and into a capsule rotor and rotate the capsule rotor at a high rate of speed (perform centrifuging operations). In some implementations, instructions, upon execution, cause a computer system to pipette a sample from a separate sample container or a reagent cartridge into a capsule rotor, pipette one or more reagents from a removable reagent cartridge and into the capsule rotor, and rotate the capsule rotor at a high rate of speed (perform centrifuging operations). The computer-readable storage medium may further comprise instructions, which upon execution cause a computer system to raise a chamber member, lower the chamber member, or both. The computer-readable storage medium may further comprise instructions, which upon execution cause a computer system to control a capper mechanism. The computer-readable storage medium may comprise instructions, which upon execution cause a computer system to open a door, close the door, or both. The instructions may cause the computer system to pipette waste liquid from a capsule rotor and dispose of the waste liquid in a waste well. The instructions may cause a computer system to control one or more fans, operate one or more resistive heating elements, operate one or more cooling elements, or combinations of two or more thereof. The instructions may cause a computer system to control an RFID tag reader/writer, a barcode reader, or both.

System Evaluation

When referring to various instrument features, components and reagents in the experimental testing discussed herein, the following abbreviations will apply:

### Abbreviations

ABAU Acinetobacter baumannii
BAL Bronchoalveolar lavage
BB Breadboard model
BP Bacterial pneumonia
CAMHB Calcium adjusted Mueller Hinton broth
CITF Citrobacter freundii
CITK Citrobacter koseri
DOE Design of experiments
ECOL Escherichia coli
ENTA Enterobacter aerogenes
ENTC Enterobacter cloacae
EKC Electrokinetic concentration
FM Functional model
HINF Haemophilus influenzae
KLPN Klebsiella pneumoniae
KOXY Klebsiella oxytoca
MHA Mueller Hinton agar
NF Normal flora
OD Optical density
PRMI Proteus mirabilis
PROV Proteus vulgaris
PSAR Pseudomonas aeruginosa
RAM Respiratory artificial matrix

### r/s Rate/second

rpm Revolutions per minute
SOC Standard of care
SAUR Staphylococcus aureus
SERM Serratia marcescens
STMA Stenotrophomonas maltophilia
STPN Streptococcus pneumoniae

### Bug(s) Microorganism(s) or Organism(s)

A key aspect of implementations employing an automated instrument system is the manipulation of samples to remove debris, proteins (e.g., enzymes) and the like without harming the pathogens responsible for causing illness in the patient from whom the sample was collected. To automate the sample preparation and provide a cleaned sample without inhibitory substances, multiple concepts were tested. An exemplary assay design was selected for processing respiratory specimens. This exemplary assay utilizes a disposable capsule rotor having an internal annular flange and a reagent cartridge filled with various reagents, such as wash fluids. The assay utilizes 1.5 mL of respiratory BAL or mini-BAL specimen which is mixed by the automated sample preparation system with 0.5 mL of a pellet forming reagent. These components are pipetted repeatedly until resuspended and after which the resuspended sample is subjected to a series of five rinsing steps. Each of the five “rinses” entails centrifuging resuspended sample for 5 minutes at 20,000 rpm in the presence of varying wash fluids, followed by removal of supernatant after centrifugation concludes and the addition of more wash fluid. Rinses taper from 0.1× cation-adjusted Mueller Hinton Broth (CAMIHB) to 1 mM L-Histidine. Each rinse comprises 1.5 mL of wash fluid with the final resuspension occurring in 1 mM L-Histidine, a buffer that provides optimal capture and recovery in at least one downstream sample analysis system that was tested.

### EXAMPLES

### Experimental Design #1: Optimal Sample Pelleting for Cell Retention

Many parameters may be altered to influence the pelleting efficiency of a sample in the implementations of the automated sample preparation system. This study was designed to determine the most optimal set of conditions that will facilitate the highest cell retention of a sample upon completion of the sample preparation process. The parameters altered in this study included the pelleting peak speed, duration at pelleting speed, speed of deceleration from peak speed to 1000 rpm (first deceleration), speed of deceleration from 1000 rpm to 0 rpm (second deceleration), capsule material type and sample volume.

### Method

The following values for each parameter were tested under a design of experiment (DOE) matrix created using the DOE Wisdom software program (Launsby Consulting).
Condition 1: Pelleting peak speed: 20,000 rpm vs 30,000 rpm
Condition 2: Duration at peak speed: 300 seconds vs 600 seconds
Condition 3: Speed of deceleration from peak speed to 1000 rpm (first deceleration): 500 r/s vs 3000 r/s
Condition 4: Speed of deceleration from 1000 rpm to 0 rpm (second deceleration): 5 r/s vs 500 r/s
Condition 5: Capsule material type: Polycarbonate vs Delrin
Condition 6: Starting sample volume: 0.5 mL vs 1.5 mL
Ghost condition: Nothing was changed for this variable. This was used to determine the inherent error in the measurement method.

The DOE matrix conditions and their associated values are shown in Table 1.

TABLE 1
Pelleting DOE Matrix

| Run# | Condition 1 | Condition 2 | Condition 3 | | Condition 4 | | Condition 5 | Condition 6 |
|---|---|---|---|---|---|---|---|---|
| 1 | 20,000 rpm | 300 s | 500 | r/s | 5 | r/s | Polycarbonate | 0.5 mL |
| 2 | 30,000 rpm | 300 s | 3000 | r/s | 5 | r/s | Polycarbonate | 1.5 mL |
| 3 | 30,000 rpm | 600 s | 500 | r/s | 5 | r/s | Delrin | 0.5 mL |
| 4 | 20,000 rpm | 600 s | 3000 | r/s | 5 | r/s | Delrin | 1.5 mL |
| 5 | 30,000 rpm | 600 s | 3000 | r/s | 500 | r/s | Polycarbonate | 0.5 mL |
| 6 | 20,000 rpm | 600 s | 500 | r/s | 500 | r/s | Polycarbonate | 1.5 mL |
| 7 | 20,000 rpm | 300 s | 3000 | r/s | 500 | r/s | Delrin | 0.5 mL |
| 8 | 30,000 rpm | 300 s | 500 | r/s | 500 | r/s | Delrin | 1.5 mL |

All samples were contrived into a negative BAL specimen mimicking an actual patient sample free of interfering substances. All conditions were run using the same automated sample preparation instrument breadboard unit (BB 01) to eliminate variability across instruments. All runs were composed of single spin and resuspension procedures in which the resuspension parameters were held constant. Run 1-8 conditions were conducted with both SAUR_ATCC_29213 and PSAR_ATCC_27853 to understand differences across bacterial isolates. All 16 runs were conducted in a single day and repeated the following day to understand differences across days. Both percent loss in the supernatant and percent recovery in resuspension were measured using quantitative drip plating. Percent loss in the supernatant was used to determine the most successful parameters.

### Summary of Data and Results

Table 2 below summarizes the data from the 32 pelleting DOE runs.

TABLE 2
Percent Loss and Recovery in Supernatant and Resuspension in Pelleting DOE

| | SAUR_ATCC_29213 | | PSAR_ATCC_27853 | |
|---|---|---|---|---|
| Isolate | Supernatant | Resuspension | Supernatant | Resuspension |
| Run 1 | 1.52% | 83.27% | 0.00% | 55.18% |
| Run 2 | 2.33% | 90.32% | 1.27% | 70.07% |
| Run 3 | 2.16% | 85.00% | 2.33% | 64.89% |
| Run 4 | 2.67% | 83.49% | 3.29% | 77.74% |
| Run 5 | 0.00% | 77.04% | 1.05% | 63.97% |
| Run 6 | 0.00% | 88.62% | 0.18% | 94.76% |
| Run 7 | 1.82% | 89.07% | 0.56% | 71.19% |
| Run 8 | 1.26% | 104.07% | 2.33% | 93.70% |

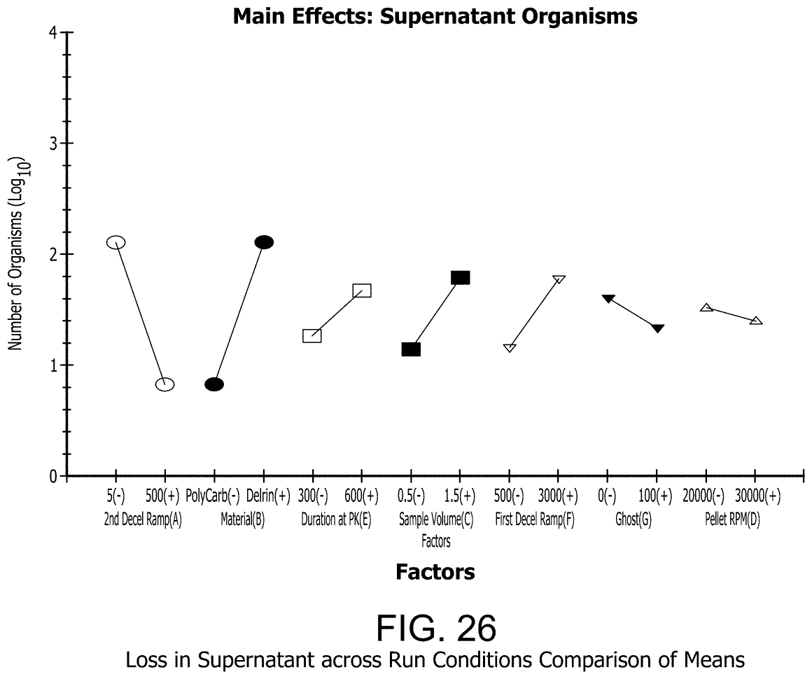

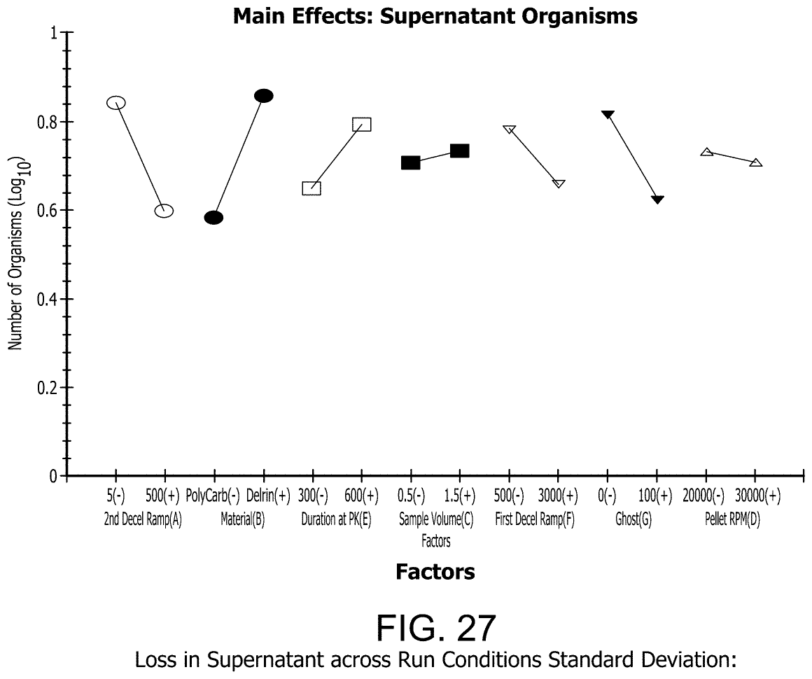

The results of this experiment are summarized in FIGS. 26 and 27, where FIG. 26 shows the mean loss of organisms in supernatant across run conditions, and FIG. 27 shows the percent of organisms lost in the in supernatant. The percentage was taken by averaging all supernatant plate counts and dividing by the total number of samples to get the values represented on the Y-axis. The number of organisms in the supernatant is shown on the Y-Axis (log₁₀ scale) in FIGS. 26-27. In FIGS. 26 and 27, the first two data points (open ovals) from the left compare the number of organisms detected in the supernatant when the speed of deceleration from 1000 rpm to 0 rpm is 5 r/s (first open oval) and 500 r/s (second open oval). The next two data points (darkened ovals) compare the number of organisms detected in the supernatant when the capsule material is polycarbonate (first darkened oval) and Delrin (second darkened ovals). The next two data points (open squares) compare the number of organisms in the supernatant when the duration at peak speed is 300 seconds (first open square) and the 600 seconds (second open square). The next two data points (darkened squares) compare the number of organisms in the supernatant when the sample volume is 0.5 mL (first darkened square) and 1.5 mL (second darkened square). The next two data points (open triangles) compare the number of organisms in the supernatant where the first deceleration ramp from peak speed to 1000 rpm is 500 r/s (first open triangle) or 3000 r/s (second open triangle). The next two data points (darkened triangles) compare the number of organisms in the supernatant where there was no change in the conditions—i.e., ghost variable—showing the inherent error in the measurement method. The last two data points (open triangles pointed up) compare the number of organisms in the supernatant where the peak speed is 20,000 rpm (first open triangle) or 30,000 rpm (second open triangle).

Pelleting DOE Statistics from DOE Wisdom program, with asterisks (*) meaning impact pelleting efficiency. Thus, Second deceleration ramp (A), Material (B), Sample volume (C), and First deceleration ramp (F) impact pelleting efficiency.

DOE Table A.
DOE Wisdom Analysis of Variance

| | Supernatant |
|---|---|
| Dependent Variable: | Bugs |
| Number Runs (N): | 32 |
| Multiple R: | 0.846415 |
| Squared Multiple R: | 0.716418 |
| Adjusted Squared Multiple R: | 0.633706 |
| Standard Error of Estimate: | 0.756018 |

| Variable | Coefficient | Std Error | 95% CI | Tolerance | T | P(2 Tail) |
|---|---|---|---|---|---|---|
| Constant | 1.46563 | 0.133646 | ±0.275832 | | 10.966 | 0 |
| 2nd Decel Ramp(A)* | −0.640625 | 0.133646 | ±0.275832 | 1 | −4.793 | 0 |
| Material(B)* | 0.640625 | 0.133646 | ±0.275832 | 1 | 4.793 | 0 |
| Duration at PK(E) | 0.203125 | 0.133646 | ±0.275832 | 1 | 1.52 | 0.142 |
| Sample Volume(C)* | 0.321875 | 0.133646 | ±0.275832 | 1 | 2.408 | 0.024 |
| First Decel Ramp(F)* | 0.309375 | 0.133646 | ±0.275832 | 1 | 2.315 | 0.029 |
| Ghost(G) | −0.134375 | 0.133646 | ±0.275832 | 1 | −1.005 | 0.325 |
| Pellet RPM(D) | −0.059375 | 0.133646 | ±0.275832 | 1 | −0.444 | 0.661 |

| | Sum of | | | | |
|---|---|---|---|---|---|
| Source | Squares | DF | Mean Square | F Ratio | P |
| Regression | 34.654687 | 7 | 4.9506696 | 8.66164 | 0 |
| Residual | 13.7175 | 24 | 0.5715625 | | |

Ideal conditions predicted by DOE Wisdom program per DOE Table A.

DOE Wisdom Prediction Equation

| | | Super- | | |
|---|---|---|---|---|
| | | natant | Resuspended | |
| | | Bugs | Bugs | D(composite) |
| | | 1.46875 | 103.625 | 0.968501 |
| 95% CI: | | ±1.74452 | ±22.2702 | Not Available |
| Variable | Setting | | | |
| Constant | N/A | 1.46563 | 84.125 | Not Available |
| 2^{nd} Decel Ramp(A) | 500 | −0.640625 | 4.5 | Not Available |
| Material (B) | Delrin | 0.640625 | 3.375 | Not Available |
| Duration at PK(E) | 300 | 0.203125 | −0.75 | Not Available |
| Sample Volume(C) | 1.5 | 0.321875 | 6.3125 | Not Available |
| First Decel Ramp(F) | 500 | 0.309375 | −2.1875 | Not Available |
| Ghost(G) | 0 | −0.134375 | −0.3125 | Not Available |
| Pellet RPM(D) | 20000 | −0.059375 | −2.0625 | Not Available |

### Conclusion

Of the runs completed, run 6 across both isolates provided the lowest loss of isolate in the supernatant while also having the highest recovery in the resuspension. This was using a pelleting speed of 20,000 rpm for 600 seconds with a first deceleration of 500 r/s and a second deceleration of 500 r/s using a polycarbonate capsule and a sample input of 1.5 mL.

The parameters that impact the loss in the supernatant and the preferred value of the parameter were: the first deceleration ramp (500 r/s), the second deceleration ramp (500 r/s), the material type (Delrin) and the starting sample volume (1.5 mL). The pelleting speed and duration at the peak pelleting speed did not have a statistical impact on performance.

The optimal conditions determined from this pelleting DOE were: 1) using a pelleting speed of 20,000 rpm for 300 seconds with a first deceleration of 500 r/s and 2) a second deceleration of 500 r/s using a Delrin capsule and a sample input of 1.5 mL.

### Experimental Design #2: Saline and Heavy Mucus Specimens

A factor that was not tested in the previous experiment but can play a role in pelleting is the viscosity of the specimen. To further understand the role that viscosity plays, an isolate spiked into saline sample was run through an implementation of the automated sample preparation system to understand a no mucus scenario. Given that many negative BAL specimens are very runny or fluid in nature, a thick heavy mucus positive sample was run through a prototype of the automated sample preparation instrument system to understand a high mucus scenario.

### Methods

SAUR_ATCC_29213 was spiked into saline to mimic a no mucus scenario and was run in duplicate across both polycarbonate and Delrin scenarios using the optimized procedure from above with a pelleting speed of 20,000 rpm for 300 seconds with a first and second deceleration of 500 r/s and 1.5 mL of starting sample.

A positive Stenotrophomonas maltophilia specimen, PITT_106, was run in duplicate across both polycarbonate and Delrin scenarios using the optimized procedure from above with a pelleting speed of 20,000 rpm for 300 seconds with a first and second deceleration of 500 r/s and 1.5 mL of starting sample.

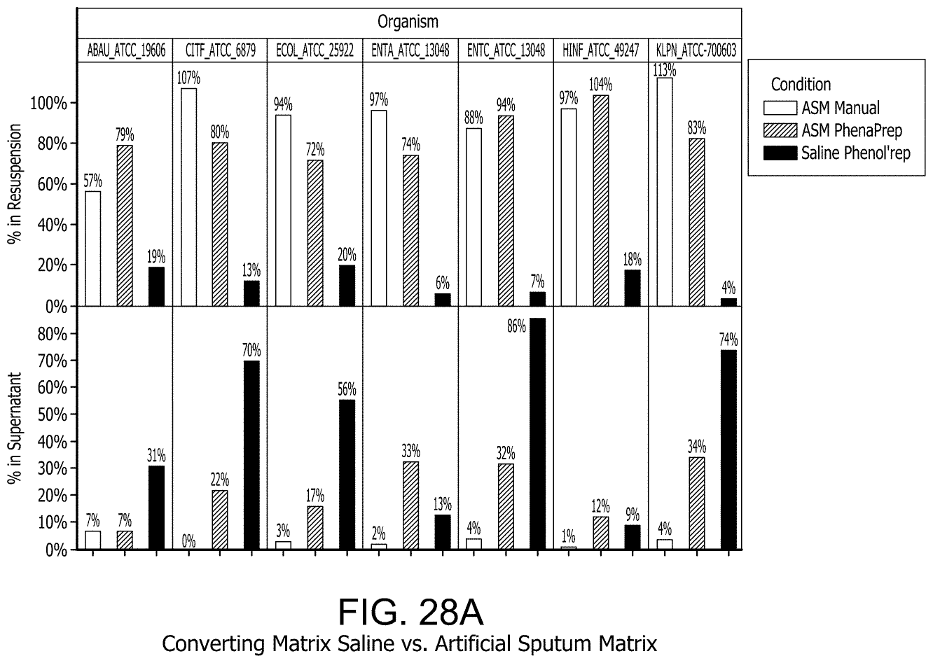

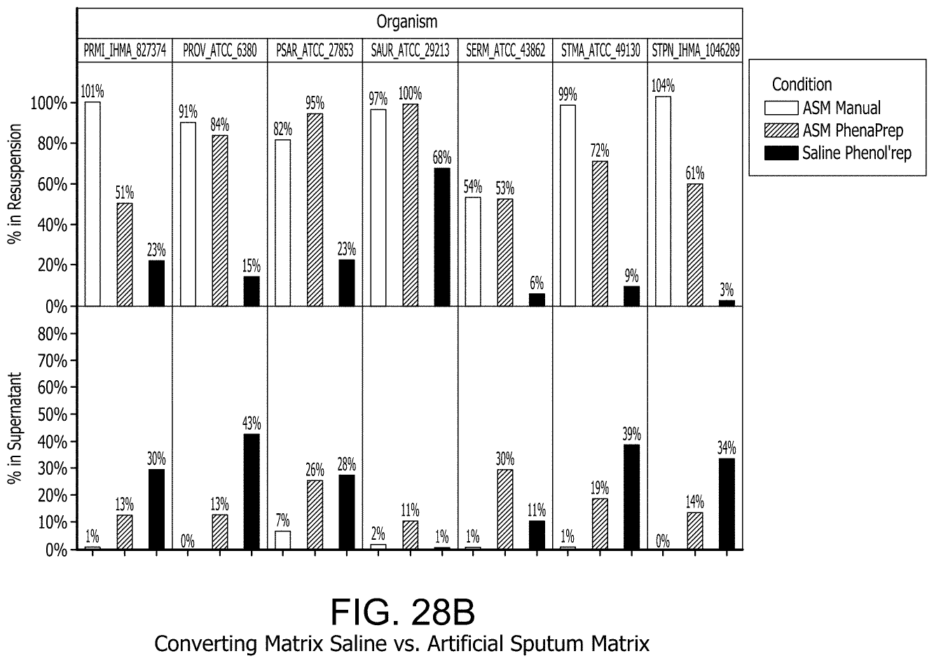

The procedures were run across sample preparation breadboard instruments BB 01, BB 02, BB 03, and BB 04. These results are summarized in FIGS. 28A-28B, where ASM refers to Artificial Sputum Matrix and PhenoPrep™ refers to a system as described herein and in the following two Tables.

TABLE
Contriving Matrix vs. Artificial Sputum
Matrix (ASM): % in Resuspension

| | ASM | ASM | Saline |
|---|---|---|---|
| Organism | Manual | PhenoPrep ™ | PhenoPrep ™ |
| ABAU_ATCC_19608 | 57% | 79% | 19% |
| CTTF_ATCC_6879 | 107% | 80% | 13% |
| ECOL_ATCC_25922 | 94% | 72% | 20% |
| ENTA_ATCC_13048 | 97% | 74% | 6% |
| ENTC_ATCC_13048 | 88% | 94% | 7% |
| HINF_ATCC_49247 | 97% | 104% | 18% |
| KLPN_ATCC_700603 | 113% | 83% | 4% |
| PRMI_IHMA_827374 | 101% | 51% | 23% |
| PROV_ATCC_6380 | 91% | 84% | 15% |
| PSAR_ATCC_27853 | 82% | 95% | 23% |
| SAUR_ATCC_29213 | 97% | 100% | 68% |
| SERM_ATCC_43862 | 54% | 53% | 6% |
| STMA_ATCC_49130 | 99% | 72% | 9% |
| STPN_IHMA_1046289 | 104% | 61% | 3% |

PhenoPrep ™ is a system as described herein.

TABLE
Contriving Matrix vs. Artificial Sputum
Matrix (ASM): % in Supernatant

| | ASM | ASM | Saline |
|---|---|---|---|
| Organism | Manual | PhenoPrep ™ | PhenoPrep ™ |
| ABAU_ATCC_19608 | 7% | 7% | 31% |
| CTTF_ATCC_6879 | 0% | 22% | 70% |
| ECOL_ATCC_25922 | 3% | 17% | 56% |
| ENTA_ATCC_13048 | 2% | 33% | 13% |
| ENTC_ATCC_13048 | 4% | 32% | 86% |
| HINF_ATCC_49247 | 1% | 12% | 9% |
| KLPN_ATCC_700603 | 4% | 34% | 74% |
| PRMI_IHMA_827374 | 1% | 13% | 30% |
| PROV_ATCC_6380 | 0% | 13% | 43% |
| PSAR_ATCC_27853 | 7% | 26% | 28% |
| SAUR_ATCC_29213 | 2% | 11% | 1% |
| SERM_ATCC_43862 | 1% | 30% | 11% |
| STMA_ATCC_49130 | 1% | 19% | 39% |
| STPN_IHMA_1046289 | 0% | 14% | 34% |

PhenoPrep ™ is a system as described herein.

Both specimens used a single spin and resuspension assay.

Percent loss in the supernatant and percent recovery in resuspension were measured using quantitative drip plating.

Following this, more isolates were run spiking into either an artificial sputum matrix or saline using the optimized procedure above on an automated sample preparation instrument breadboard or a manual prep procedure. This experiment was performed to assess whether spiking into something with a higher viscosity could help with the cell recovery.

Summary of Data and Results

TABLE 3
Saline Sample Percent Loss in Supernatant and Percent Recovery

| | SAUR_ATCC_29213 | |
|---|---|---|
| | Supernatant | Resuspension |
| Run 1: Polycarbonate | 2.02% | 0.40% |
| Run 2: Polycarbonate | 0.00% | 44.17% |
| Run 3: Delrin | 0.00% | 7.61% |
| Run 4: Delrin | 2.25% | 0.00% |

TABLE 4
Heavy Mucus Real Specimen Percent Loss
in Supernatant and Percent Recovery

| | PITT_106 | |
|---|---|---|
| | Supernatant | Resuspension |
| Run 1: Polycarbonate | 0.2% | 81.2% |
| Run 2: Polycarbonate | 0.3% | 104.7% |
| Run 3: Delrin | 1.0% | 92.6% |
| Run 4: Delrin | 0.8% | 86.8% |

Conclusions

The results of these experiments indicate that there is a need for an added pellet former to retain bacteria and maintain sample pH to allow for recovery of healthy bacteria in samples that are contrived in saline alone. It is likely this also applies to real positive samples that are very fluid, having low viscosity in nature, thus experiments to determine optimal pellet former components are necessary. The high mucus sample had a higher recovery than a saline sample, indicating that a certain amount of mucus is necessary to maintain a pellet throughout the automated sample preparation assay.

Matrix (RAM)

Given that fresh positive specimens with heavy mucus perform better in the exemplary automated sample preparation assay than contrived saline specimens there is a need for an external pellet former that can be added to specimens to increase the viscosity and thus maintain the pellet throughout the assay. In addition, for contriving experiments there is a need for a sample that will give equivalent performance to fresh positive specimens. This contriving matrix will be useful, for example, in clinical trial or other analytical studies.

Methods

Testing with a preliminary batch of artificial sputum matrix (https://www.nature.com/protocolexchange/protocols/1999#/reagents) showed reduced bacterial growth on 5% TSA blood agar plates after spiking and overnight growth. Thus, each of the ingredients was checked for potential inhibition. The first portion of this study was meant to determine the source of inhibition and to formulate different variations of a respiratory artificial matrix (RAM) to use as a pellet former. To complete this objective, 100 μL of each of the ingredients was dispensed onto the center of four different Mueller Hinton Agar (MHA) plates. After letting the plates dry for ˜2 hours they were lawned with the following four bacteria: ECOL_ATCC_25922, SAUR_ATCC_29213, PROV_ATCC_6380 and PRMI_IHMA_827374. The following day the plates were measured for zones of inhibition. Following this, the pellet former recipe was optimized to exclude non-sterile components. Additionally, 3.87 μm envy green fluorescent microspheres (Bangs Laboratories, FSEG006) were added as a control to allow one to detect whether an automated sample preparation module run lost all beads, and thus also lost the bacterial cells. Many fresh positive specimens of varying viscosities were then tested with an assay that incorporated this pellet former by adding 500 μL to the capsule with 1500 μL of BAL or mini-BAL specimen.

After looking at fresh positive specimen success with pellet former, contriving experiments using various matrix conditions were tested. Saline samples alone did not produce the same recovery, even with the addition of pellet former. However, real specimens with a watery appearance still outperformed contrived scenarios. Thus, a different matrix needed to be optimized that would allow performance equivalent to that of real specimens. Optical density, a measurement of the scattering of light, was used to normalize mucus pools, either by diluting or concentrating the contents to assess performance. A titration curve was generated to determine optical density necessary to produce consistent results that provide growing clone levels that do not vary from prior to and after using the sample preparation system module. Given the variability from sample to sample used to produce normalized mucus pools, other contriving matrices were studied. Using an automated sample preparation FM module, SAUR_ATCC_29213 was spiked into the following different contriving matrices: Sheep BAL, a negative BAL mucus pool (Pool B), a negative BAL mucus pool at a 2× concentration, 2× RAM, 4× RAM, 8× RAM and 16× RAM. The optical density of each of the samples was recorded both before and after prep, on both the automated sample preparation module as well as a manual spin and resuspension method.

Summary of Data and Results

When using the disk diffusion method for analysis, there was no inhibition shown for various components useful in formulating a respiratory artificial matrix. There was, however, inhibition from DTPA with the values presented below.

TABLE 5
Disk Diffusion Inhibition Results of RAM

| | | RAM (with | RAM (no |
|---|---|---|---|
| Isolate | DTPA alone | DTPA) | DTPA) |
| ECOL_ATCC_25922 | 7 mm | 7 mm | 0 mm |
| SAUR_ATCC_29213 | 19 mm | 20 mm | 0 mm |
| PROV_ATCC_6380 | 26 mm | 25 mm | 0 mm |
| PRMI_IHMA_827374 | 30 mm | 29 mm | 0 mm |

Given that DTPA inhibited each of the organisms tested, it was excluded from formulations of the RAM.

The data shown in Table 6 are the quantitative plating results of fresh positives run with the automated sample preparation system breadboard module and the respiratory Assay on the Accelerate Pheno™ system brand of ID/AST instrument according to the disclosure. The quantitative plating was completed using a 50 μL drip plating method on tryptic soy agar (TSA) plates plating 1:100, 1:1000, and 1:10000 dilutions. All plating results were within a log and did not depend on sample viscosity; even samples that appear to be saline performed at the same level as though with much higher viscosity. This indicates that the RAM pellet former was doing the intended job of creating and holding onto the pellet during spin and resuspension steps of the assay.

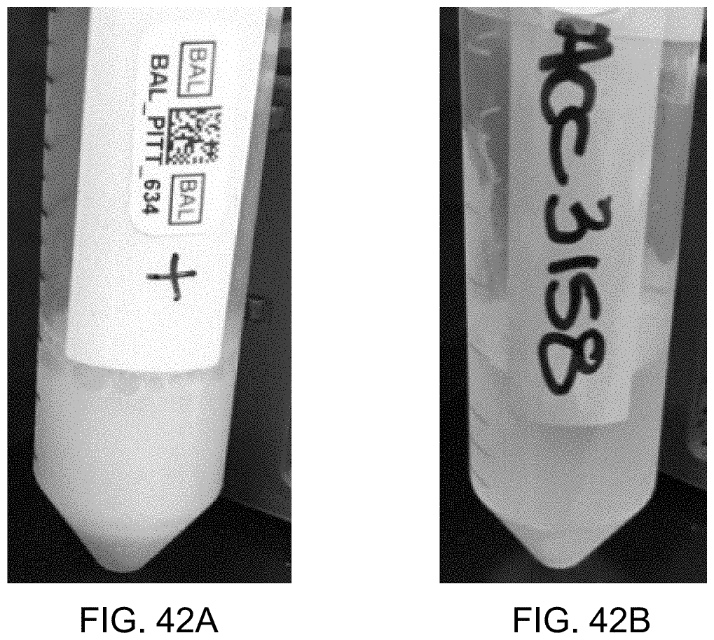

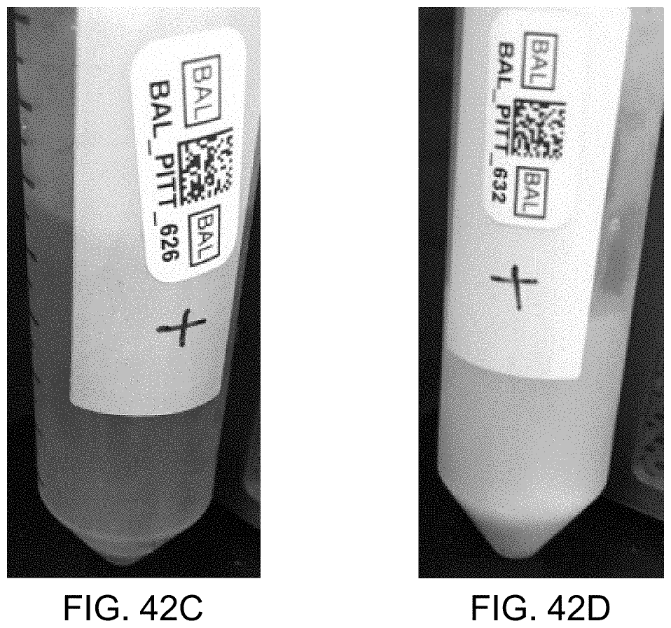

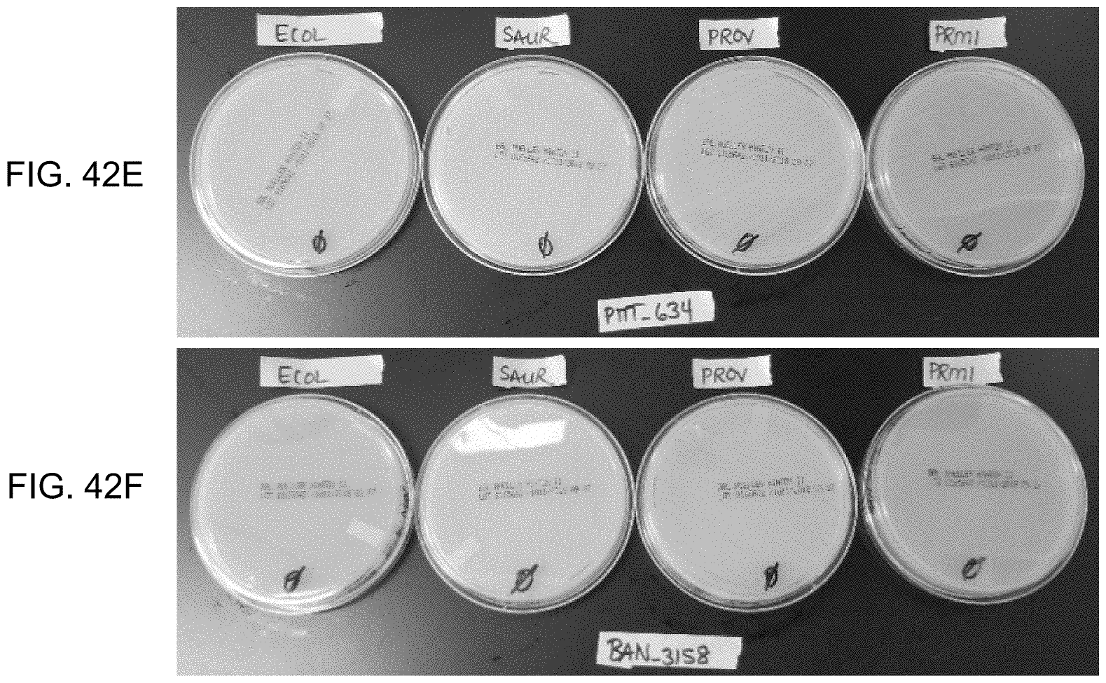

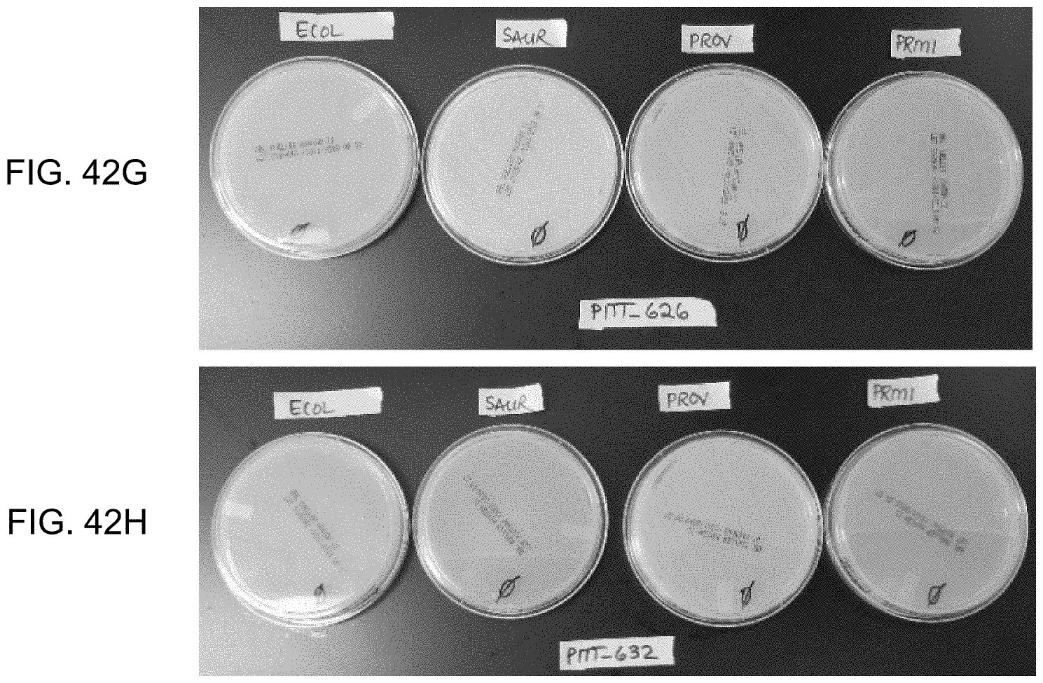

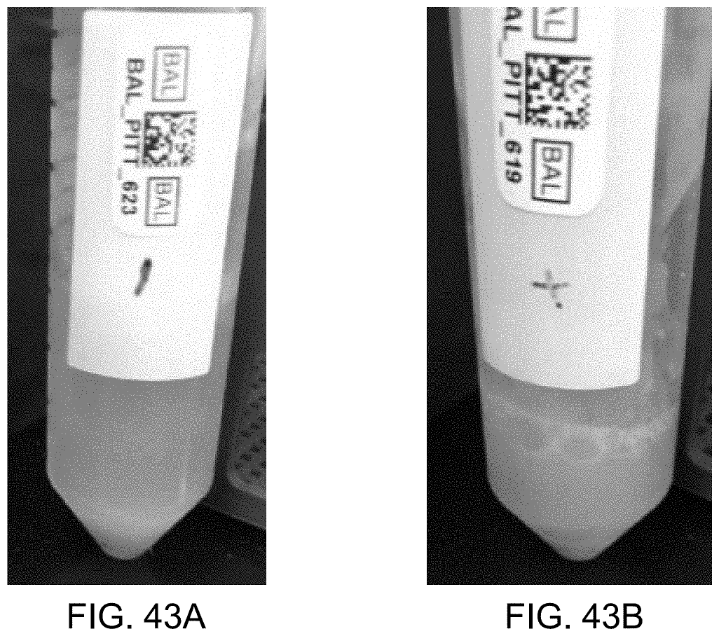

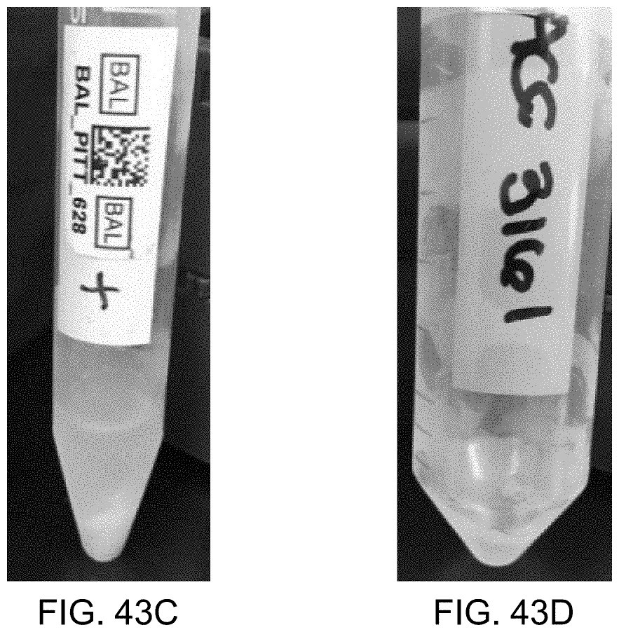

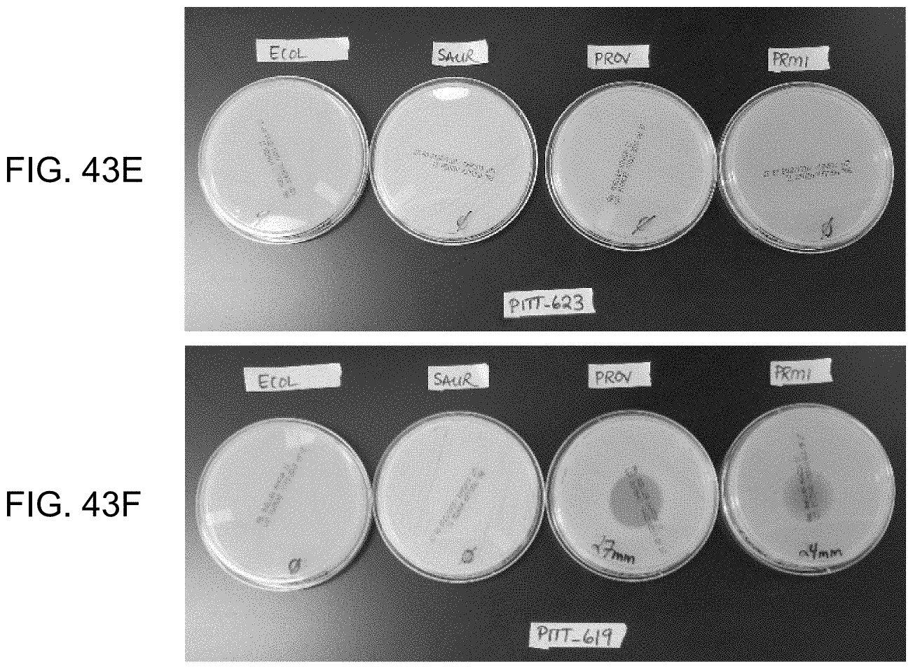

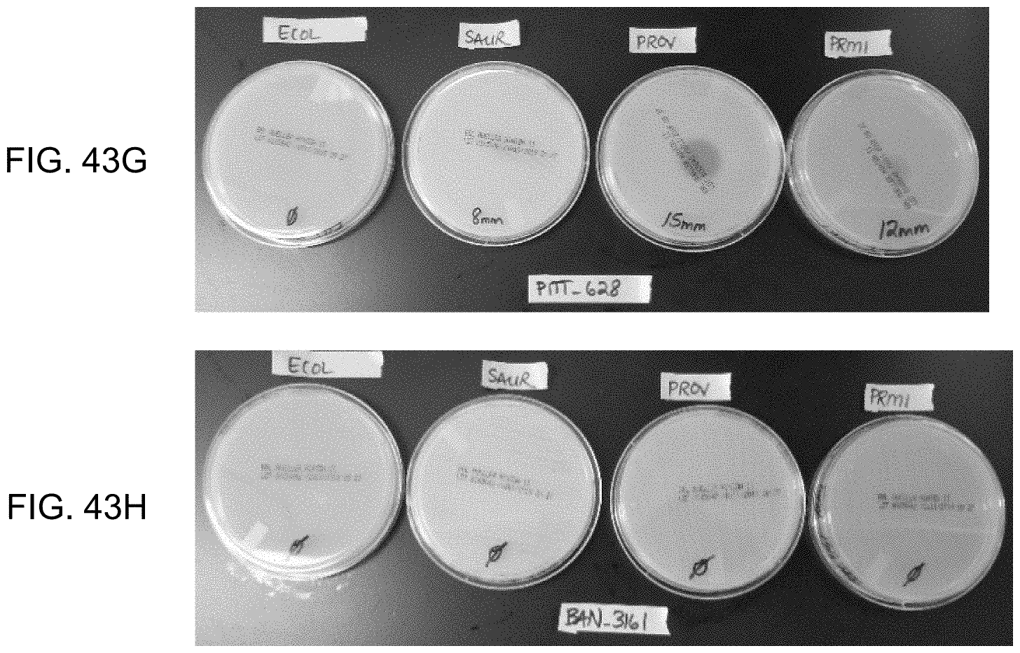

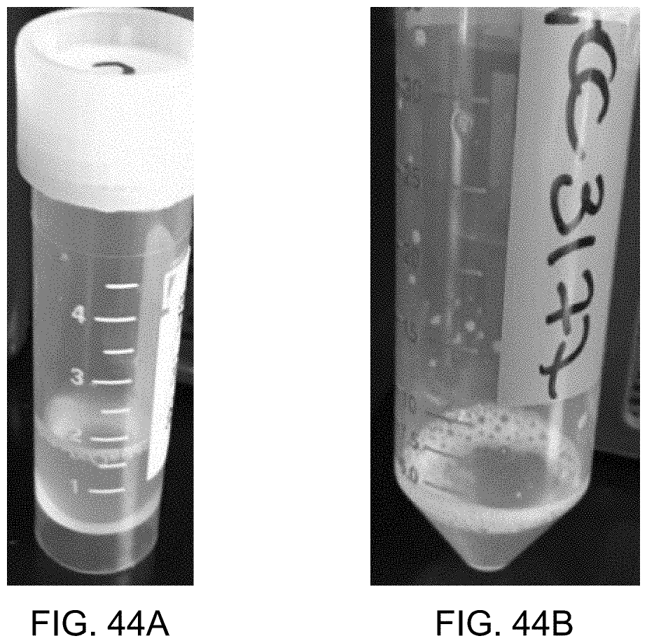

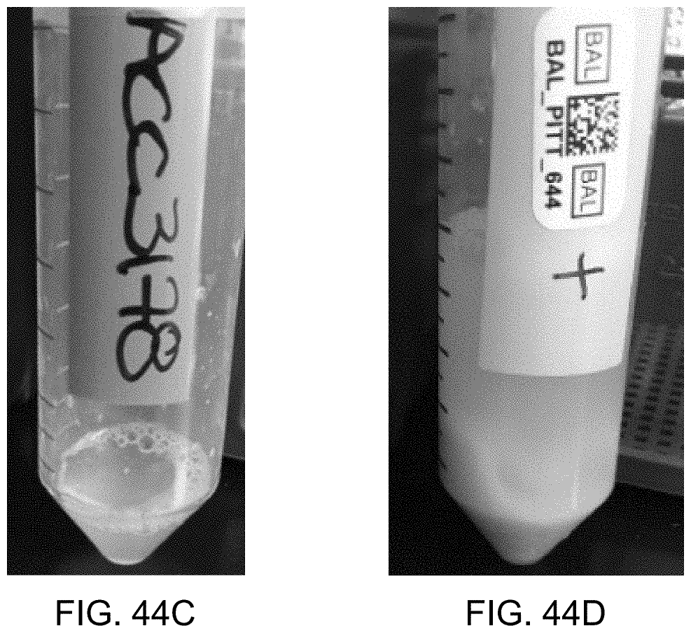

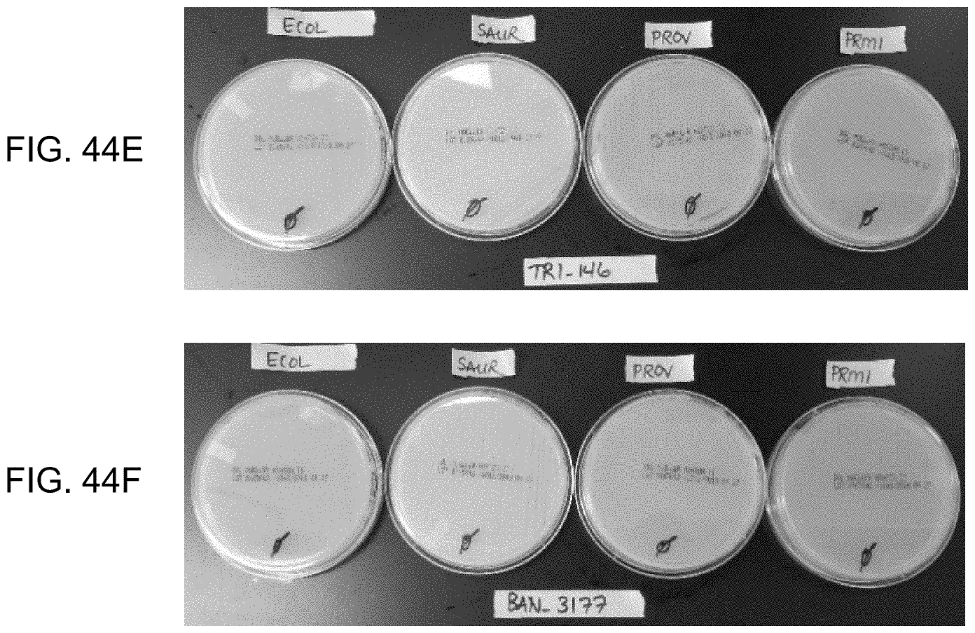

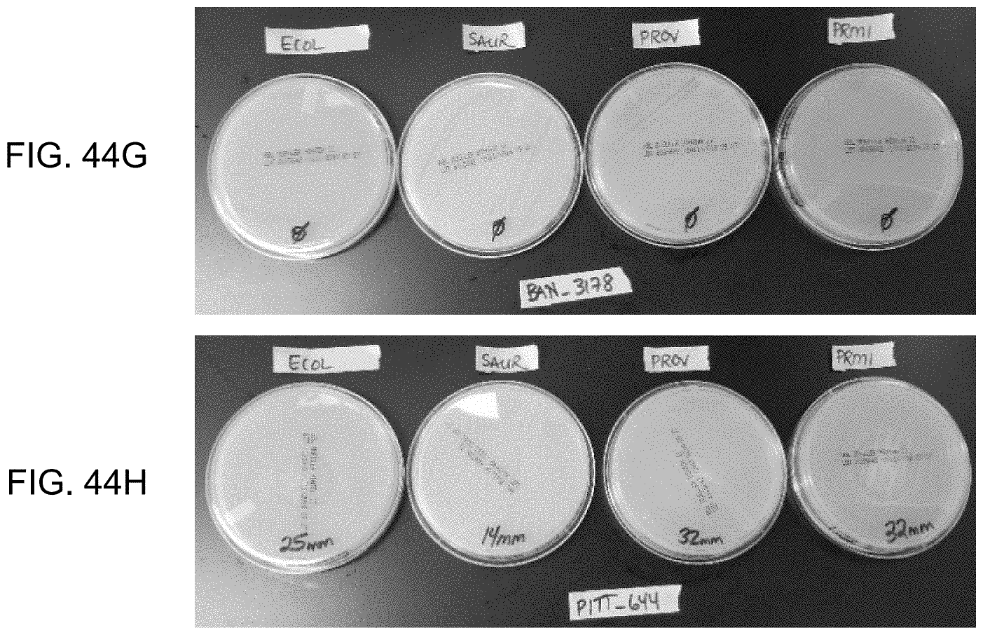

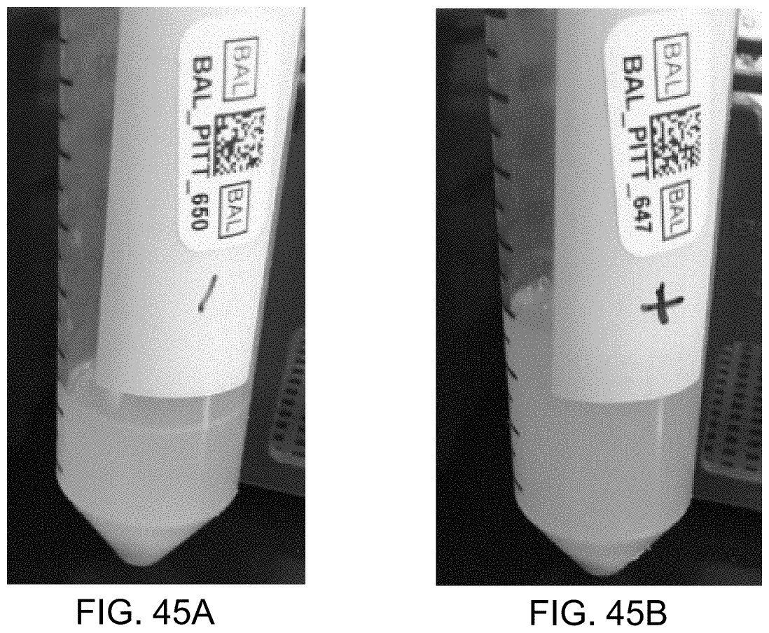

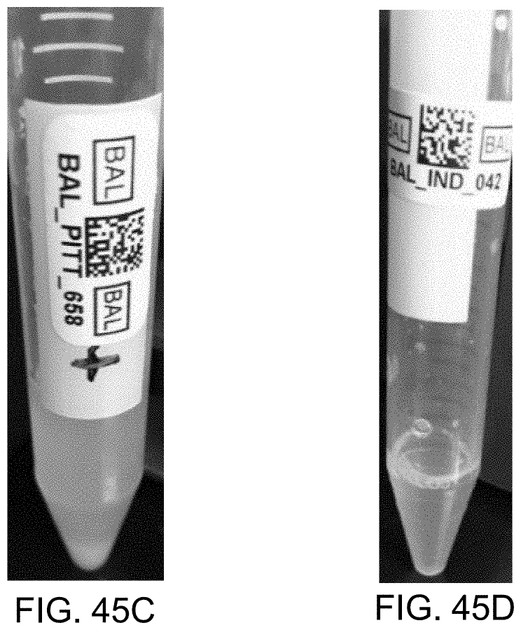

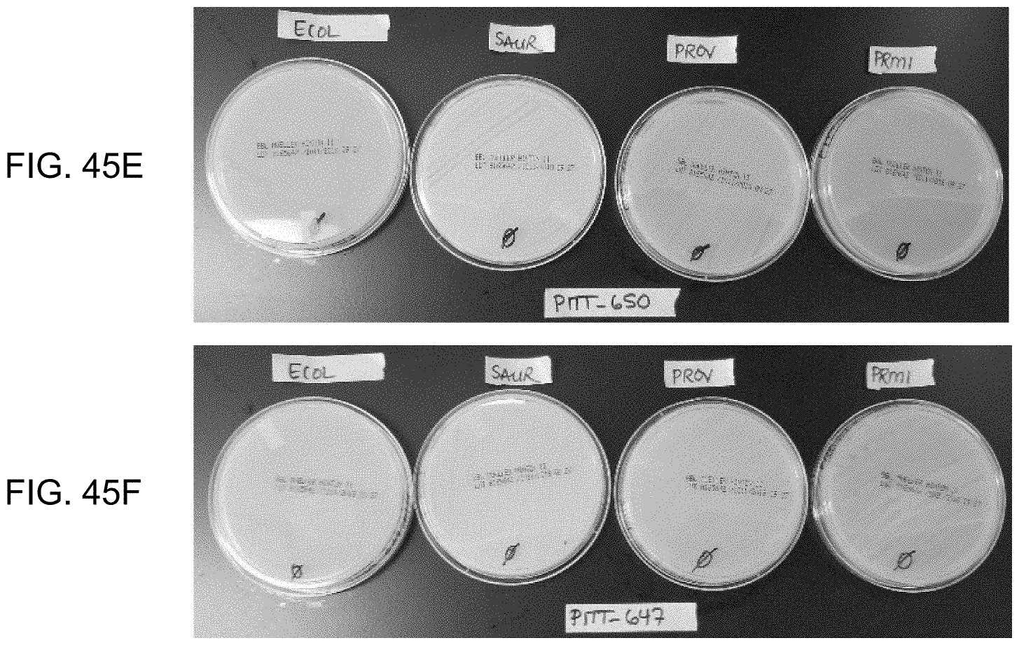

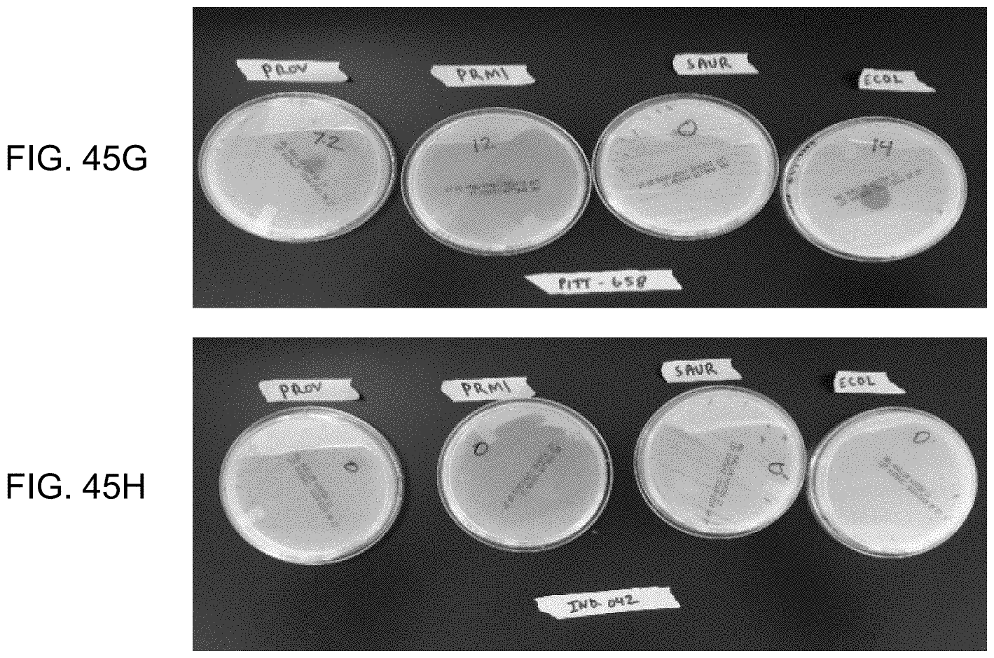

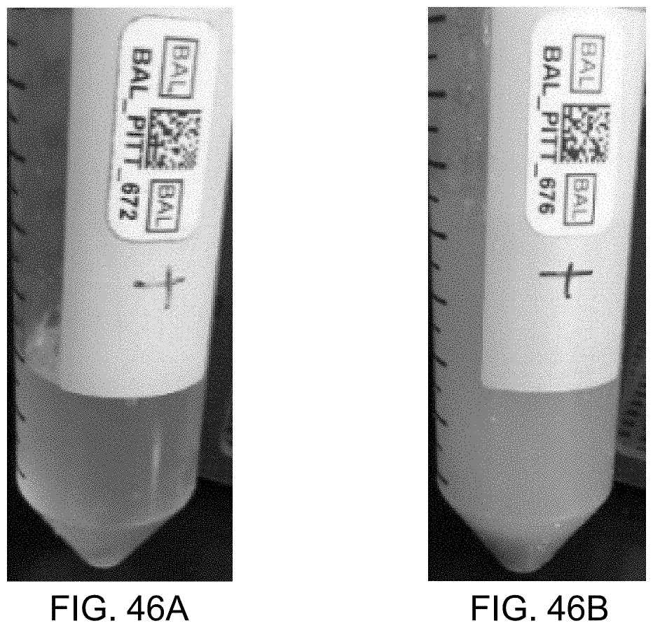

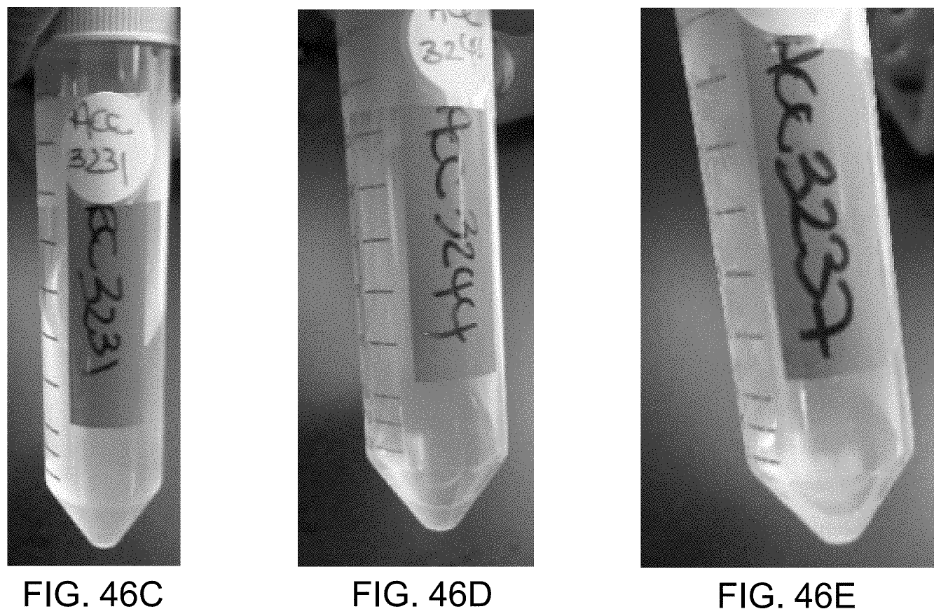

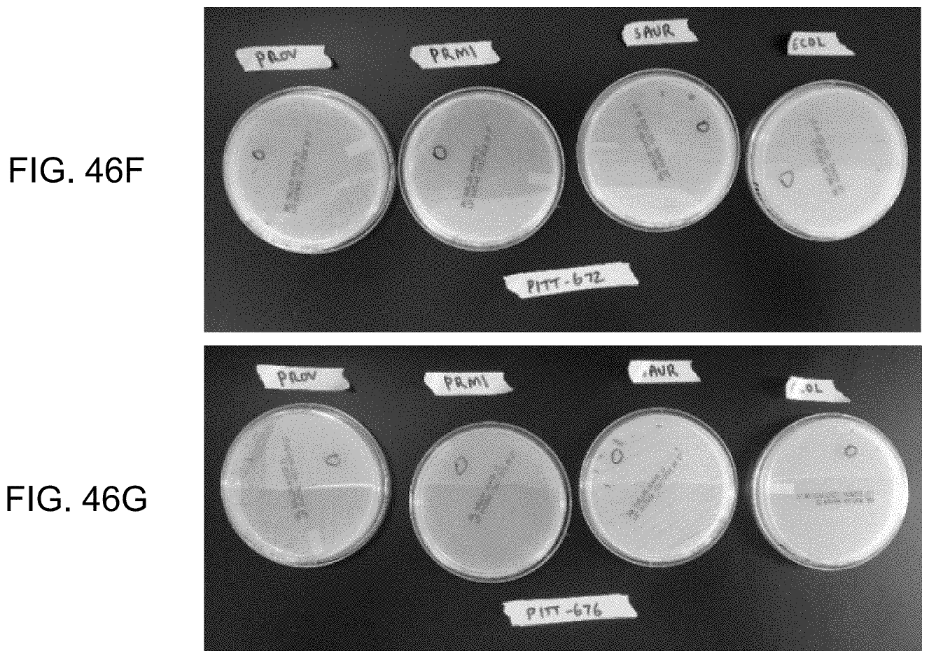

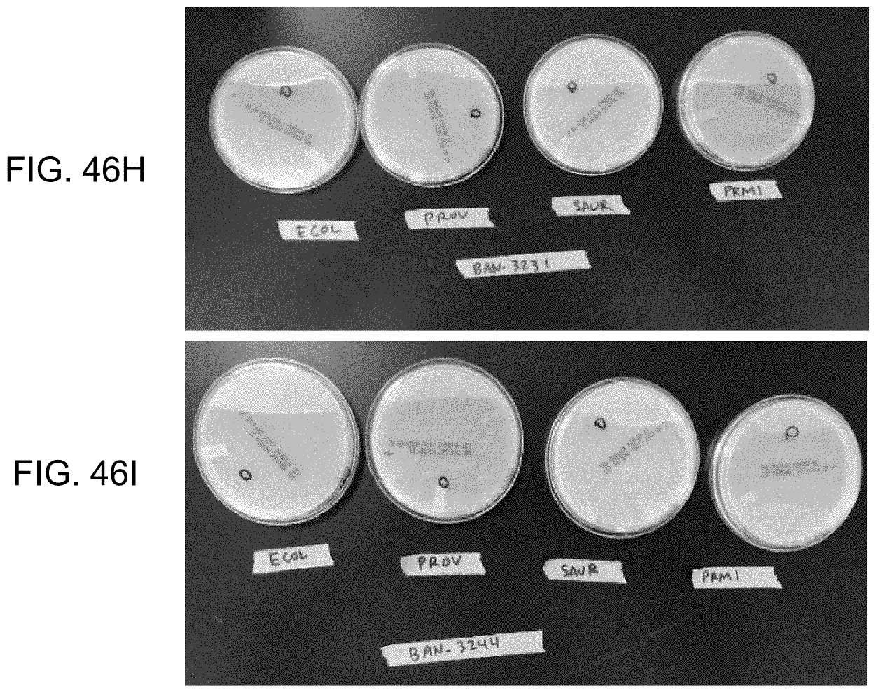

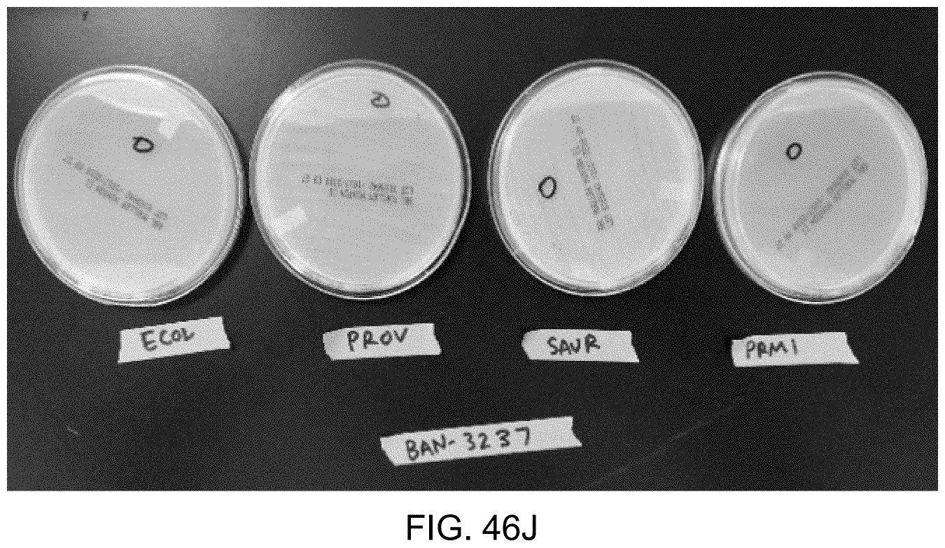

The figures referenced in the first column of Table 6 depict the following: FIGS. 42A-42D depict images of sample pellets from samples PITT_634 (cloudy yellow supernatant, yellow pellet), BAN_3158 (orange supernatant and pellet), PITT_626 (clear red supernatant and red pellet) and PITT_632 (translucent yellow supernatant and yellow pellet), respectively; FIGS. 43A-43D depict images of sample pellets from samples PITT_623 (orange supernatant, off-white pellet), PITT_619 (salmon translucent supernatant, salmon pellet), PITT_628 (yellow translucent supernatant, yellow pellet) and BAN_3161 (orange translucent supernatant, orange pellet), respectively; FIGS. 44A-44D depict images of sample pellets from samples TRI_146 (translucent supernatant, white pellet), BAN_3177 (slightly rose-colored supernatant and pellet), BAN_3178 (translucent yellow supernatant and yellow pellet) and PITT_644 (cloudy yellow supernatant and slightly yellow pellet), respectively; FIGS. 45A-45D depict images of sample pellets from samples PITT_650 (translucent yellow supernatant and yellow pellet), PITT_647 (cloudy yellow supernatant and yellow pellet), PITT_658 (clear yellowish supernatant and off-white pellet) and IND_042 (clear yellow supernatant and off-white pellet), respectively; and FIGS. 46A-46E depict images of sample pellets from samples PITT_672 (clear supernatant and off-white pellet), PITT_676 (cloudy yellow supernatant and off-white pellet), BAN_3231 (clear supernatant and off-white pellet), BAN_3244 (slightly pink supernatant and pink pellet) and BAN_3237 (clear yellow supernatant and off-white pellet), respectively.

The third column of Table 6 shows the diameter of the zone of inhibition for the indicated microorganism species (ECOL, SAUR, PROV, and PRMI, respectively). The figures referenced in the third column of Table 6 depict the following: FIGS. 42E-42H depict images of inhibition plating results from samples PITT_634, BAN_3158, PITT_626 and PITT_632, respectively; FIGS. 43E-43H depict images of inhibition plating results from samples PITT_623, PITT_619, PITT_628 and BAN_3161, respectively; FIGS. 44E-44H depict images of inhibition plating results from samples TRI_146, BAN_3177, BAN_3178 and PITT_644, respectively; FIGS. 45E-45H depict images of inhibition plating results from samples PITT_650, PITT_647, PITT_658 and IND_042, respectively; and FIGS. 46E-46H depicts images of inhibition plating results from samples PITT_672, PITT_676, BAN_3231, BAN_3244 and BAN_3237, respectively.

TABLE 6
Real Sample Preparations using Automated Sample Preparation Breadboard Models.

| | | Disk Diffusion Inhibition Pre-Prep (all | | | | | | |
|---|---|---|---|---|---|---|---|---|
| | | inhibition was removed post-prep): | | | | | Post- | |
| | SOC | inhibition is indicated as diameter in | | | | Pre-Plate | Plate | |
| Sample | ID | millimeters (mm) of zone of inhibition | | | | CFU/mL | CFU/mL | Pheno Exp # |
| PITT_634 | SAUR | E.Coli | S. AUR | PROV | PRMI | 1.44 × 10⁵ | 2.54 × 10⁵ | 66_22_8365 |
| See FIG. | | 0 mm | 0 mm | 0 mm | 0 mm | | | |
| 42A | | Images: See FIG. 42E | | | | | | |
| BAN_3158 | SAUR | E.Coli | S. AUR | PROV | PRMI | 6.26 × 10⁷ | 3.58 × 10⁷ | 66_20_8363 |
| See FIG. | | 0 mm | 0 mm | 0 mm | 0 mm | | | |
| 42B | | See FIG. 42F | | | | | | |
| PITT_626 | ENTC | E.Coli | S. AUR | PROV | PRMI | 1.02 × 10⁶ | 1.28 × 10⁶ | 66_26_8366 |
| See FIG. | | 0 mm | 0 mm | 0 mm | 0 mm | | | |
| 42C | | Images: See FIG. 42G | | | | | | |
| PITT_632 | PSAR | E.Coli | S. AUR | PROV | PRMI | >5.0 × 10⁷ | >5.0 × 10⁷ | 66_1025_8364 |
| See FIG. | | 0 mm | 0 mm | 0 mm | 0 mm | | | |
| 42D | | Images: See FIG. 42H | | | | | | |
| PITT_623 | SAUR | E.Coli | S. AUR | PROV | PRMI | 2.4 × 10⁴ | <2.0 × 10³ | 285_1040_3634 |
| See FIG. | | 0 mm | 0 mm | 0 mm | 0 mm | | | |
| 43A | | Images: See FIG. 43E | | | | | | |
| PITT_619 | KLPN | E.Coli | S. AUR | PROV | PRMI | 2.0 × 10³ | 1.0 × 10⁴ | 285_1131_3635 |
| See FIG. | | 0 mm | 0 mm | 27 mm | 24 mm | | | |
| 43B | | Images: See FIG. 43F | | | | | | |
| PITT_628 | PSAR | E.Coli | S. AUR | PROV | PRMI | 2.0 × 10⁵ | 1.02 × 10⁵ | 285_1219_3637 |
| See FIG. | | 0 mm | 8 mm | 15 mm | 12 mm | | | |
| 43C | | Images: See FIG. 43G | | | | | | |
| BAN_3161 | ENTC | E.Coli | S. AUR | PROV | PRMI | 1.58 × 10⁷ | 5.8 × 10⁶ | 285_1221_3636 |
| See FIG. | | 0 mm | 0 mm | 0 mm | 0 mm | | | |
| 43D | | Images: See FIG. 43H | | | | | | |
| TRI_146 | ENTC | E.Coli | S. AUR | PROV | PRMI | 1.38 × 10⁷ | 8.4 × 10⁶ | 69_48_6347 |
| See FIG. | | 0 mm | 0 mm | 0 mm | 0 mm | | | |
| 44A | | Images: See FIG. 44E | | | | | | |
| BAN_3177 | ECOL | E.Coli | S. AUR | PROV | PRMI | 2.8 × 10⁴ | 1.2 × 10⁴ | 69_46_6346 |
| See FIG. | | 0 mm | 0 mm | 0 mm | 0 mm | | | |
| 44B | | Images: See FIG. 44F | | | | | | |
| BAN_3178 | SAUR | E.Coli | S. AUR | PROV | PRMI | 2.4 × 10⁵ | 1.8 × 10⁵ | 69_1047_6345 |
| See FIG. | | 0 mm | 0 mm | 0 mm | 0 mm | | | |
| 44C | | Images: See FIG. 44G | | | | | | |
| PITT_644 | SAUR | E.Coli | S. AUR | PROV | PRMI | 1.22 × 10⁷ | 8.2 × 10⁶ | 69_1045_6350 |
| See FIG. | | 25 mm | 14 mm | 32 mm | 32 mm | | | |
| 44D | | Images: See FIG. 44H | | | | | | |
| PITT_650 | STPN | E.Coli | S. AUR | PROV | PRMI | 1.2 × 10⁴ | 7.6 × 10⁴ | 69_48_6351 |
| See FIG. | | 0 mm | 0 mm | 0 mm | 0 mm | | | |
| 45A | | Images: See FIG. 45E | | | | | | |
| PITT_647 | KLPN/ | E.Coli | S. AUR | PROV | PRMI | 4.2 × 10⁶ | 4.8 × 10⁶ | 69_1047_6349 |
| See FIG. | ECOL | 0 mm | 0 mm | 0 mm | 0 mm | KLPN | KLPN | |
| 45B | | Images: See FIG. 45F | | | | 8.6 × 10⁶ | 1.18 × 10⁷ | |
| | | | | | | ECOL | ECOL | |
| PITT_658 | SAUR | PROV | PRMI | S. AUR | E.Coli | 1.52 × 10⁵ | 1.82 × 10⁵ | 421_1190_2539 |
| See FIG. | | 7.2 mm | 12 mm | 0 mm | 14 mm | | | |
| 45 C | | Images: See FIG. 45G | | | | | | |
| IND_042 | ECOL | PROV | PRMI | S. AUR | E.Coli | 1.76 × 10⁵ | 1.10 × 10⁵ | 421_1192_2540 |
| See FIG. | | 0 mm | 0 mm | 0 mm | 0 mm | | | |
| 45D | | Images: See FIG. 45H | | | | | | |
| PITT_672 | KLPN | PROV | PRMI | S. AUR | E.Coli | 2.4 × 10⁴ | 6 × 10³ | 66_26_8374 |
| See FIG. | ENTC | 0 mm | 0 mm | 0 mm | 0 mm | | | |
| 46A | | Images: See FIG. 46F | | | | | | |
| PITT_676 | | PROV | PRMI | S. AUR | E.Coli | 6.6 × 10⁶ | 5.4 × 10⁶ | 66_1025_8376 |
| See FIG. | | 0 mm | 0 mm | 0 mm | 0 mm | | | |
| 46B | | Images: See FIG. 46G | | | | | | |
| BAN_3231 | PSAR | E.Coli | PROV | S. AUR | PRMI | 5.62 × 10⁷ | 4.66 × 10⁷ | 66_26_8396 |
| See FIG. | | 0 mm | 0 mm | 0 mm | 0 mm | | | |
| 46C | | Images: See FIG. 46H | | | | | | |
| BAN_3244 | SAUR | E.Coli | PROV | S. AUR | PRMI | 1.48 × 10⁵ | 1.4 × 10⁵ | 66_20_8394 |
| See FIG. | | 0 mm | 0 mm | 0 mm | 0 mm | | | |
| 46D | | Images: See FIG. 46I | | | | | | |
| BAN_3237 | ENTC | E.Coli | PROV | S. AUR | PRMI | 1.52 × 10⁵ | 2.82 × 10⁵ | 66_22_8395 |
| See FIG. | | 0 mm | 0 mm | 0 mm | 0 mm | | | |

| | |
|---|---|
| 46E | Images: See FIG. 46J |

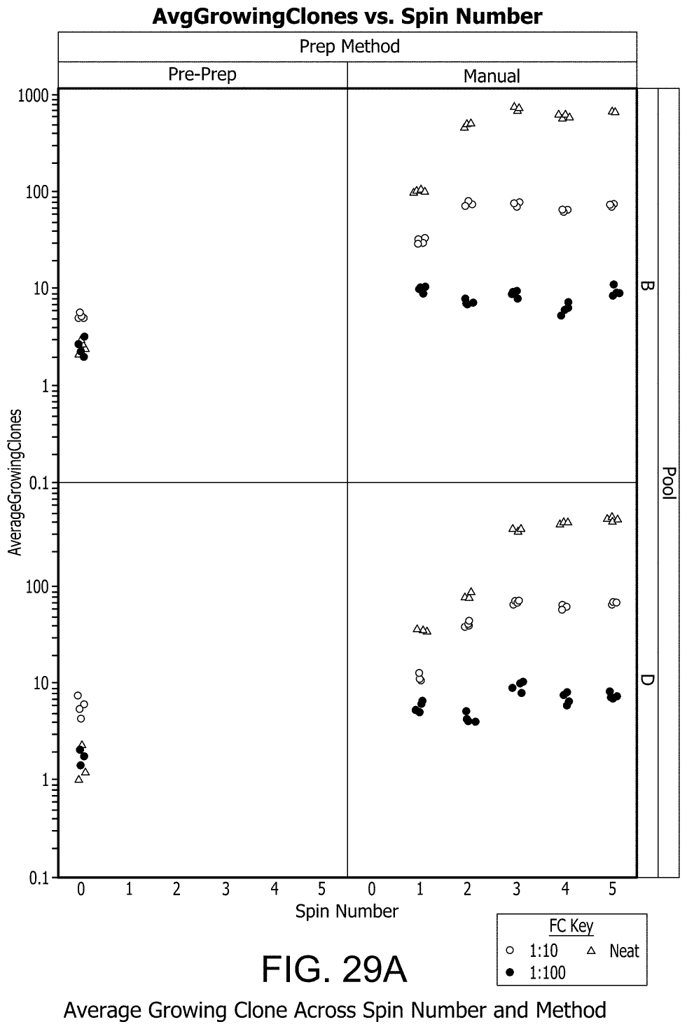

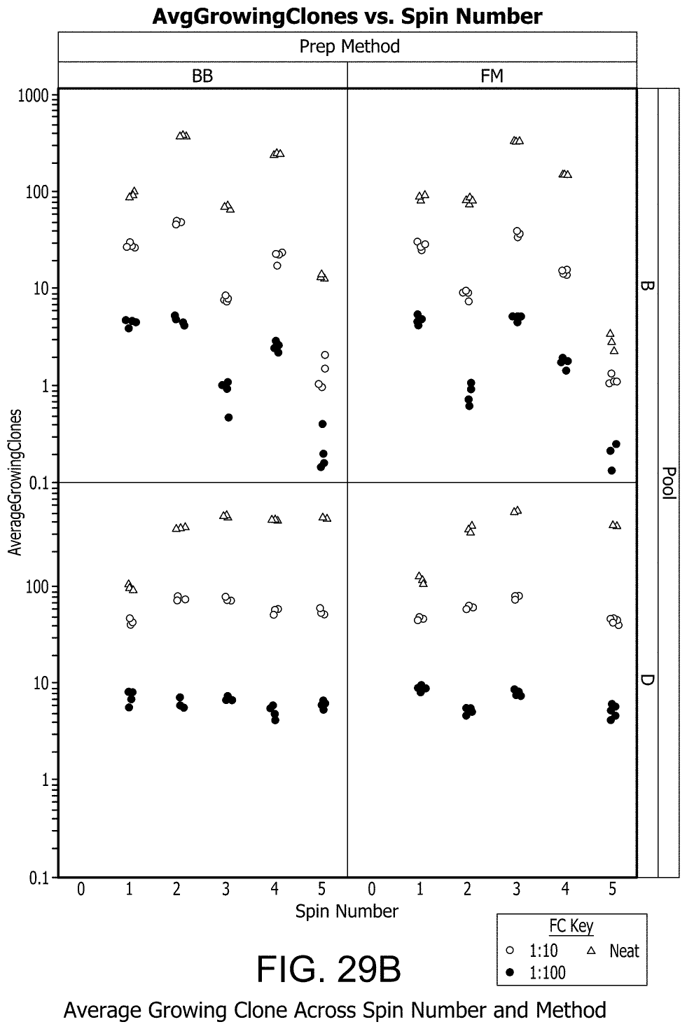

Given that many viscosities of fresh specimens produced clone counts within a log between pre- and post-prep plates, it was necessary to understand how to manage contrived specimens to perform as well as fresh specimens in an automated sample preparation instrument assay. Two mucus pools were created, pool B (appearance of a saline sample) with an optical density of 0.8 and pool D (appearance of a cloudy thicker sample) with an optical density of 4.2. A sample was taken after each spin to determine at which point loss in prep could occur both for pool B and D, as well as across prep methods: Manual Prep, Breadboard (BB) prep, and FM prep. All results were run using a growth only assay (Growth Only Assay 3), which runs nine flow channels per sample (3 Neat, 3 with a 1:10 dilution and 3 with a 1:100 dilution). The results indicate that the bigger the pellet, and thus the higher the optical density, the better the recovery across all prep methods. FIG. 29A shows the average growing clones for pool B and pool D, both pre-preparation and after manual preparation. FIG. 29B shows the average growing clones for pool B and pool D after BB and FM preparation.

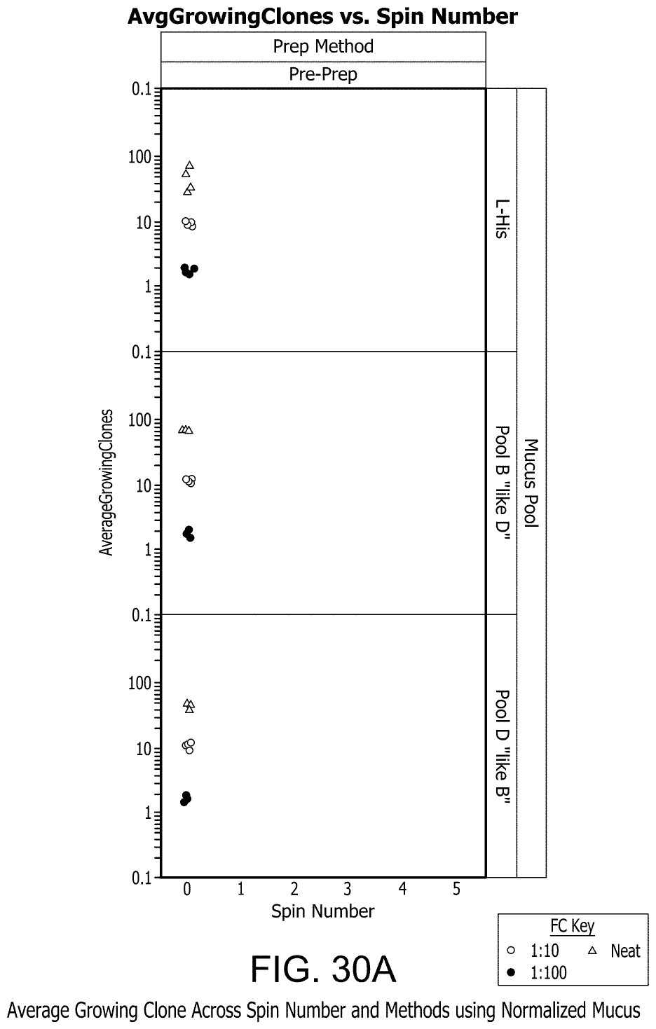

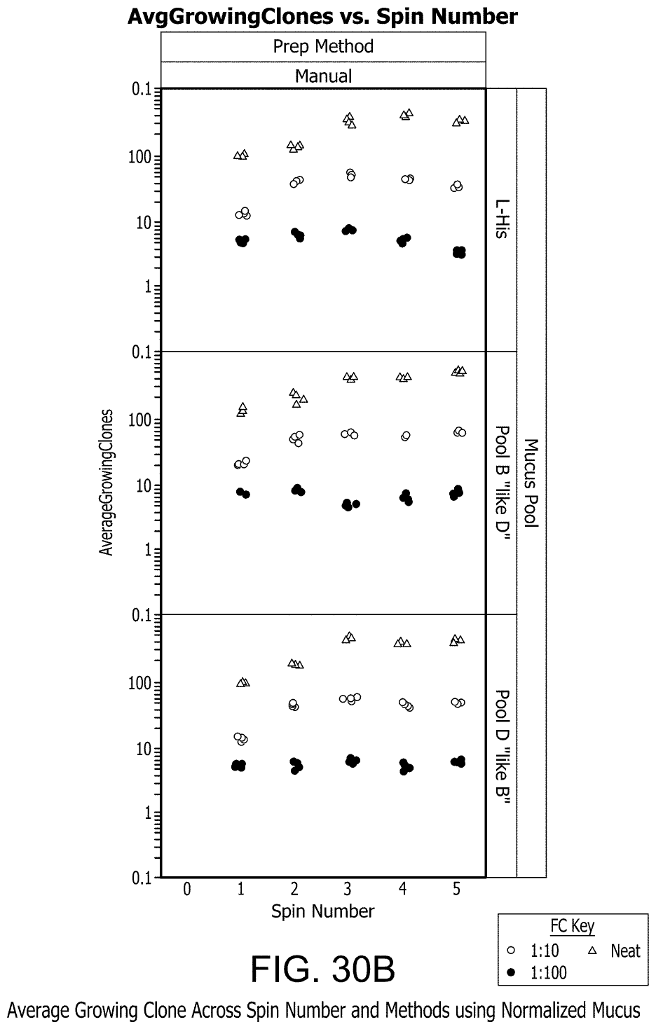

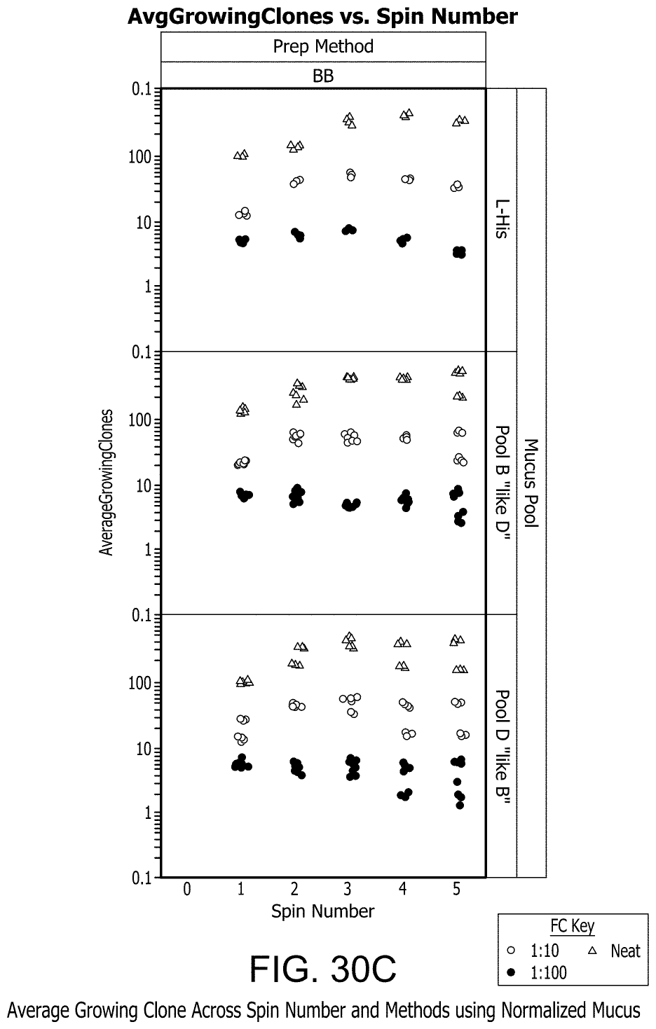

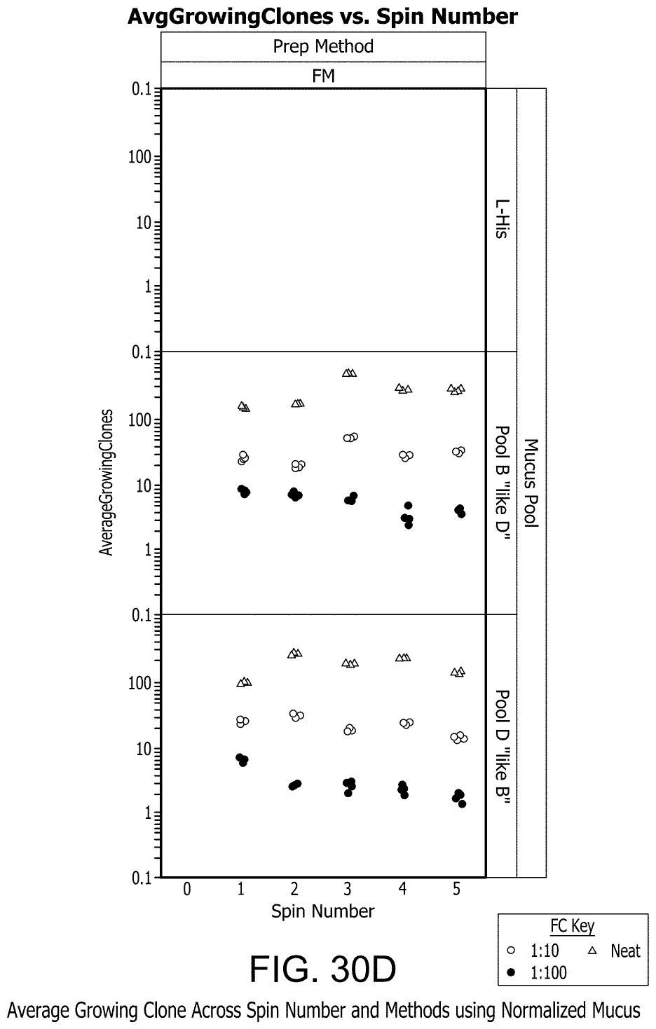

As can be seen in FIGS. 30A-30D, pool D, which has the higher optical density, has consistent performance across preparation methods and does not show loss of clones across spins like pool B. (FIG. 30A: pre-prep; FIG. 30B: manual; FIG. 30C: BB prep method; FIG. 30D: FM prep method). Thus, to prove that a higher optical density (and thus bigger pellet sample) performs better than a very low pellet sample, pool B was concentrated, and pool D was diluted.

These results, depicted in FIGS. 29A, 29B, and 30A-30D, indicate that a sample with low optical density and a small pellet can be improved by concentrating to a higher optical density and give consistent and high growing clones numbers that match the starting sample. In this case, pool B was able to be improved by concentrating from an optical density of 0.8 to 4.2, however even when diluting pool D to an optical density of 0.8 the performance is not as bad as the initial pool B sample. To further understand this, pool D was used to create a titration curve with optical densities of 0.2, 0.6, 1.8 and 4.2. The same assay was used to look into growing clones across the different optical density specimens with manual, BB and FM prep methods.

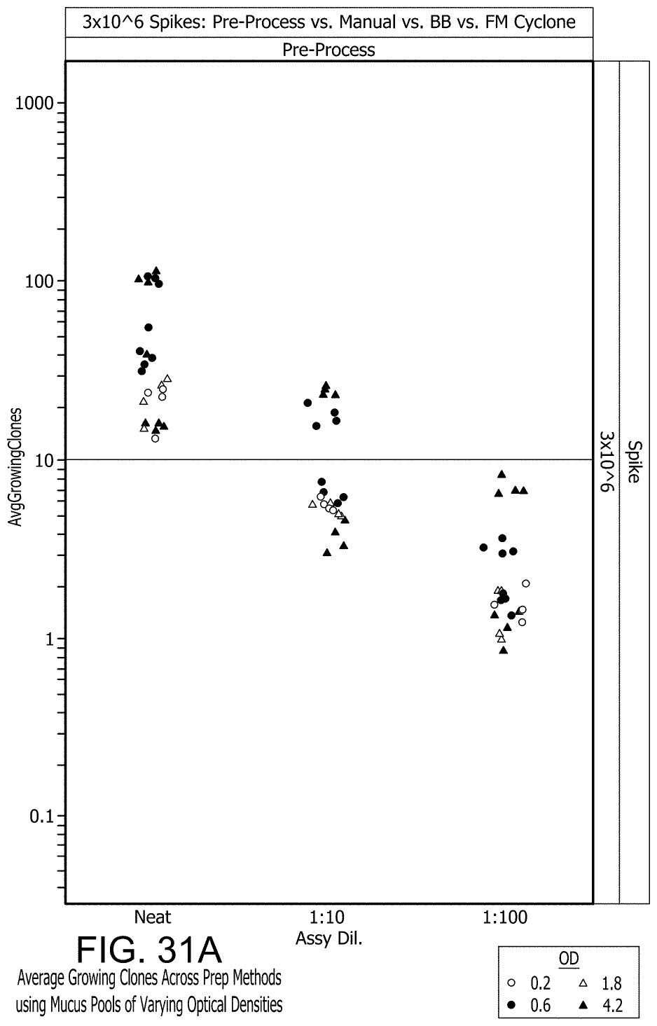

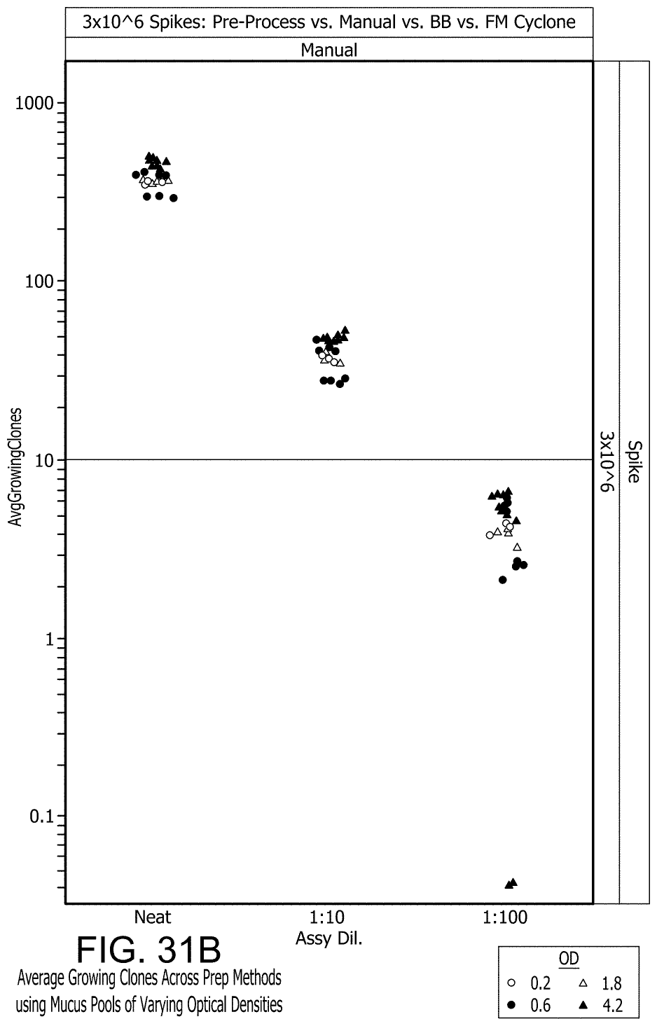

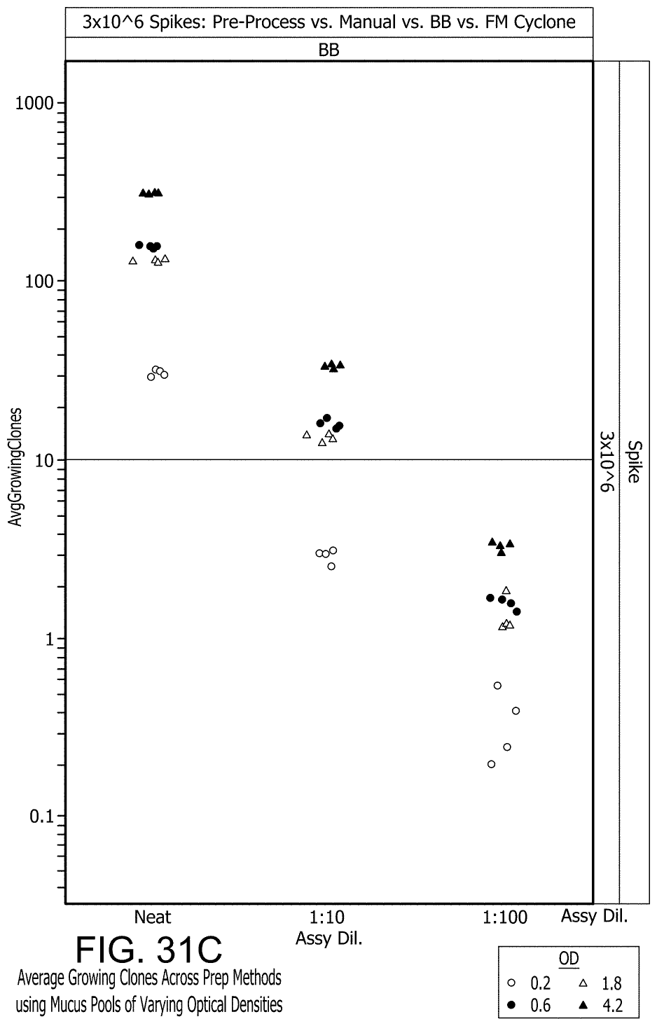

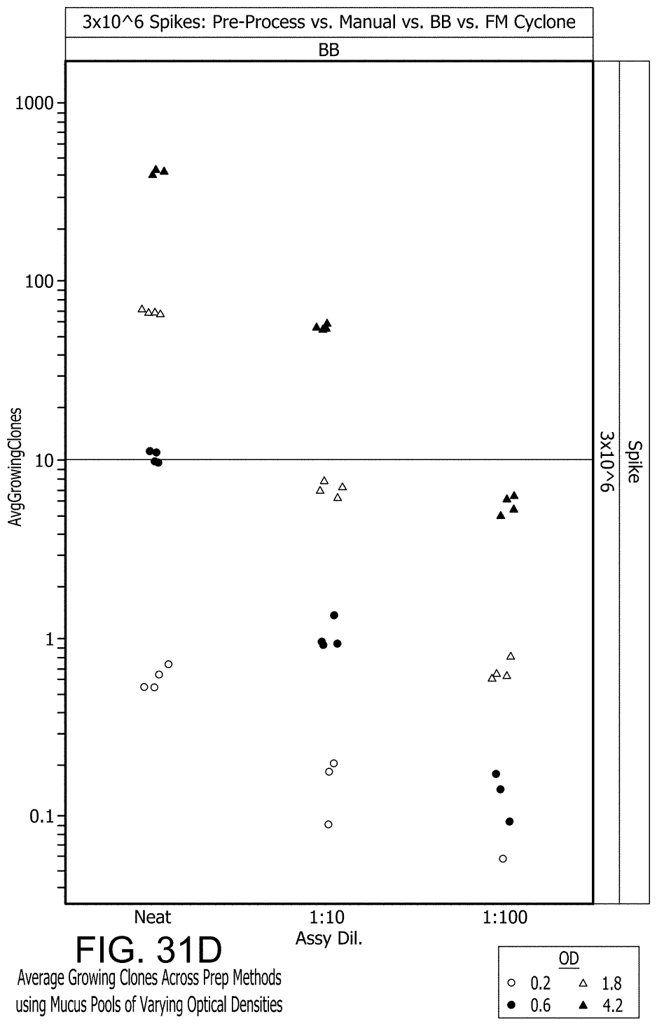

As can be seen in FIGS. 31A-31D, the samples with an optical density of 4.2, the highest tested optical density, also showed the highest growing clone numbers. FIG. 31A shows average growing clones, pre-process, at neat, 1:10 dilution, and 1:100 dilution concentrations. FIG. 31B shows average growing clones after manual preparation, at neat, 1:10 dilution, and 1:100 dilution concentrations. FIG. 31C shows average growing clones after BB preparation at neat, 1:10 dilution, and 1:100 dilution concentrations. FIG. 31D shows average growing clones after FM preparation at neat, 1:10 dilution, and 1:100 dilution concentrations. The data shown in the figures indicate a correlation between optical density and performance, and that the matrix into which samples are contrived can greatly impact the results.

To further prove that the contriving matrix can greatly impact performance and to determine a contriving matrix that can be consistently used with little variability in performance, multiple contriving matrices of varying optical densities were tested.

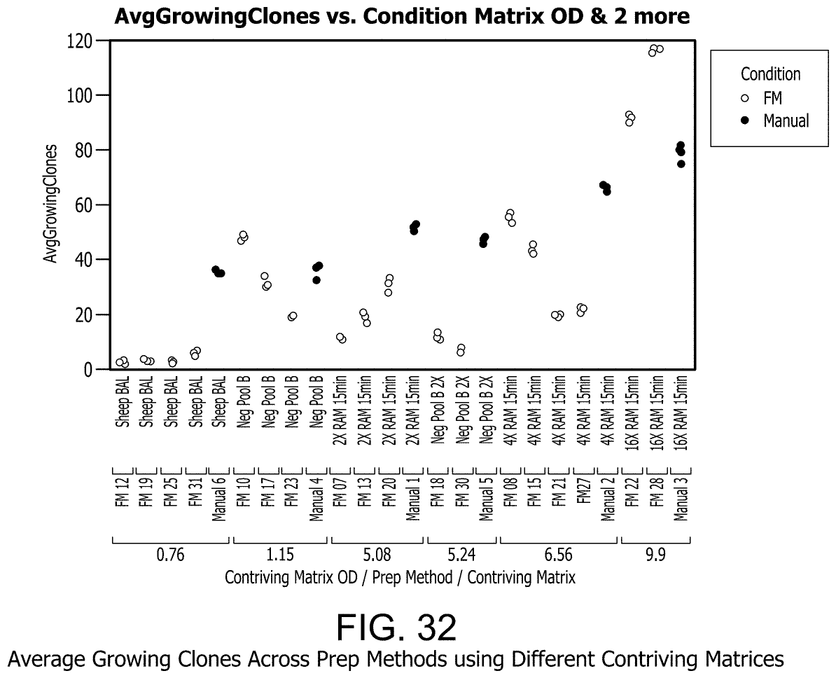

FIG. 32 shows the number of average growing clones under various conditions of contriving matrix OD (0.76, 1.15, 5.08, 5.24, 6.56, and 9.9), prep methods (FM prep or manual prep), and contriving matrices (sheep BAL, Negative Pool B, 2×RAM, 4×RAM, or 16×RAM). The plot depicted in FIG. 32 indicates that a higher optical density corresponds to higher clone counts. After image review, the 16×RAM condition showed a high amount of debris and noise which would interfere with ID analysis, thus the 2× and 4× RAM conditions were selected for a further study to compare the two.

A further study comparing 2× and 4× RAM showed higher average growing clones with the 4× RAM relative to the 2× RAM.

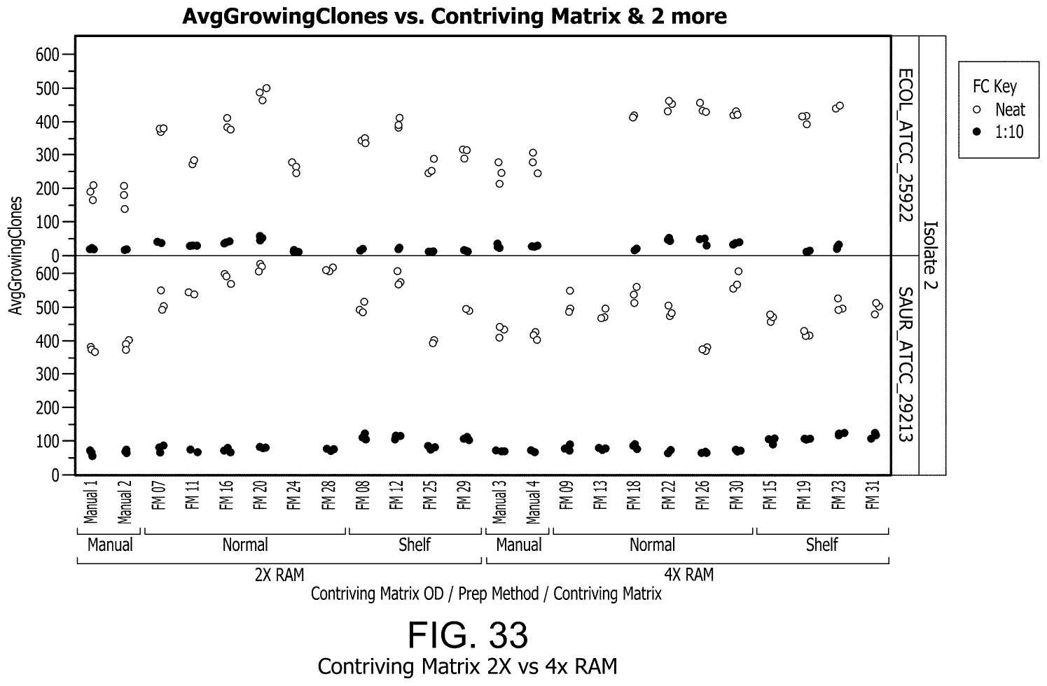

FIG. 33 shows the number of average growing clones using FM preparation, manual preparation, or a shelf capsule, and 2× RAM or 4× RAM, neat or at a 1:10 dilution. The data depicted in FIG. 33 prove that the 4× RAM condition produces higher growing clones relative to 2× RAM. In addition, a shelf capsule provides more average growing clones relative to the normal capsule and manual cleanup method.

Conclusions

The results of these experiments outline the necessity of a pellet former added to all samples to both liquefy heavy mucus samples with a high viscosity also create a pellet in cases where samples have low levels of mucus. The pellet former recipe was optimized to include all necessary components while removing DTPA, a reagent that can be adverse to organism health. In addition, non-sterile additives were removed. Real specimen runs were completed to prove that the pellet former served the intended purpose of retaining bacteria in samples with varying viscosities. In all cases the recoveries using quantitative drip plating were within one log factor from pre- to post-sample processing indicating that the pellet former performed the intended function. Since real specimen runs performed better with pellet former than saline only runs with pellet former, a contriving matrix needed to be developed to allow contrived specimens to perform like the fresh specimens. Optical density was leveraged to normalize mucus pools and prove that by concentrating a low optical density sample, and thus increasing the pellet size, recovery also improves. In addition, a titration curve was produced which proved that the higher the optical density, the higher the recovery will be. Due to the availability and difficulty preparing normalized negative mucus pools, multiple synthetic options were tested to determine if any produced performance that matched or was better than a negative BAL specimen. RAM prepared at a 16× concentration, with an optical density of 9.9 produced the highest number of growing clones but had too much debris in the ID and AST portion of the assay, thereby preventing the use of this material as a contriving matrix. RAM prepared at a 4× concentration with an optical density of 6.56 however produced growing clones that were matched to the negative BAL pool. Given that the 4× RAM contriving matrix is made of synthetic ingredients, it can be prepared in a controlled manner and is therefore preferable to a negative BAL pool, and thus was selected to continue to test in all further contriving studies.

Experimental Design #4: Sample Resuspension for Optimal Recovery

There are many parameters that can be altered to affect resuspension efficiency in prototype automated sample preparation systems. This study was meant to determine the most optimal set of conditions to allow for the highest cell recovery after preparation of a BAL or mini-BAL specimen in an implementation of the automated sample preparation system. The parameters altered in this study were: acceleration/deceleration rate, target velocity, reversal, motor cool off wait time, material, resuspension volume, as well as number of resuspension cycles.

Methods

The following values for each parameter were tested under a DOE matrix created using the DOE Wisdom software program:
Condition 1: Acceleration/Deceleration rate: 10,000 vs 100,000 rpm/second
Condition 2: Velocity target: 1,500 vs 5,000 rpm
Condition 3: Motor cool off wait time: 50 vs. 500 seconds
Condition 4: Number of resuspension cycles: 30 vs. 252
Condition 5: Reversal: Yes or no
Condition 6: Material type: Delrin vs. Polycarbonate
Condition 7: Fluid resuspension volume: 0.5 vs. 1.0 mL

The DOE matrix conditions and their associated values are presented below.

TABLE 7
Resuspension DOE Matrix

| Run# | Condition 1 | | Condition 2 | Condition 3 | | Condition 4 | | Condition 5 | Condition 6 | Condition 7 | |
|---|---|---|---|---|---|---|---|---|---|---|---|
| 1 | 10,000 | rpm | 1,500 rpm | 50 | sec | 30 | cycles | Yes | Delrin | 0.5 | mL |
| 2 | 10,000 | rpm | 1,500 rpm | 500 | sec | 252 | cycles | Yes | Polycarbonate | 1 | mL |
| 3 | 10,000 | rpm | 5,000 rpm | 50 | sec | 252 | cycles | No | Delrin | 1 | mL |
| 4 | 10,000 | rpm | 5,000 rpm | 500 | sec | 30 | cycles | No | Polycarbonate | 0.5 | mL |
| 5 | 100,000 | rpm | 1,500 rpm | 50 | sec | 252 | cycles | No | Polycarbonate | 0.5 | mL |
| 6 | 100,000 | rpm | 1,500 rpm | 500 | sec | 30 | cycles | No | Delrin | 1 | mL |
| 7 | 100,000 | rpm | 5,000 rpm | 50 | sec | 252 | cycles | Yes | Polycarbonate | 1 | mL |
| 8 | 100,000 | rpm | 5,000 rpm | 500 | sec | 30 | cycles | Yes | Delrin | 0.5 | mL |

All samples were contrived into a negative BAL specimen that was free of interfering substances.

All conditions were run using one automated sample preparation breadboard unit: BB01 to eliminate variability across instruments.

All runs were comprised of single spin and resuspension procedures in which the pelleting parameters were held constant. The pelleting parameters selected were the most successful condition run in the pelleting DOE described herein above.

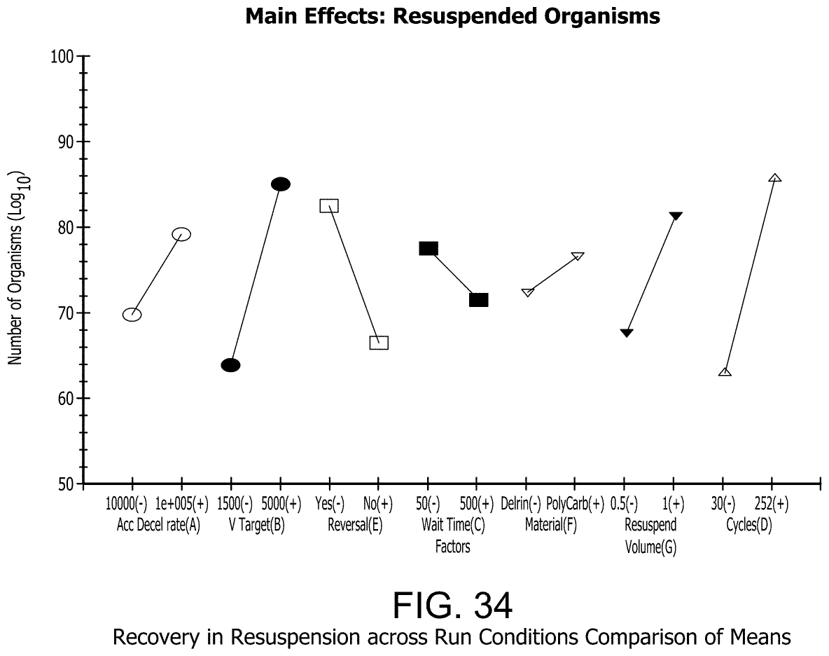

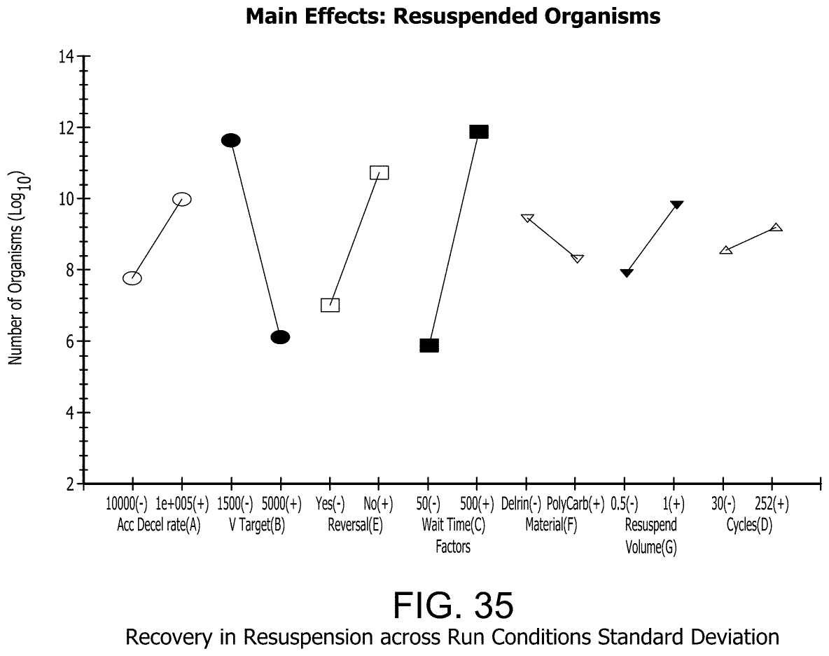

Runs 1-8 were run with both SAUR_ATCC_29213 and PSAR_ATCC_27853 to understand the differences between gram positive and gram-negative organisms. All 16 runs were run in a day and repeated the following day to understand differences from day to day. These data are summarized in FIGS. 34 and 35.

Both percent loss in the supernatant and percent recovery in resuspension were measured using quantitative drip plating. Percent recovery in the resuspension was used to determine the most successful parameters.

Summary of Data and Results

Table 8 below summarizes the data from the 32 resuspension DOE runs.

TABLE 8
Percent Loss and Recovery in Supernatant and Resuspension in Resuspension DOE

| | SAUR_ATCC_29213 | | PSAR_ATCC_27853 | |
|---|---|---|---|---|
| Isolate | Supernatant | Resuspension | Supernatant | Resuspension |
| Run 1 | 1.20% | 47.09% | 3.29% | 52.95% |
| Run 2 | 0.78% | 86.65% | 1.85% | 82.24% |
| Run 3 | 1.08% | 93.48% | 1.12% | 89.31% |
| Run 4 | 0.91% | 49.19% | 1.44% | 57.48% |
| Run 5 | 1.37% | 78.13% | 1.11% | 62.09% |
| Run 6 | 1.00% | 48.57% | 2.92% | 53.55% |
| Run 7 | 1.73% | 97.88% | 2.48% | 98.48% |
| Run 8 | 2.37% | 103.24% | 2.98% | 91.10% |

The results of this experiment are summarized in FIGS. 34 and 35, where FIG. 34 shows the mean recovery of organisms in the resuspension across run conditions, and FIG. 35 shows the standard deviation of recovered organisms in the resuspension. The number of organisms in the resuspension is shown on the Y-Axis (log₁₀ scale) in FIGS. 34-35. In FIGS. 34 and 35, the first two data points (open ovals) from the left compare the number of organisms detected in the resuspension when the Acceleration/Deceleration rate is 10,000 rpm/second (first open oval) and 100,000 rpm/second (second open oval). The next two data points (darkened ovals) compare the number of organisms detected in the resuspension when the velocity target is 1,500 rpm (first darkened oval) and 5,000 rpm (second darkened oval). The next two data points (open squares) compare the number of organisms in the resuspension when there is reversal (yes, first open square) and when there is no reversal (no, second open square). The next two data points (darkened squares) compare the number of organisms in the resuspension when the sample volume is motor cool off wait time is 50 seconds (first darkened square) and 500 seconds (second darkened square). The next two data points (open triangles) compare the number of organisms in the resuspension where the sample rotor is Delrin (first open triangle) or polycarbonate (second open triangle). The next two data points (darkened triangles) compare the number of organisms in the resuspension where the fluid resuspension volume was 0.5 mL (first darkened triangle) or 1.0 ml (second darkened triangle). The last two data points (open triangles pointed up) compare the number of organisms in the resuspension where the number of resuspension cycles is 30 (first open triangle) or 252 (second open triangle).

Below are Resuspension DOE Statistics from a DOE Wisdom program, with asterisks (*) indicating that they impact resuspension recovery. Thus, the Acceleration/Deceleration rate (A), Velocity target (B), Reversal (y/n) (E), Resuspension volume (G), and Number of resuspension cycles (D) impact resuspension recovery.

DOE Table B
DOE Wisdom Analysis of Variance

| Dependent Variable: | Resuspend Bugs |
|---|---|
| Number Runs(N): | 32 |
| Multiple R: | 0.913792 |
| Squared Multiple R: | 0.835017 |
| Adjusted Squared Multiple R: | 0.786896 |
| Standard Error of Estimate: | 10.0629 |

| Variable | Coefficient | Std Error | 95% CI | Tolerance | T | P(2Tail) |
|---|---|---|---|---|---|---|
| Constant | 74.4631 | 1.77888 | ±3.67142 | | 41.86 | 0 |
| Acc Decel rate(A)* | 4.66531 | 1.77888 | ±3.67142 | 1 | 2.623 | 0.015 |
| V Target(B)* | 10.5556 | 1.77888 | ±3.67142 | 1 | 5.934 | 0 |
| Reversal(E)* | −7.98969 | 1.77888 | ±3.67142 | 1 | −4.491 | 0 |
| Wait Time(C) | −2.96188 | 1.77888 | ±3.67142 | 1 | −1.665 | 0.109 |
| Material(F) | 2.05406 | 1.77888 | ±3.67142 | 1 | 1.155 | 0.26 |
| Resuspend Volume(G)* | 6.80437 | 1.77888 | ±3.67142 | 1 | 3.825 | 0.001 |
| Cycles(D)* | 11.3166 | 1.77888 | ±3.67142 | 1 | 6.362 | 0 |

| | Sum of | | Mean | | |
|---|---|---|---|---|---|
| Source | Squares | DF | Square | F Ratio | P |
| Regression | 12300.078 | 7 | 1757.1541 | 17.3527 | 0 |
| Residual | 2430.2629 | 24 | 101.26096 | | |

Ideal conditions predicted by DOE Wisdom program per DOE Table B:

DOE Wisdom Prediction Equation

| | | Supernatant | Resuspended | |
|---|---|---|---|---|
| | | Bugs | Bugs | D(composite) |
| | | 1.81125 | 120.811 | 0.996272 |
| 95% CI: | | ±2.42147 | ±23.2201 | Not Available |
| Variable | Setting | | | |
| Constant | N/A | 1.725 | 74.4631 | Not Available |
| Acc Decel rate(A) | 100000 | 0.268125 | 4.66531 | Not Available |
| V Target(B) | 5000 | 0.035 | 10.5556 | Not Available |
| Reversal(E) | Yes | −0.358125 | −7.98969 | Not Available |
| Wait Time(C) | 50 | 0.055 | −2.96188 | Not Available |
| Material(F) | PolyCarb | −0.269375 | 2.05406 | Not Available |
| Resuspend Volume(G) | 1 | −0.10625 | 6.80437 | Not Available |
| Cvcles(D) | 252 | −0.144375 | 11.3166 | Not Available |

Conclusions Of the runs completed, run 7 across both isolates provided the highest recovery in the resuspension despite some loss in the supernatant. The most favorable resuspension condition tested was using an acceleration and deceleration speed of 100,000 rpm hitting a target velocity of 5,000 rpm with a motor cool off time of 50 seconds and 30 resuspension cycles with reversal using polycarbonate as the material type and a final resuspension volume of 1.0 mL. Run 8 also had a high recovery but with more loss in the supernatant and had many of the same factors except motor cool off time, number of resuspend cycles, material type and sample resuspension volume.

The parameters that impact the recovery in the resuspension and the preferred value were: acceleration and deceleration rate (100,000 rpm), velocity target (5,000 rpm), reversal (yes), resuspend volume (1 mL), and number of resuspend cycles (252). The motor cool off time and material type did not have a statistical impact on performance.

The optimal conditions determined from this resuspension DOE were: using a resuspension acceleration and deceleration of 100,000 rpm with a target velocity of 5,000 rpm having a motor cool off time of 50 seconds and 252 resuspension cycles with reversal using polycarbonate as the material type and a final resuspension volume of 1 mL.

Experimental Design #5: Capsule Material Selection for Optimal Recovery

Initial capsule rotors used in prototype automated sample preparation system modules were manufactured using three different plastic material types: polycarbonate, polypropylene and Delrin. Polypropylene is very commonly used in laboratories and is the material used in many components of commercially available test kits. Delrin is the cheapest plastic for use in disposable components, while polycarbonate is the easiest to manufacture. Each plastic type has benefits and seemed to show minimal differences in both the pelleting and resuspension DOE experiments. A study comparing both polycarbonate and polypropylene using the Run #7 resuspension condition from the resuspension DOE was completed to understand the material type that produces the highest resuspension recovery. In addition, three different capsule designs (normal, shelf, and trough) were manufactured to determine which capsule shape produced optimal recovery.

Methods

In one study, PSAR_ATCC_27853 was spiked at 1×10³ cfu/mL and was spiked into a negative BAL and put into either a polycarbonate or polypropylene capsule and run with the Run #7 condition from the resuspension DOE described herein above. Each material type was spiked and run in replicates of eight.

Another study measured the difference in bacterial recovery using the three different capsule shapes: shelf, trough and normal capsules. The capsule shape design studies were completed using the automated sample preparation FM modules and SAUR_ATCC_29213 spiked at 1×10⁵ cfu/mL. Average growing clones and bead concentration were assessed for all three capsule designs and were compared to a manual preparation method. The three different capsule designs are illustrated in FIGS. 15A, 15B and 15C.

Summary of Data and Results

In certain implementations, the automated sample preparation instrument system comprises a growth function for certain specimen types. The growth function would enable microorganisms to be incubated in, e.g., for example, a capsule rotor under environmentally controlled conditions to increase microbial cell counts. The following table shows the results of an automated sample preparation breadboard model looking across polypropylene and polycarbonate conditions to determine which material type consistently produced higher recovery of microbial cells.

TABLE 9
Polypropylene vs Polycarbonate Material Type Percent Recoveries

| | | Initial | Supernatant | | Resuspension | |
|---|---|---|---|---|---|---|
| | | Sample | Loss | Supernatant | Recovery | Recovery |
| Run # | Material Type | CFU/mL | CFU/mL | % Loss | CFU/mL | % |
| 1 | Polycarbonate | 1.29 × 10³ | 3.33 × 10¹ | 2.58% | 1.12 × 10³ | 88.67% |
| 2 | Polycarbonate | 1.30 × 10³ | 6.67 × 10⁰ | 0.51% | 1.20 × 10³ | 92.78% |
| 3 | Polycarbonate | 1.34 × 10³ | 1.33 × 10¹ | 1.00% | 1.18 × 10³ | 88.64% |
| 4 | Polycarbonate | 1.40 × 10³ | 2.00 × 10¹ | 1.43% | 1.20 × 10³ | 87.50% |
| 5 | Polypropylene | 1.16 × 10³ | 6.67 × 10⁰ | 0.57% | 1.03 × 10³ | 89.13% |
| 6 | Polypropylene | 1.11 × 10³ | 6.67 × 10¹ | 6.02% | 9.24 × 10² | 88.73% |
| 7 | Polypropylene | 1.34 × 10³ | 3.33 × 10¹ | 2.49% | 1.10 × 10³ | 83.88% |
| 8 | Polypropylene | 1.31 × 10³ | 4.00 × 10¹ | 3.05% | 1.07 × 10³ | 84.28% |
| 9 | Polycarbonate | 1.33 × 10³ | 3.33 × 10¹ | 2.51% | 1.15 × 10³ | 88.67% |
| 10 | Polycarbonate | 1.40 × 10³ | 3.33 × 10¹ | 2.39% | 1.08 × 10³ | 78.96% |
| 11 | Polycarbonate | 1.37 × 10³ | 4.67 × 10¹ | 3.41% | 1.19 × 10³ | 90.21% |
| 12 | Polycarbonate | 1.43 × 10³ | 2.67 × 10¹ | 1.87% | 1.12 × 10³ | 80.21% |
| 13 | Polypropylene | 1.28 × 10³ | 3.33 × 10¹ | 2.61% | 1.22 × 10³ | 98.18% |
| 14 | Polypropylene | 1.35 × 10³ | 2.00 × 10¹ | 1.48% | 1.16 × 10³ | 87.39% |
| 15 | Polypropylene | 1.40 × 10³ | 3.33 × 10¹ | 2.38% | 1.24 × 10³ | 90.73% |
| 16 | Polypropylene | 1.44 × 10³ | 3.33 × 10¹ | 2.31% | 1.08 × 10³ | 76.78% |

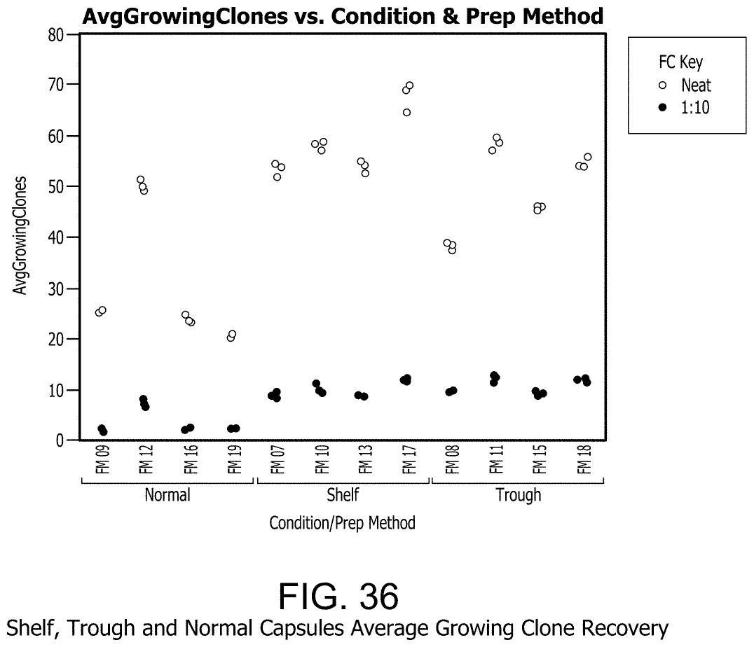

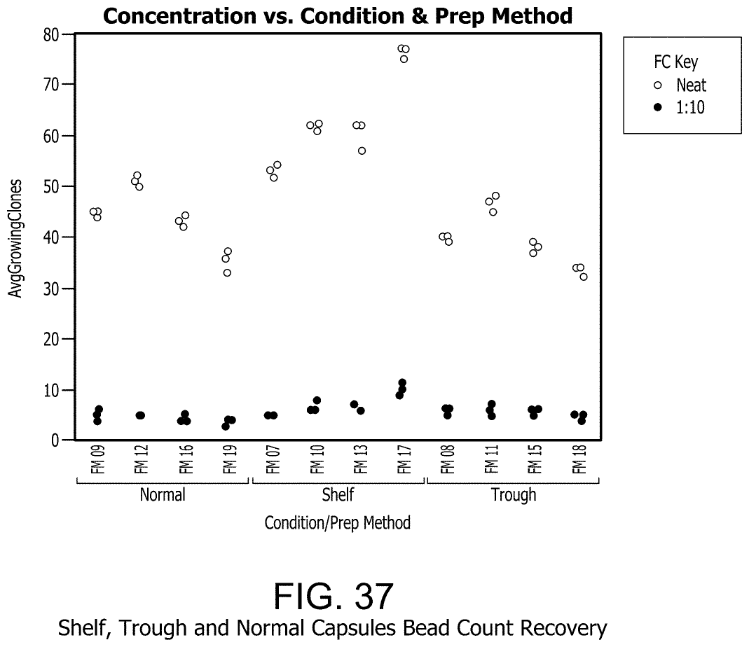

FIG. 36 shows the number of average growing clones obtained from two runs using normal, shelf, and trough capsules at neat and 1:10 dilution concentrations. FIG. 36 shows the bead count recovery obtained from two runs using normal, shelf, and trough capsules at neat and 1:10 dilution concentrations. The capsule shape study utilizing all polypropylene material for the normal, shelf and trough designs were compared using SAUR_ATCC_29213. Both runs, depicted in the dot plots of FIGS. 36 and 37, respectively, showed improved performance in growing clones when using the shelf capsule relative to the trough capsule.

Conclusions

Polycarbonate and polypropylene capsules performed similarly in recovery and loss in the supernatant using the automated sample preparation system module. Nonetheless, polypropylene was chosen for future studies. The shelf capsules provide both higher growing clone and bead concentration counts, and therefore the shelf design was selected for all future studies using the automated sample preparation system.

Experimental Design #6: Inhibition Removal Necessity with Real Sample Examples

BAL and mini-BAL specimens are collected at the time of patient symptoms of a lower respiratory tract infection as well as throughout treatment. Many fresh positive specimens were received at Accelerate Diagnostics, Inc. and exhibited very slow to minimal growth on plates. Samples from BANNER-PHX, Medfusion, Pittsburgh as well as TriCore were received and screened for positivity. Following this screening, an inhibition screening was developed in which Mueller Hinton agar plates were used and 100 μL of specimen was allowed to dry on the center of the plate. After this, sensitive organisms were used to streak in a disk diffusion method across the MHA plates. These were incubated overnight in a 37° C. incubator and the zones of inhibition were measured in the morning. This diskless disk diffusion method allowed for visualization of any inhibition that was present against ECOL_ATCC_25922, SAUR_ATCC_29213, PROV_ATCC_6380 and PRMI_IHMA_827374 in each of the specimens. In one week of specimens from BANNER-PHX, there were 49 specimens received of which 18 were positive for a pathogen, 4 were negative for a pathogen or normal flora, and 27 had normal flora of varying levels. Of the samples received, 23 were screened for inhibition. Of the 23 specimens screened, 14 showed inhibition to one or all the organisms tested. This indicates that there are interfering substances that are innate to respiratory specimens. These inhibitory substances likely include: antibiotics (both inhaled and oral), surfactant from the lungs, lidocaine from the sample removal procedure, as well as immune system cells. The main goal of the automated sample preparation system module is to significantly decrease—if not fully remove—inhibitory substances present in specimens such that identification and antibiotic susceptibility testing can be completed with that specimen without any interference from such substances.

Methods

A shipment received from BANNER-PHX in March of 2018 was selected to further understand inhibition in positive specimens. This set of specimens contained 61% inhibition using the diskless disk diffusion screening method. Each specimen went through screening in which 100 μL of sample was plated on Trypticase soy agar with 5% sheep's blood (TSA), MacConkey and Chocolate agar plates using a four-quadrant streak method. After 48 hours, samples were determined to be either positive, negative, or normal flora only. Of the specimens that were positive, a diskless disk diffusion was completed in which 100 μL of specimen was dispensed onto four different MHA plates and left to dry. After the plates were dry, the following organisms were lawned on the MHA plates: SAUR_ATCC_29213, ECOL_ATCC_25922, PROV_ATCC_6380 and PRMI_IRMA_827374. In addition to this inhibition screening a self-inhibition screening was completed in which 100 μL of the specimen was dispensed onto an MHA plate and the organism in the highest initial concentration was used for lawning the plate. The results of these tests are shown in Table 10, third column. Also, a growth screening was completed in which a control (no cleanup condition) was compared to a 1 spin and resuspension cleanup as well as a 2 or 3 spin and resuspension cleanup. Each sample prepared was mixed 1:1 with MHB and left in the thermomixer to grow for 4 hours. Plating of each of the specimens occurred both prior to and after 4 hours of growth. Results of these tests are summarized in Table 10, fourth column, and the referenced figures. In addition, a supernatant dilution screening was completed in which the following dilutions (Neat, 1:2, 1:4, 1:8, 1:16, 1:32 and 1:64) of the supernatant were plated to determine at what dilution the inhibition is removed. After 100 μL of each of the diluted samples was dispensed onto MHA plates PROV_ATCC_6380 was used to lawn the plates as this is the most sensitive organism that was tested in the above inhibition tests. Results of these tests are summarized in Table 10, fifth column, and the referenced figures.

In addition to the 23 positives tested, 20 negatives were also screened for inhibition to determine if the same rate of occurrence is present in positive and negative specimens.

To shorten the assay timing and limit loss of bacteria associated with multiple spin and resuspension steps to cleanup inhibition a rinse vs. wash study was completed to understand whether a rinse was as effective as a wash in removing inhibitory substances in respiratory specimens. A rinse is an approach by which sample is loaded into the capsule rotor and pelleted for 5 minutes at 20,000 rpm, the supernatant then is removed, and a wash fluid is added; this is repeated four times and in the final wash a full resuspension removes the cells from the wall of the capsule rotor to present to a downstream ID/AST or other sample analysis instrument. In the wash approach, the sample is loaded into the capsule rotor and pelleted for 5 minutes at 20,000 rpm, the supernatant is removed, and a wash fluid is added; this then undergoes a resuspension and these steps are repeated five times. Using the automated sample preparation breadboard model, both approaches were tested with real specimens to determine whether a rinse was as effective as a wash in removing inhibition. Another study was aimed at understanding loss associated with both methods. In this study SAUR_ATCC_29213 was spiked at 1×10⁵ and run with either a manual or automated sample preparation procedure using a rinse or wash approach.

Summary of Data and Results

Of the 23 specimens, 14 were found to have inhibition to at least one organism that was tested. Table 10 highlights the different tests that were completed on each sample.

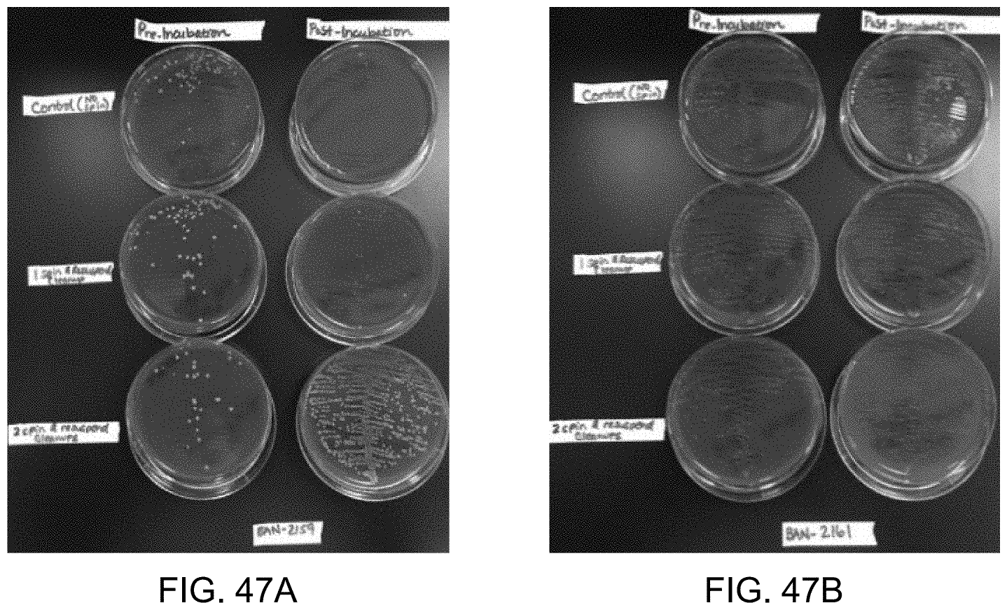

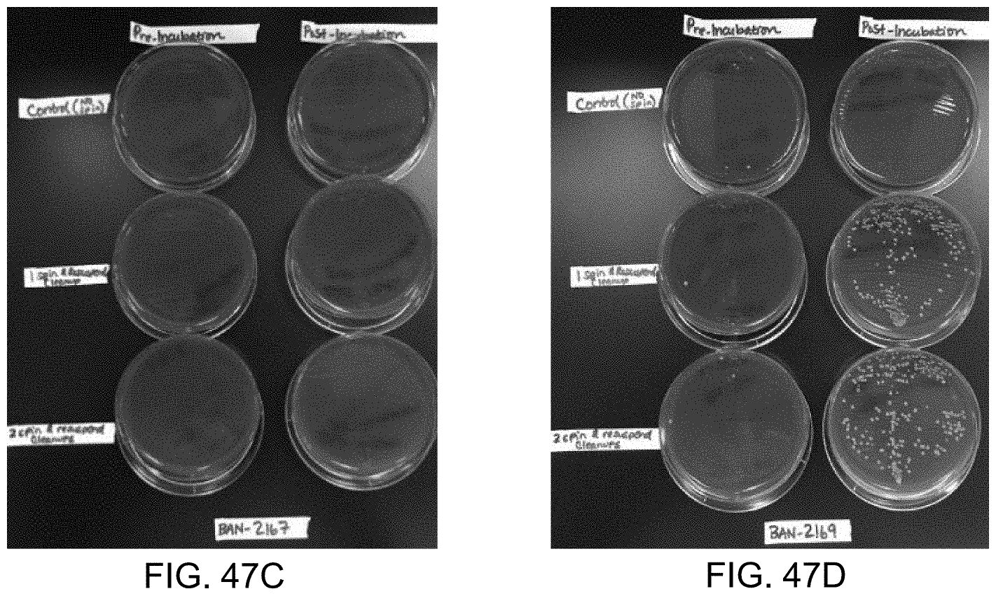

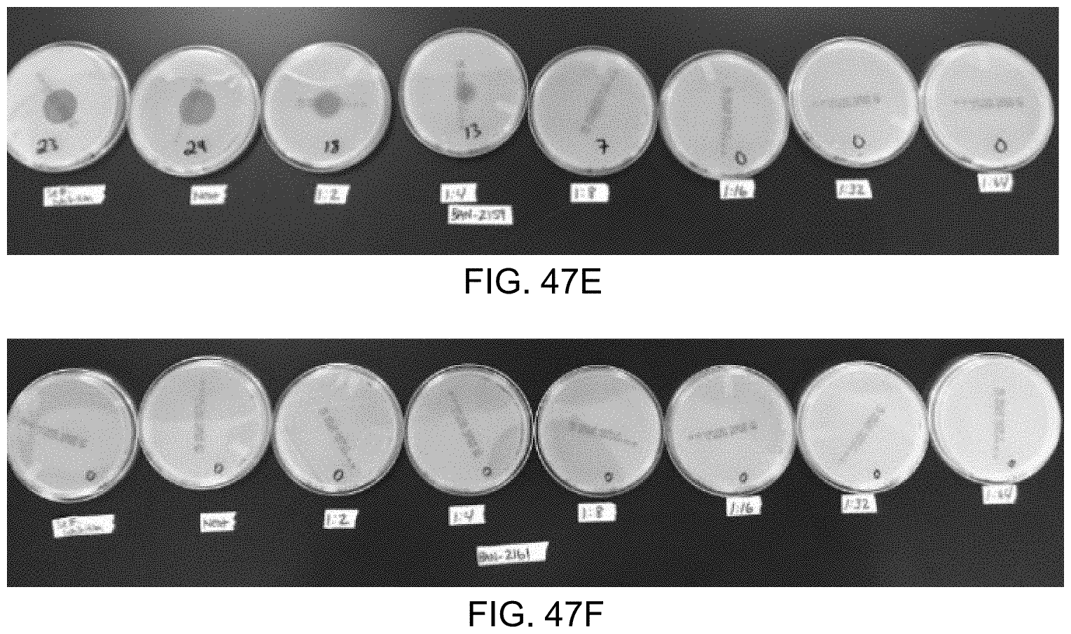

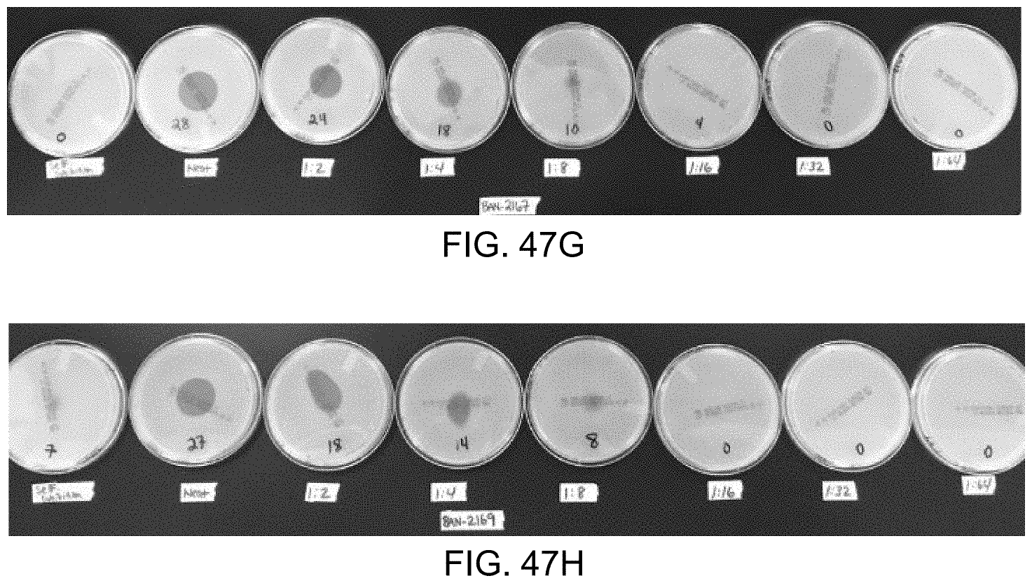

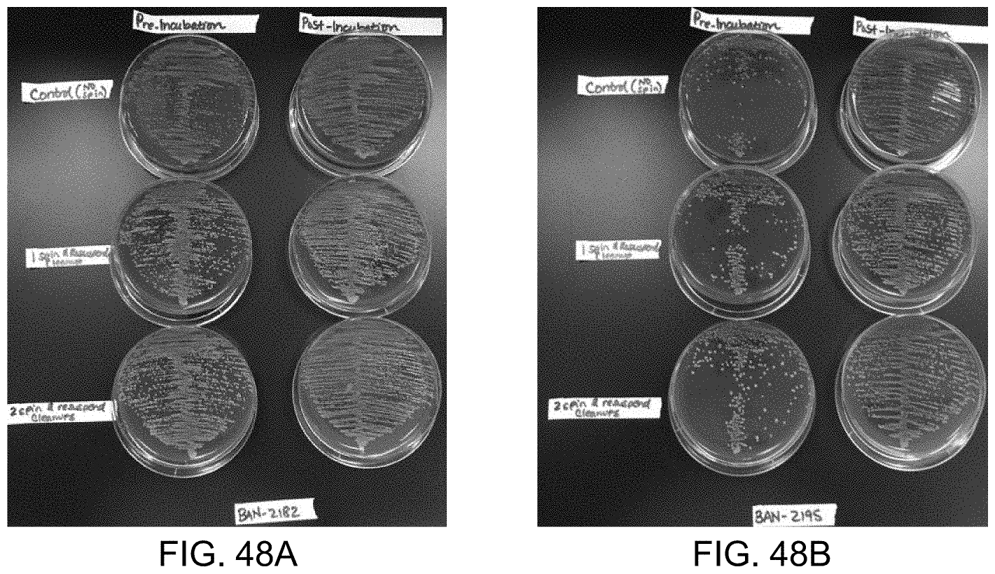

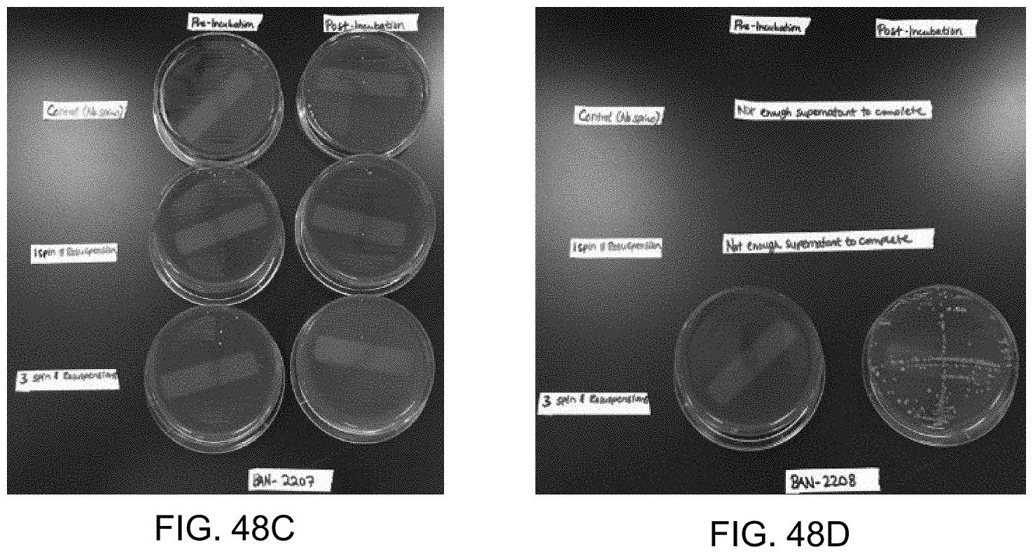

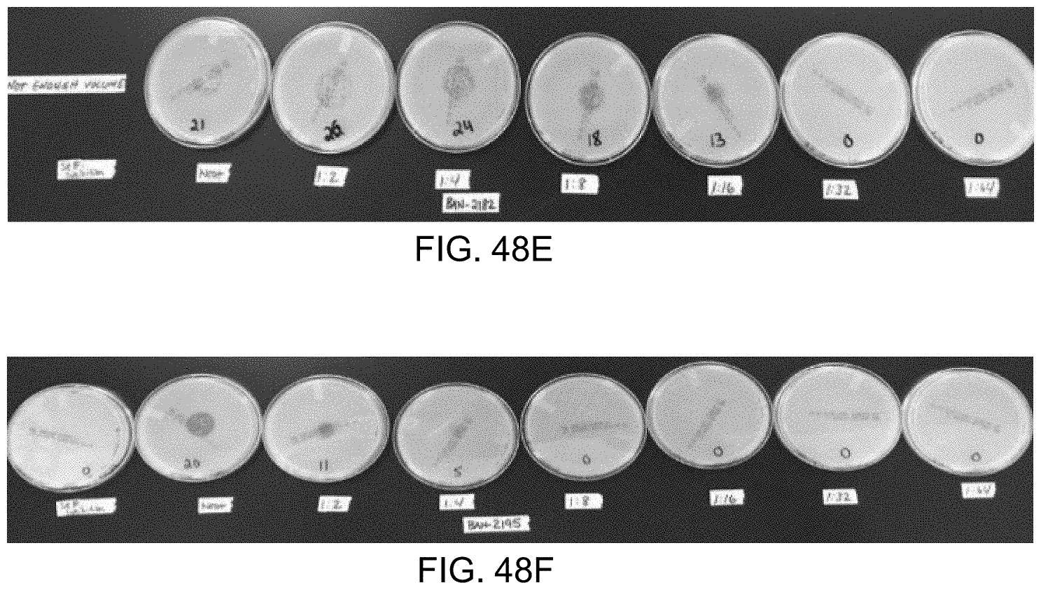

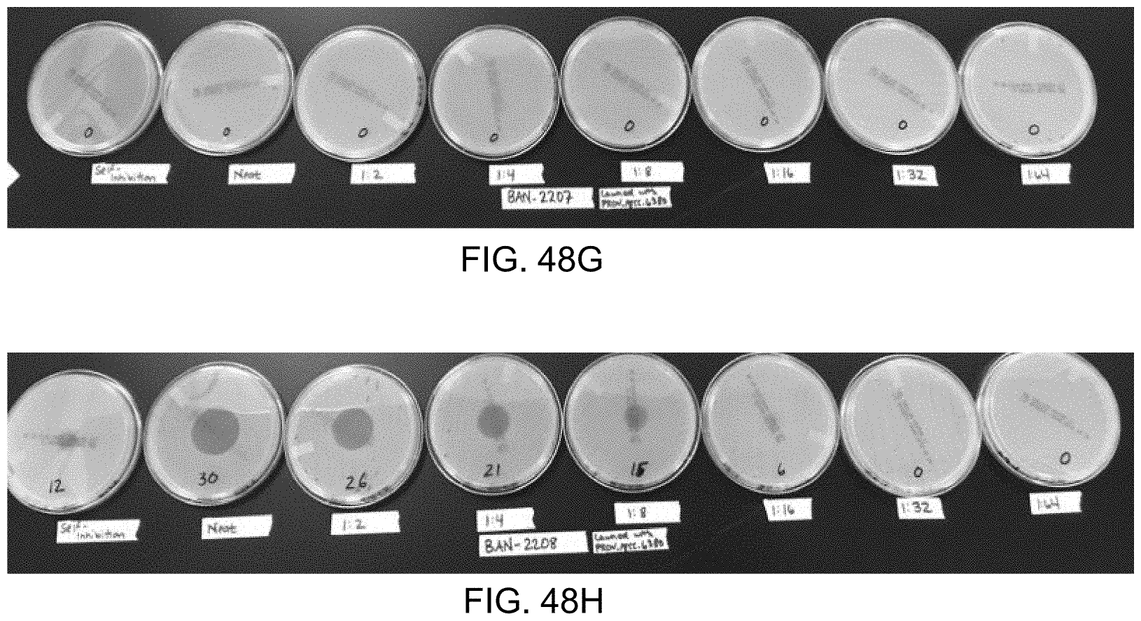

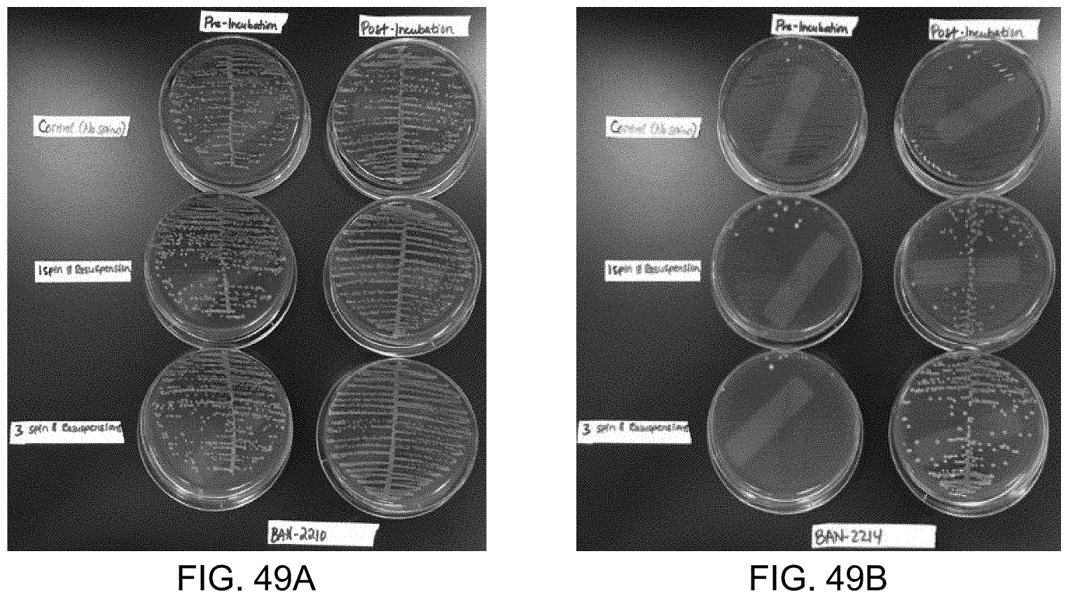

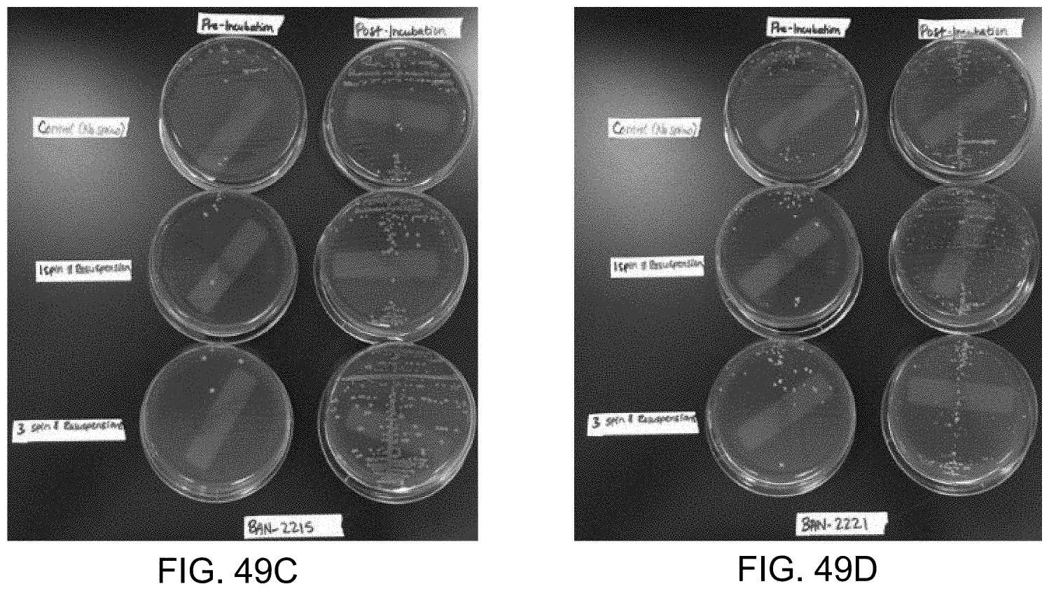

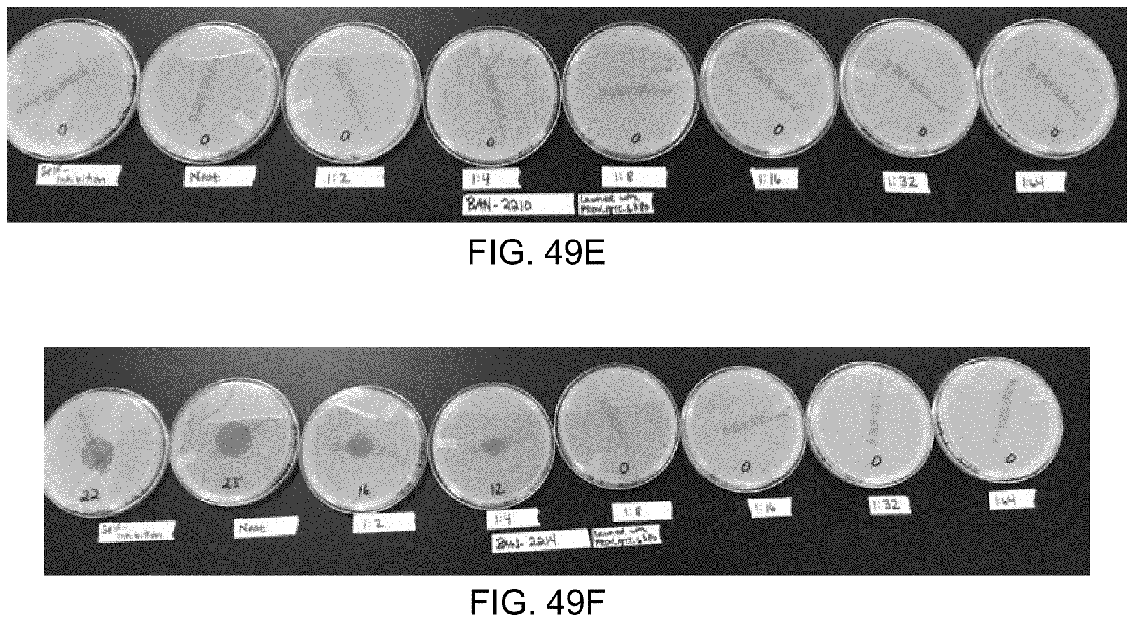

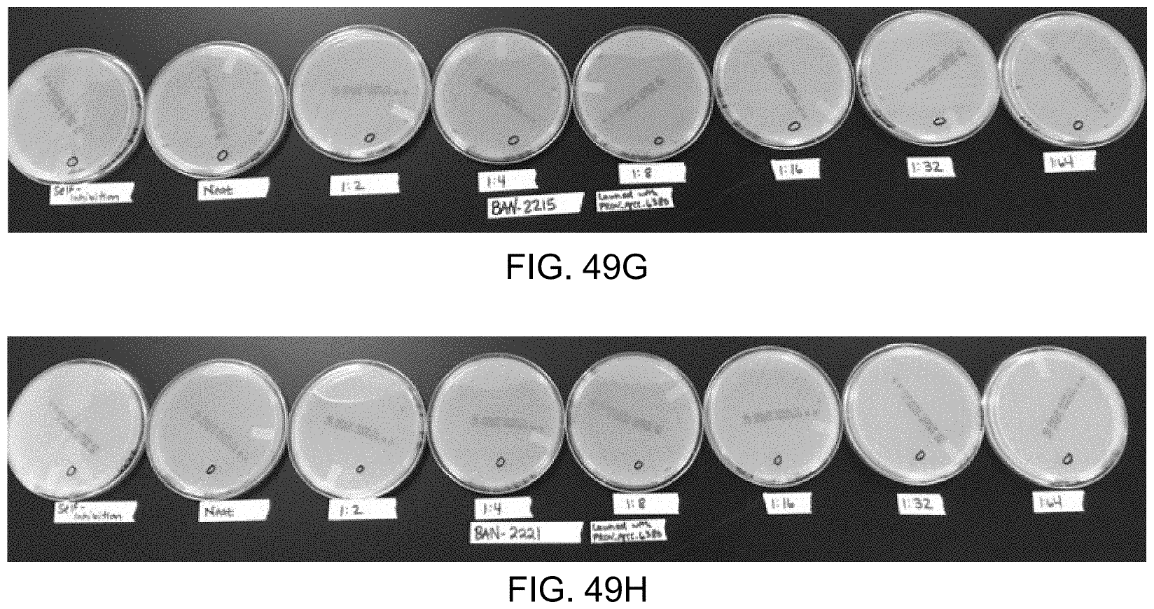

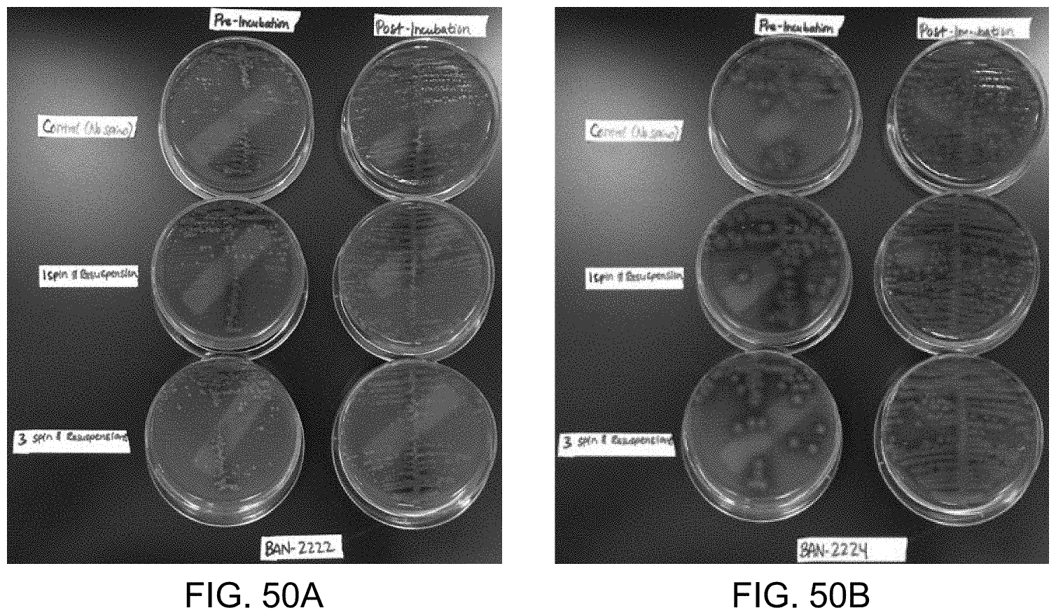

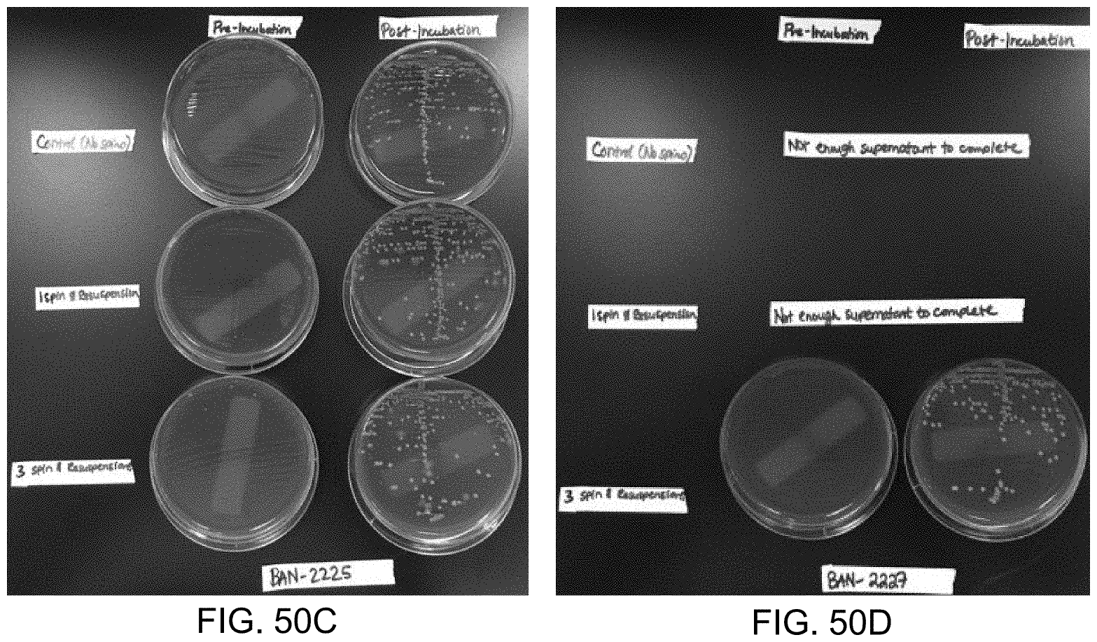

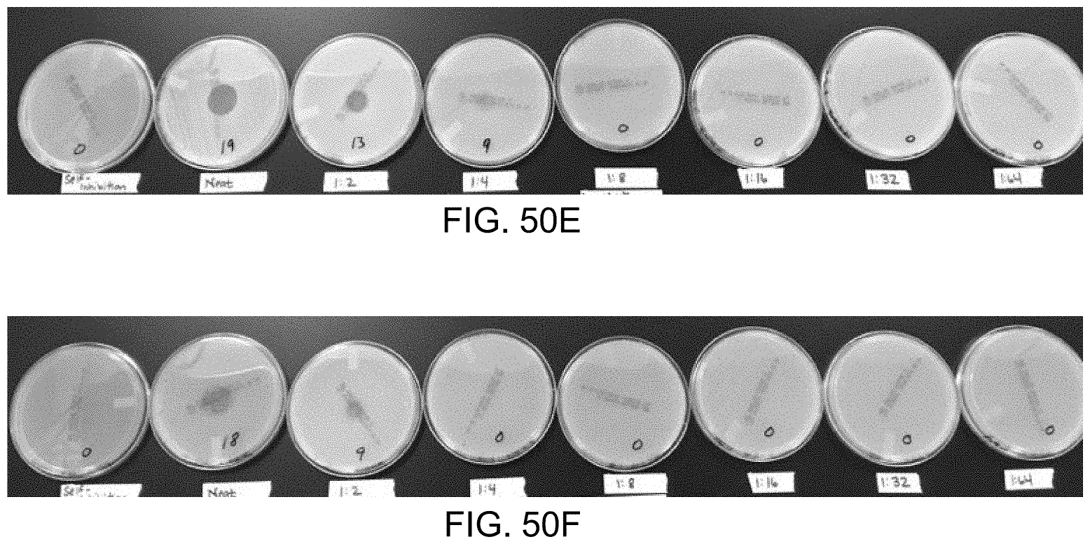

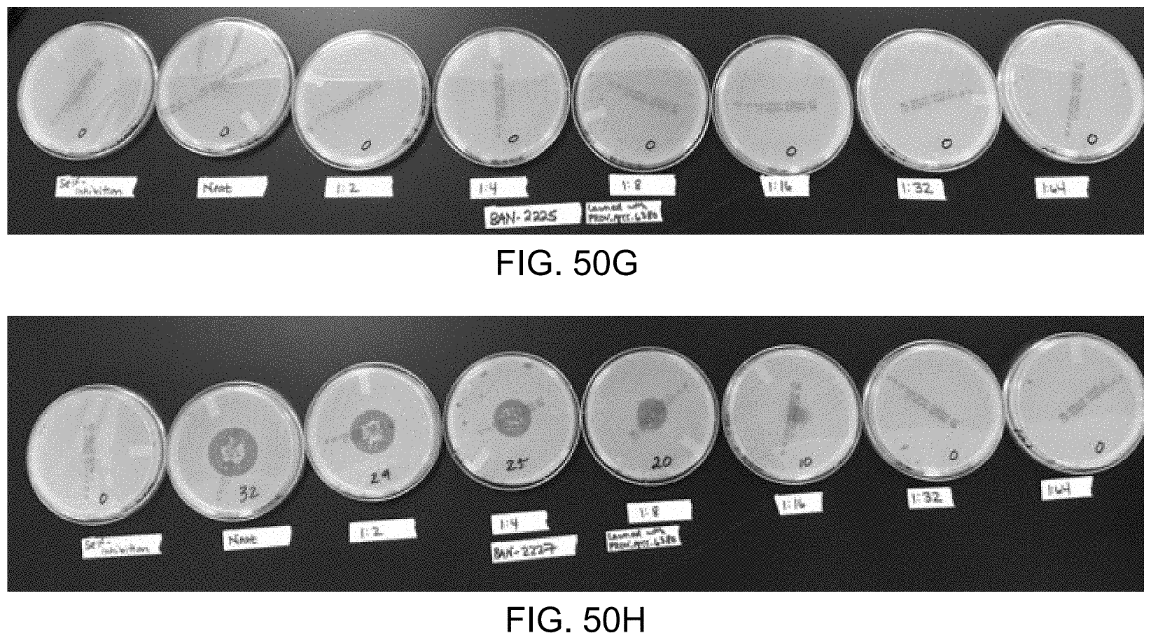

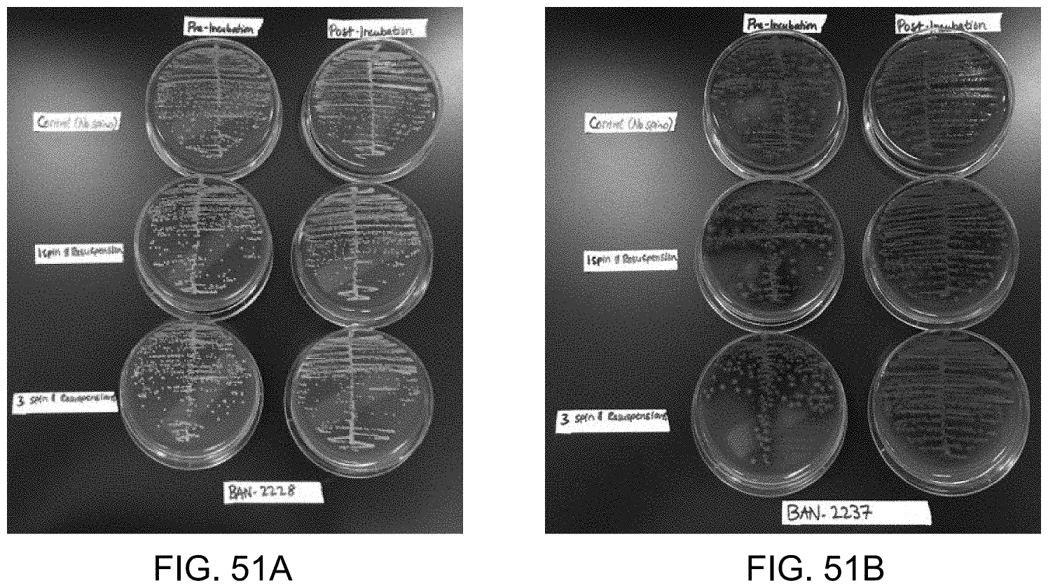

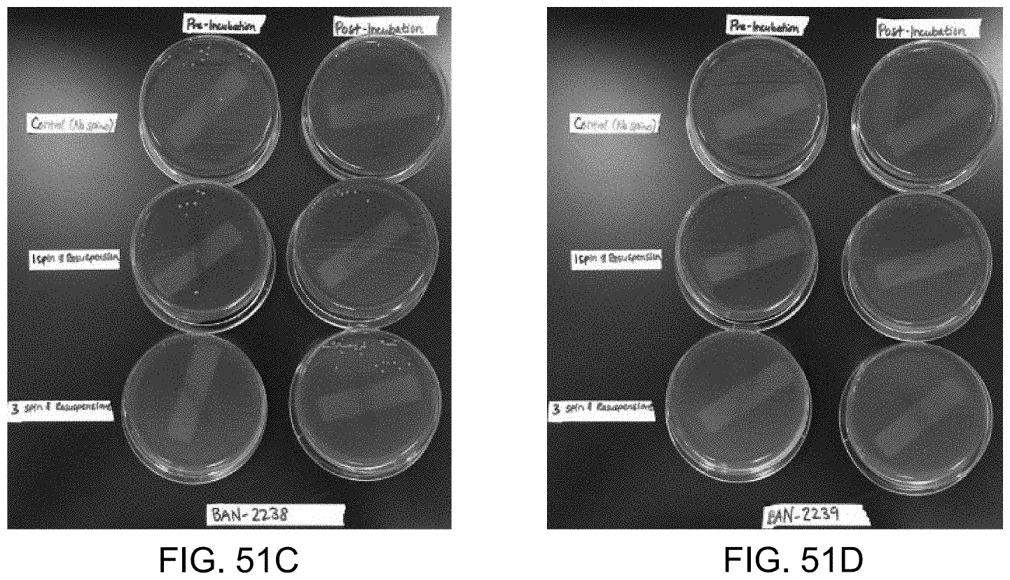

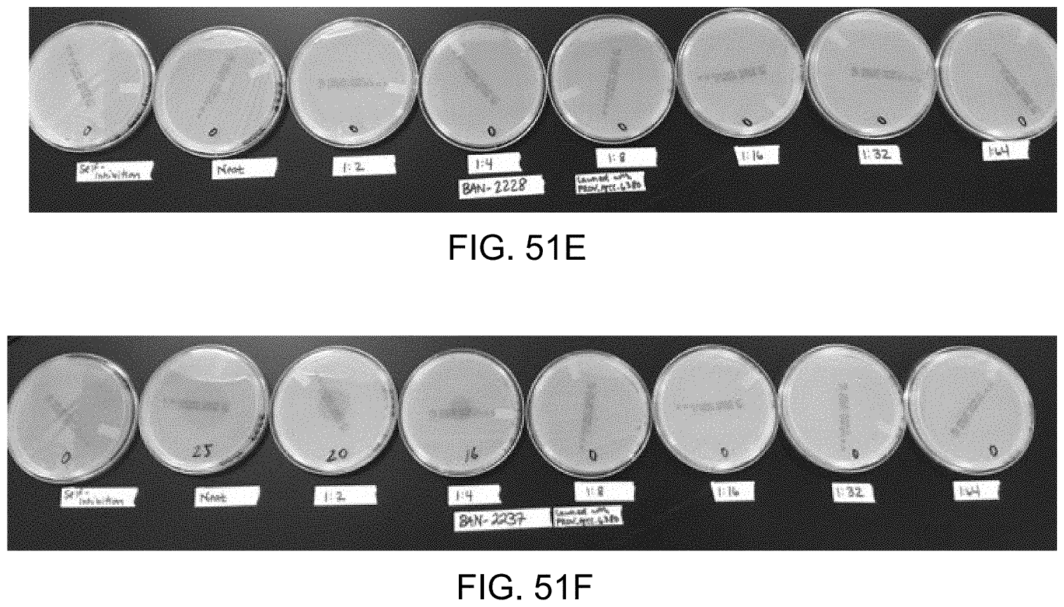

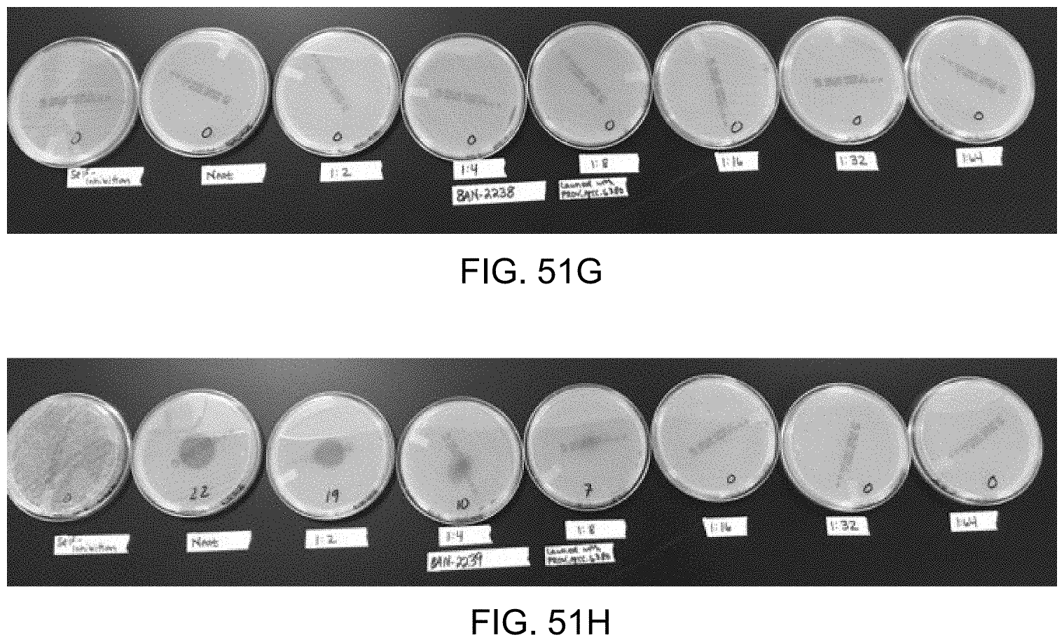

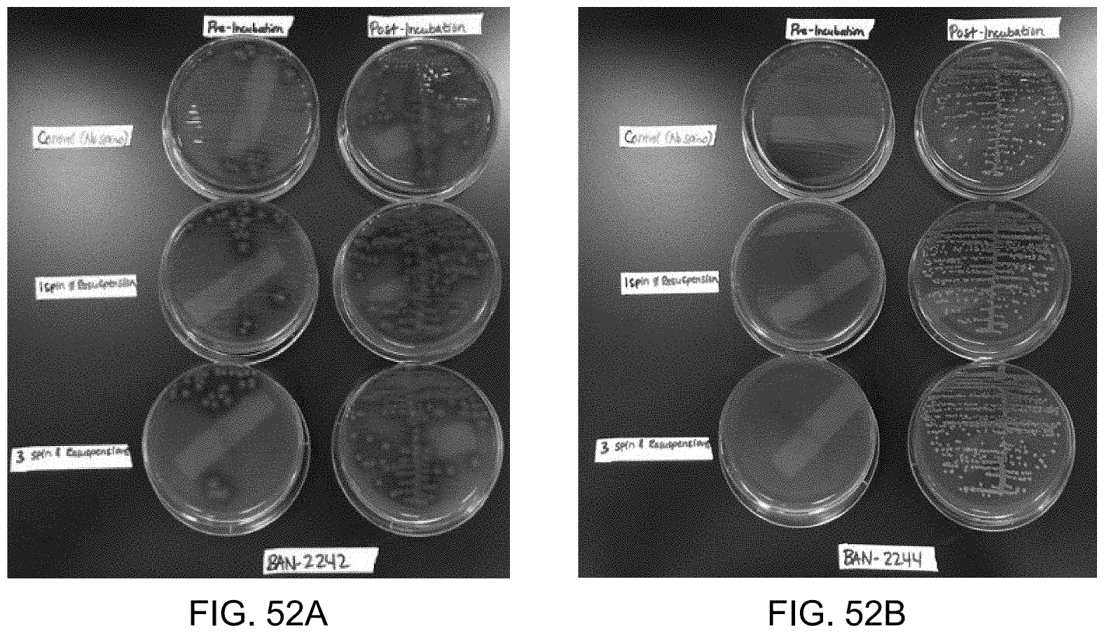

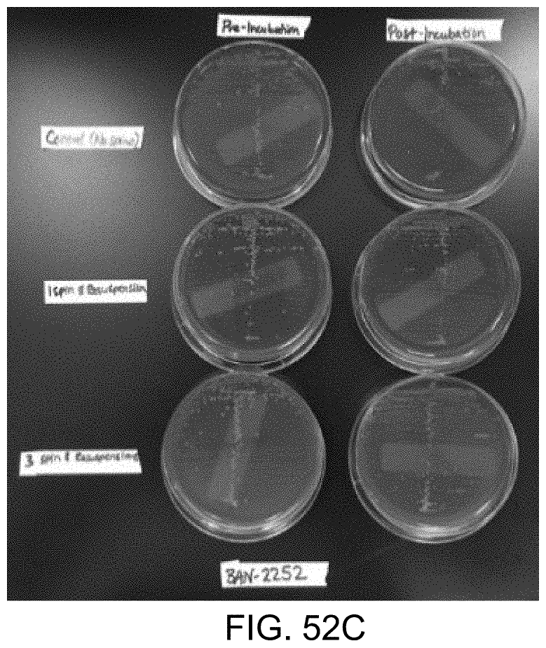

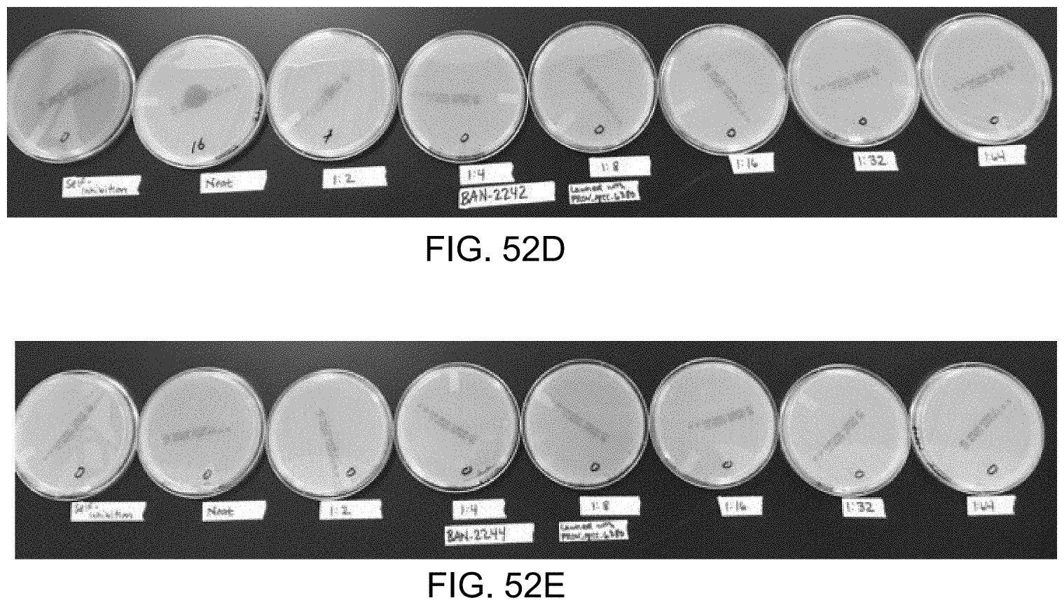

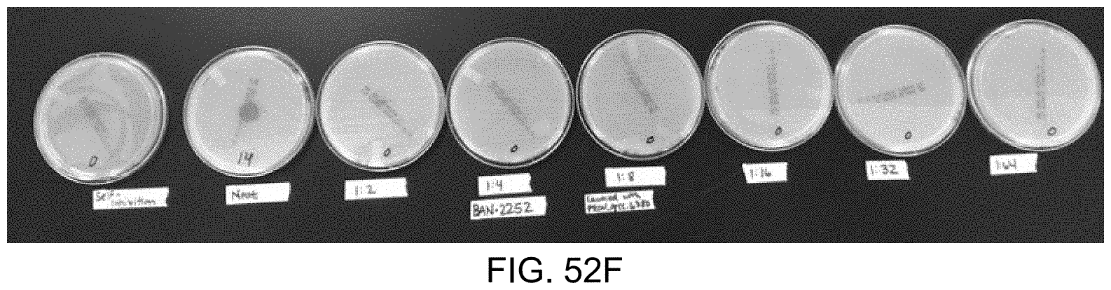

FIG. 47A-47D, referenced in Table 10, depict images of pre- and post-incubation plating from samples that have undergone a no spin and resuspension cleanup (control), 1 spin and resuspension cleanup and 2 spin and resuspension cleanup for samples BAN_2159, BAN_2161, BAN_2167 and BAN_2169; FIG. 48A-48D, referenced in Table 10, depict images of pre- and post-incubation plating from samples that have undergone a no spin and resuspension cleanup (control), 1 spin and resuspension cleanup and 2 spin and resuspension cleanup for samples BAN_2182, BAN_2195, BAN_2207 and BAN_2208, respectively; FIG. 49A-49D, referenced in Table 10, depict images of pre- and post-incubation plating from samples that have undergone a no spin and resuspension cleanup (control), 1 spin and resuspension cleanup and 2 spin and resuspension cleanup for samples BAN_2210, BAN_2214, BAN_2215 and BAN_2221, respectively; FIG. 50A-50D, referenced in Table 10, depict images of pre- and post-incubation plating from samples that have undergone a no spin and resuspension cleanup (control), 1 spin and resuspension cleanup and 2 spin and resuspension cleanup for samples BAN_2222, BAN_2224, BAN_2225 and BAN_2227, respectively; FIG. 51A-50D, referenced in Table 10, depict images of pre- and post-incubation plating from samples that have undergone a no spin and resuspension cleanup (control), 1 spin and resuspension cleanup and 2 spin and resuspension cleanup for samples BAN_2228, BAN_2237, BAN_2238 and BAN_2239, respectively; FIG. 52A-52D, referenced in Table 10, depict images of pre- and post-incubation plating from samples that have undergone a no spin and resuspension cleanup (control), 1 spin and resuspension cleanup and 2 spin and resuspension cleanup for samples BAN_2242, BAN_2244 and BAN_2252, respectively.

FIG. 47E-47H, referenced in Table 10, depict images of supernatant plating for samples BAN_2159, BAN_2161, BAN_2167 and BAN_2169; FIG. 48E-48H, referenced in Table 10, depict images of supernatant plating for samples BAN_2182, BAN_2195, BAN_2207 and BAN_2208, respectively; FIG. 49E-49H, referenced in Table 10, depict images of supernatant plating for samples BAN_2210, BAN_2214, BAN_2215 and BAN_2221, respectively; FIG. 50E-50H, referenced in Table 10, depict images of supernatant plating for samples BAN_2222, BAN_2224, BAN_2225 and BAN_2227, respectively; FIG. 51E-51H, referenced in Table 10, depict images of supernatant plating for samples BAN_2228, BAN_2237, BAN_2238 and BAN_2239, respectively; FIG. 52E-52F, referenced in Table 10, depict images of supernatant plating for samples BAN_2242, BAN_2244 and BAN_2252, respectively.

TABLE 10
Positive Specimen Inhibition Screening Methods.

| | | | | | Supernatant Dilution | | | |
|---|---|---|---|---|---|---|---|---|
| | | | | | Inhibition is shown by | | | |
| | | Initial | | | diameter in | | | |
| | MALDI | Inhibition | Pre and Post Incubation | | millimeters (mm) of | | | |
| Sample | result | Screening | Plating with Cleanup | | zone of inhibition | | | Interpretation |
| BAN_2159 | KLPN, | Self-inhibition | Control + | Control + | Self- | 23 | mm | No inhibition |
| | PSAR, | (21 mm), | Pre- | Post- | inhibition | | | after 2 spins |
| | PRMI | SAUR(20 mm), | incubation | incubation | Neat | 24 | mm | and 1:16 |
| | | ECOL (0 mm), | 1 Spin + | 1 Spin + | 1:2 | 18 | mm | dilution |
| | | PROV (23 mm), | Pre- | Post- | 1:4 | 13 | mm | |
| | | PRMI (18 mm) | incubation | incubation | 1:8 | 7 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 47A | | Plate Images: See FIG. 47E | | | |
| BAN_2161 | PSAR | Self-inhibition | Control + | Control + | Self- | 0 | mm | No inhibition |
| | | (0 mm), | Pre- | Post- | inhibition | | | |
| | | SAUR(20 mm), | incubation | incubation | Neat | 0 | mm | |
| | | ECOL (0 mm), | 1 Spin + | 1 Spin + | 1:2 | 0 | mm | |
| | | PROV (0 mm), | Pre- | Post- | 1:4 | 0 | mm | |
| | | PRMI (0 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 47B | | Plate Images: See FIG. 47F | | | |
| BAN_2167 | PSAR | Self-inhibition | Control + | Control + | Self- | 0 | mm | No inhibition |
| | | (0 mm), | Pre- | Post- | inhibition | | | after 2 spins |
| | | SAUR(0 mm), | incubation | incubation | Neat | 28 | mm | and 1:32 |
| | | ECOL (26 mm), | 1 Spin + | 1 Spin + | 1:2 | 24 | mm | dilution |
| | | PROV (30 mm), | Pre- | Post- | 1:4 | 18 | mm | |
| | | PRMI (22 mm) | incubation | incubation | 1:8 | 10 | mm | |
| | | | 2 Spin + | 2 Spin + | 1:16 | 4 | mm | |
| | | | Pre- | Post- | 1:32 | 0 | mm | |
| | | | incubation | incubation | 1:64 | 0 | mm | |
| | | | Plate Images: See FIG. 47C | | Plate Images: See FIG. 47G | | | |
| BAN_2169 | KLPN | Self-inhibition | Control + | Control + | Self- | 7 | mm | No inhibition |
| | | (7 mm), | Pre- | Post- | inhibition | | | after 1 spin |
| | | SAUR(0 mm), | incubation | incubation | Neat | 27 | mm | and 1:16 |
| | | ECOL (12 mm), | 1 Spin + | 1 Spin + | 1:2 | 18 | mm | dilution |
| | | PROV (28 mm), | Pre- | Post- | 1:4 | 14 | mm | |
| | | PRMI (26 mm) | incubation | incubation | 1:8 | 8 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 47D | | Plate Images: See FIG. 47H | | | |
| BAN_2182 | ABAU | Self-inhibition | Control + | Control + | Self- | Not enough | | No inhibition |
| | | (not enough | Pre- | Post- | inhibition | vaccine | | after 1:32 |
| | | volume to test), | incubation | incubation | Neat | 21 | mm | dilution |
| | | SAUR(15 mm), | 1 Spin + | 1 Spin + | 1:2 | 26 | mm | |
| | | ECOL (30 mm), | Pre- | Post- | 1:4 | 24 | mm | |
| | | PROV (27 mm), | incubation | incubation | 1:8 | 18 | mm | |
| | | PRMI (0 mm) | 2 Spin + | 2 Spin + | 1:16 | 13 | mm | |
| | | | Pre- | Post- | 1:32 | 0 | mm | |
| | | | incubation | incubation | 1:64 | 0 | mm | |
| | | | Plate Images: See FIG. 48A | | Plate Images: See: FIG. 48E | | | |
| BAN_2195 | ECOL | Self-inhibition | Control + | Control + | Self- | 0 | mm | No inhibition |
| | | (0 mm), | Pre- | Post- | inhibition | | | after 1:8 |
| | | SAUR(0 mm), | incubation | incubation | Neat | 20 | mm | dilution |
| | | ECOL (20 mm), | 1 Spin + | 1 Spin + | 1:2 | 11 | mm | |
| | | PROV (18 mm), | Pre- | Post- | 1:4 | 5 | mm | |
| | | PRMI (0 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 48B | | Plate Images: See FIG. 48F | | | |
| BAN_2207 | SAUR | Self-inhibition | Control + | Control + | Self- | 0 | mm | No inhibition |
| | | (0 mm), | Pre- | Post- | inhibition | | | present in |
| | | SAUR(0 mm), | incubation | incubation | Neat | 0 | mm | sample |
| | | ECOL (0 mm), | 1 Spin + | 1 Spin + | 1:2 | 0 | mm | |
| | | PROV (0 mm), | Pre- | Post- | 1:4 | 0 | mm | |
| | | PRMI (0 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 48C | | Plate Images: See FIG. 48G | | | |
| BAN_2208 | KLPN | Self-inhibition | Control + | Control + | Self- | 12 | mm | No inhibition |
| | | (12 mm), | Pre- | Post- | inhibition | | | after 3 spins |
| | | SAUR(8 mm), | incubation | incubation | Neat | 30 | mm | and 1:16 |
| | | ECOL (7 mm), | 1 Spin + | 1 Spin + | 1:2 | 26 | mm | dilution |
| | | PROV (30 mm), | Pre- | Post- | 1:4 | 21 | mm | |
| | | PRMI (30 mm) | incubation | incubation | 1:8 | 15 | mm | |
| | | | 2 Spin + | 2 Spin + | 1:16 | 6 | mm | |
| | | | Pre- | Post- | 1:32 | 0 | mm | |
| | | | incubation | incubation | 1:64 | 0 | mm | |
| | | | Plate Images: See FIG. 48D | | Plate Images: See FIG. 48H | | | |
| BAN_2210 | MALDI | Self-inhibition | Control + | Control + | Self- | 0 | mm | No inhibition |
| | could | (0 mm), | Pre- | Post- | inhibition | | | present in |
| | not | SAUR(0 mm), | incubation | incubation | Neat | 0 | mm | sample |
| | identify | ECOL (0 mm), | 1 Spin + | 1 Spin + | 1:2 | 0 | mm | |
| | (gram | PROV (0 mm), | Pre- | Post- | 1:4 | 0 | mm | |
| | stain | PRMI (0 mm) | incubation | incubation | 1:8 | 0 | mm | |
| | showed | | 2 Spin + | 2 Spin + | 1:16 | 0 | mm | |
| | gram | | Pre- | Post- | 1:32 | 0 | mm | |
| | negative | | | | 1:64 | 0 | mm | |
| | cocci) | | Plate Images: See FIG. 49A | | Plate Images: See FIG. 49E | | | |
| BAN_2214 | KLPN | Self-inhibition | Control + | Control + | Self- | 22 | mm | No inhibition |
| | | (22 mm), | Pre- | Post- | inhibition | | | after 3 spins |
| | | SAUR(0 mm), | incubation | incubation | Neat | 25 | mm | and 1:8 |
| | | ECOL (25 mm), | 1 Spin + | 1 Spin + | 1:2 | 16 | mm | dilution |
| | | PROV (24 mm), | Pre- | Post- | 1:4 | 12 | mm | |
| | | PRMI (20 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 49B | | Plate Images: See FIG. 49F | | | |
| BAN_2215 | SAUR | Self-inhibition | Control + | Control + | Self- | 0 | mm | No inhibition |
| | | (0 mm), | Pre- | Post- | inhibition | | | present in |
| | | SAUR(0 mm), | incubation | incubation | Neat | 0 | mm | sample |
| | | ECOL (0 mm), | 1 Spin + | 1 Spin + | 1:2 | 0 | mm | |
| | | PROV (0 mm), | Pre- | Post- | 1:4 | 0 | mm | |
| | | PRMI (0 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 49C | | Plate Images: See FIG. 49G | | | |
| BAN_2221 | ABAU | Self-inhibition | Control + | Control + | Self- | 0 | mm | No inhibition |
| | | (0 mm), | Pre- | Post- | inhibition | | | present in |
| | | SAUR(0 mm), | incubation | incubation | Neat | 0 | mm | sample |
| | | ECOL (0 mm), | 1 Spin + | 1 Spin + | 1:2 | 0 | mm | |
| | | PROV (0 mm), | Pre- | Post- | 1:4 | 0 | mm | |
| | | PRMI (0 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 49D | | Plate Images: See FIG. 49H | | | |
| BAN_2222 | PSAR | Self-inhibition | Control + | Control + | Self- | 0 | mm | No inhibition |
| | | (0 mm), | Pre- | Post- | inhibition | | | after 1:8 |
| | | SAUR(18 mm), | incubation | incubation | Neat | 19 | mm | dilution |
| | | ECOL (0 mm), | 1 Spin + | 1 Spin + | 1:2 | 13 | mm | |
| | | PROV (0 mm), | Pre- | Post- | 1:4 | 9 | mm | |
| | | PRMI (0 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 50A | | Plate Images: See FIG. 50E | | | |
| BAN_2224 | PSAR | Self-inhibition | Control + | Control + | Self- | 18 | mm | No inhibition |
| | | (0 mm), | Pre- | Post- | inhibition | | | after 1:4 |
| | | SAUR(18 mm), | incubation | incubation | Neat | 9 | mm | dilution |
| | | ECOL (15 mm), | 1 Spin + | 1 Spin + | 1:2 | 0 | mm | |
| | | PROV (6 mm), | Pre- | Post- | 1:4 | 0 | mm | |
| | | PRMI (0 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 50B | | Plate Images: See FIG. 50F | | | |
| BAN_2225 | ECOL | Self-inhibition | Control + | Control + | Self- | 0 | mm | No inhibition |
| | | (0 mm), | Pre- | Post- | inhibition | | | present in |
| | | SAUR(0 mm), | incubation | incubation | Neat | 0 | mm | sample |
| | | ECOL (0 mm), | 1 Spin + | 1 Spin + | 1:2 | 0 | mm | |
| | | PROV (0 mm), | Pre- | Post- | 1:4 | 0 | mm | |
| | | PRMI (0 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 50C | | Plate Images: See FIG. 50G | | | |
| BAN_2227 | KLPN | Self-inhibition | Control + | Control + | Self- | 0 | mm | No inhibition |
| | | (0 mm), | Pre- | Post- | inhibition | | | after 3 spins |
| | | SAUR(10 mm), | incubation | incubation | Neat | 32 | mm | and 1:8 |
| | | ECOL (10 mm), | 1 Spin + | 1 Spin + | 1:2 | 29 | mm | dilution |
| | | PROV (30 mm), | Pre- | Post- | 1:4 | 25 | mm | |
| | | PRMI (30 mm) | incubation | incubation | 1:8 | 20 | mm | |
| | | | 2 Spin + | 2 Spin + | 1:16 | 10 | mm | |
| | | | Pre- | Post- | 1:32 | 0 | mm | |
| | | | incubation | incubation | 1:64 | 0 | mm | |
| | | | Plate Images: See FIG. 50D | | Plate Images: See FIG. 50H | | | |
| BAN_2228 | SAUR | Self-inhibition | Control + | Control + | Self- | 0 | mm | No inhibition |
| | | (0 mm), | Pre- | Post- | inhibition | | | present in |
| | | SAUR(0 mm), | incubation | incubation | Neat | 0 | mm | sample |
| | | ECOL (0 mm), | 1 Spin + | 1 Spin + | 1:2 | 0 | mm | |
| | | PROV (0 mm), | Pre- | Post- | 1:4 | 0 | mm | |
| | | PRMI (0 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 51A | | Plate Images: See FIG. 51E | | | |
| BAN_2237 | PSAR | Self-inhibition | Control + | Control + | Self- | 0 | mm | No inhibition |
| | | (0 mm), | Pre- | Post- | inhibition | | | after 1:8 |
| | | SAUR(0 mm), | incubation | incubation | Neat | 25 | mm | dilution |
| | | ECOL (0 mm), | 1 Spin + | 1 Spin + | 1:2 | 20 | mm | |
| | | PROV (26 mm), | Pre- | Post- | 1:4 | 16 | mm | |
| | | PRMI (30 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 51B | | Plate Images: See FIG. 51F | | | |
| BAN_2238 | SAUR | Self-inhibition | Control + | Control + | Self- | 0 | mm | No inhibition |
| | | (0 mm), | Pre- | Post- | inhibition | | | present in |
| | | SAUR(0 mm), | incubation | incubation | Neat | 0 | mm | sample |
| | | ECOL (0 mm), | 1 Spin + | 1 Spin + | 1:2 | 0 | mm | |
| | | PROV (0 mm), | Pre- | Post- | 1:4 | 0 | mm | |
| | | PRMI (0 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 51C | | Plate Images: See FIG. 51G | | | |
| BAN_2239 | MALDI | Self-inhibition | Control + | Control + | Self- | 0 | mm | No inhibition |
| | could | (0 mm), | Pre- | Post- | inhibition | | | after 1:16 |
| | not | SAUR(22 mm), | incubation | incubation | Neat | 22 | mm | dilution |
| | identify | ECOL (25 mm), | 1 Spin + | 1 Spin + | 1:2 | 19 | mm | |
| | (gram | PROV (22 mm), | Pre- | Post- | 1:4 | 10 | mm | |
| | stain | PRMI (16 mm) | incubation | incubation | 1:8 | 7 | mm | |
| | showed | | 2 Spin + | 2 Spin + | 1:16 | 0 | mm | |
| | yeast) | | Pre- | Post- | 1:32 | 0 | mm | |
| | | | incubation | incubation | 1:64 | 0 | mm | |
| | | | Plate Images: See FIG. 51D | | Plate Images: See FIG. 51H | | | |
| BAN_2242 | PSAR | Self-inhibition | Control + | Control + | Self- | 0 | mm | No inhibition |
| | | (0 mm), | Pre- | Post- | inhibition | | | after 1:4 |
| | | SAUR(0 mm), | incubation | incubation | Neat | 16 | mm | dilution |
| | | ECOL (0 mm), | 1 Spin + | 1 Spin + | 1:2 | 7 | mm | |
| | | PROV (11 mm), | Pre- | Post- | 1:4 | 0 | mm | |
| | | PRMI (14 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 52A | | Plate Images: See FIG. 52D | | | |
| BAN_2244 | ENTC | Self-inhibition | Control + | Control + | Self- | 0 | mm | No inhibition |
| | | (0 mm), | Pre- | Post- | inhibition | | | present in |
| | | SAUR(0 mm), | incubation | incubation | Neat | 0 | mm | sample |
| | | ECOL (0 mm), | 1 Spin + | 1 Spin + | 1:2 | 0 | mm | |
| | | PROV (0 mm), | Pre- | Post- | 1:4 | 0 | mm | |
| | | PRMI (0 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |
| | | | Plate Images: See FIG. 52B | | Plate Images: See FIG. 52E | | | |
| BAN_2252 | HINF | Self-inhibition | Control + | Control + | Self- | 0 | mm | No inhibition |
| | | (0 mm), | Pre- | Post- | inhibition | | | after 1:4 |
| | | SAUR(0 mm), | incubation | incubation | Neat | 14 | mm | dilution |
| | | ECOL (0 mm), | 1 Spin + | 1 Spin + | 1:2 | 0 | mm | |
| | | PROV (0 mm), | Pre- | Post- | 1:4 | 0 | mm | |
| | | PRMI (0 mm) | incubation | incubation | 1:8 | 0 | mm | |
| | | | 2 Spin + | 2 Spin + | 1:16 | 0 | mm | |
| | | | Pre- | Post- | 1:32 | 0 | mm | |
| | | | incubation | incubation | 1:64 | 0 | mm | |

| | |
|---|---|
| Plate Images: See FIG. 52C | Plate Images: See FIG. 52F |

The plates for BAN_2159 indicate that there was bacterial growth in the preincubation control, while the post-incubation control showed no microorganisms present, due to inhibition that had not been removed from the specimen; after one spin and resuspension, the pre-incubation plate showed bacterial growth present in the specimen, while the post-incubation plate showed minimal growth, indicating that some of the inhibition present in the sample had been removed; after two spins and resuspension, the pre-incubation plate showed bacterial growth in the specimen, while the post-incubation plate showed a large increase in bacterial growth due to removal inhibition present in the sample. (The term “spin” refers to a cycle of centrifugation using as system as described herein.)

In the case of BAN_2161 (FIG. 47B), there was bacterial growth in the pre- and post-incubation controls, after 1-spin (pre- and post-incubation) and after 2-spins (pre- and post-incubation), indicating that there was no inhibition.

In the case of BAN-2167 (FIG. 47C), little bacterial growth was seen in the pre-incubation control, and none was seen in the post-incubation control. After 1-spin, very little bacterial growth was seen in the pre- and pre-incubation plates. After 2-spins, there was very little bacterial growth in the pre-incubation plate, but there is a bacterial growth in the post-incubation plate. Thus, there was no inhibition after 2 spins.

In the case of BAN-2169 (FIG. 47D), little bacterial growth was seen in the pre-incubation control, and none was seen in the post-incubation control. After 1-spin or 2-spins, very little bacterial growth was seen in the pre-incubation plate but there is a large increase in bacterial growth in the post-incubation plate. Thus, there was no inhibition after 1 spin.

In the case of BAN_2182 (FIG. 48A), there was bacterial growth in the pre- and post-incubation controls, after 1-spin (pre- and post-incubation) and after 2-spins (pre- and post-incubation), thus indicating that there was no inhibition.

In the case of BAN_2195 (FIG. 48B), there was there was bacterial growth in the pre-incubation control and greater bacterial growth in the post-incubation control; after 1-spin or 2-spins, the pre- and post-incubation plates showed a great increase in bacterial growth. Thus,

In the case of BAN_2207 (FIG. 48C), no bacterial growth was seen in the pre-incubation control, and some was seen in the post-incubation control. After 1-spin or 2-spins, some bacterial growth was seen in the pre- and pre-incubation plates. No inhibition was seen in the sample.

In the case of BAN_2208 (FIG. 48D), there was only enough supernatant to plate after 3 spins. The pre-incubation plate showed no bacterial growth, while the post-incubation plate showed a large increase in bacterial growth. Thus, there was no inhibition after 3 spins.

In the case of BAN_2210 (FIG. 49A), there was bacterial growth in the pre- and post-incubation controls, after 1 spin (pre- and post-incubation) and after 3 spins (pre- and post-incubation), indicating that there was no inhibition.

In the case of BAN_2214 (FIG. 49B), only a small amount of bacterial growth was seen in the pre- and post-incubation controls and in the pre-incubation plate after 1 spin or 3 spins; a greater degree of bacterial growth was seen in the post-incubation plate after 1 spin. After 3 spins, there was a large amount of bacterial growth was seen in the post-incubation plate. Thus, inhibition was removed by 3 spins.

In the case of BAN_2215 (FIG. 49C), only slight bacterial growth was seen in the pre-incubation control and in the 1 spin and 3-spin pre-incubation plates. A slightly larger degree of growth was seen in the post-incubation control and in the 1 spin post-incubation plate. A large amount of bacterial growth was seen in the 3 spin post-incubation plate. Thus, inhibition was removed by 3 spins.

In the case of BAN_2221 (FIG. 49D), a slight degree of bacterial growth was seen in the pre-incubation control and in the pre-incubation 1 spin and 3 spin plates. Greater bacterial growth in the post-incubation control, pre-incubation 1 spin and 3 spin plates indicates no inhibition in the sample.

In the case of BAN_2222 (FIG. 50A), some bacterial growth was seen in the pre-incubation control and in the pre-incubation 1 spin and 3 spin plates. Greater bacterial growth in the post-incubation control, pre-incubation 1 spin and 3 spin plates indicates no inhibition in the sample.

In the case of BAN_2224 (FIG. 50B), some bacterial growth was seen in the pre-incubation control and in the pre-incubation 1 spin and 3 spin plates. Greater bacterial growth in the post-incubation control, pre-incubation 1 spin and 3 spin plates indicates no inhibition in the sample.

In the case of BAN_2225 (FIG. 50C), no bacterial growth was seen in the pre-incubation control and in the pre-incubation 1 spin plate; and very little bacterial growth was seen in the 3 spin plate. Greater bacterial growth in the post-incubation control, pre-incubation 1 spin and 3 spin plates indicates no inhibition in the sample.

In the case of BAN_2227 (FIG. 50D), there was only enough supernatant to plate after 3 spins. The pre-incubation plate showed no bacterial growth, while the post-incubation plate showed a large increase in bacterial growth. Thus, there was no inhibition after 3 spins.

In the case of BAN_2228 (FIG. 51A), there was bacterial growth in the pre- and post-incubation controls, after 1 spin (pre- and post-incubation) and after 3 spins (pre- and post-incubation), indicating that there was no inhibition.

In the case of BAN_2227 (FIG. 51B), there was bacterial growth in the pre- and post-incubation controls, after 1 spin (pre- and post-incubation) and after 3 spins (pre- and post-incubation), indicating that there was no inhibition.

In the case of BAN_2238 (FIG. 51C), there was some bacterial growth in the pre- and post-incubation controls, after 1 spin (pre- and post-incubation) and after 3 spins (pre- and post-incubation), indicating that there was no inhibition.

In the case of BAN_2239 (FIG. 51D), there was no bacterial growth in the pre- and post-incubation controls, after 1 spin (pre- and post-incubation) and after 3 spins (pre- and post-incubation), indicating that three spins was not sufficient to remove inhibition.

In the case of BAN_2242 (FIG. 52A), some bacterial growth was seen in the pre-incubation control and in the pre-incubation 1 spin and 3 spin plates. Greater bacterial growth in the post-incubation control, pre-incubation 1 spin and 3 spin plates indicates no inhibition in the sample.

In the case of BAN_2244 (FIG. 52B), no bacterial growth was seen in the pre-incubation control and in the pre-incubation 1 spin and 3 spin plates. Greater bacterial growth in the post-incubation control, pre-incubation 1 spin and 3 spin plates indicates no inhibition in the sample

In the case of BAN_2252 (FIG. 52C), some bacterial growth was seen in the pre-incubation control and in the pre-incubation 1 spin and 3 spin plates. Greater bacterial growth in the post-incubation control, pre-incubation 1 spin and 3 spin plates indicates no inhibition in the sample.

All samples containing inhibiting substances had the inhibition removed in all cases at either the third spin or the 1:32 dilution, indicating the assay must include at least three spins or have a cleanup that equates to a 1:32 dilution of inhibitory material present in the specimen

The results in Table 11 show the inhibition results for negative specimens.

TABLE 11
Negative Specimen Inhibition Screening Results.

| | 24 hr | | | | | | | | | |
|---|---|---|---|---|---|---|---|---|---|---|
| | Screening | | ECOL | | SAUR | | PRMI | | PROV | |
| Sample # | Result | pH | Inhibition | | Inhibition | | Inhibition | | Inhibition | |
| BAN_2481 | Normal Flora | 6.8 | 25 | mm | 0 | mm | 34 | mm | 29 | mm |
| BAN_2447 | Normal Flora | 4.8 | 0 | mm | 0 | mm | 0 | mm | 4 | mm |
| BAN_2522 | Normal Flora | 5.3 | 19 | mm | 0 | mm | 0 | mm | 20 | mm |
| BAN_2513 | Normal Flora | 6.6 | 25 | mm | 9 | mm | 24 | mm | 24 | mm |
| BAN_2511 | Normal Flora | 6.9 | 30 | mm | 24 | mm | 28 | mm | 30 | mm |
| BAN_2486 | No Growth | 4.7 | 30 | mm | 11 | mm | 28 | mm | 26 | mm |
| BAN_2487 | No Growth | 7 | 19 | mm | 0 | mm | 27 | mm | 30 | mm |
| BAN_2488 | No Growth | 4.7 | 0 | mm | 0 | mm | 0 | mm | 0 | mm |
| BAN_2489 | No Growth | 5 | 0 | mm | 0 | mm | 0 | mm | 0 | mm |
| BAN_2482 | No Growth | 4.9 | 0 | mm | 0 | mm | 0 | mm | 0 | mm |
| BAN_2492 | No Growth | 7.6 | 7 | mm | 18 | mm | 0 | mm | 0 | mm |
| BAN_2494 | No Growth | 8 | 0 | mm | 0 | mm | 0 | mm | 0 | mm |
| BAN_2496 | No Growth | 5 | 10 | mm | 0 | mm | 0 | mm | 8 | mm |
| BAN_2484 | No Growth | 6.8 | 6 | mm | 0 | mm | 0 | mm | 6 | mm |
| BAN_2485 | No Growth | 5 | 16 | mm | 0 | mm | 17 | mm | 11 | mm |
| BAN_2490 | No Growth | 6.4 | 0 | mm | 0 | mm | 15 | mm | 0 | mm |
| BAN_2491 | No Growth | 6.4 | 27 | mm | 0 | mm | 22 | mm | 26 | mm |
| MDF_24 | Normal Flora | 6.4 | 26 | mm | 0 | mm | 34 | mm | 29 | mm |
| MDF_25 | No Growth | 6 | 36 | mm | 36 | mm | 36 | mm | 40 | mm |
| MDF_26 | No Growth | 6.4 | 0 | mm | 0 | mm | 0 | mm | 0 | mm |

Out of 20 specimens screened, 15 showed inhibition to at least one organism tested, which is a 75% rate of inhibition. Negative specimens therefore show more inhibition than positive specimens. Given that one of the main purposes of the automated sample preparation module is to significantly reduce if not completely remove inhibition from fresh specimens, a study looking into both a rinse and wash method was completed.

The rinse and wash approaches both show similar performance in removal of inhibition as shown in the table below in exception to one specimen that had slight inhibition even after a rinse.

TABLE 12
Fresh Positive Inhibition Results with Rinse and Wash Approaches

| | Wash | Super- | Super- | | Super- | | Super- | | Super- | | Resus- | |
|---|---|---|---|---|---|---|---|---|---|---|---|---|
| Sample # | Method | natant 1 | natant 2 | | natant 3 | | natant 4 | | natant 5 | | pension | |
| PITT_234 lawned | Manual | 48 mm | 37 | mm | 32 | mm | 26 | mm | 20 | mm | 27 | mm |
| with | Rinse | | | | | | | | | | | |
| PRMI_IHMA_827374 | Manual | 48 mm | 36 | mm | 21 | mm | 0 | mm | 0 | mm | 0 | mm |
| | Wash | | | | | | | | | | | |
| | Auto prep | 46 mm | 37 | mm | 26 | mm | 0 | mm | 0 | mm | 0 | mm |
| | Rinse | | | | | | | | | | | |
| | Auto Prep | 47 mm | 37 | mm | 20 | mm | 0 | mm | 0 | mm | 0 | mm |
| | Wash | | | | | | | | | | | |
| BAN_2897 lawned | Manual | 44 mm | 28 | mm | 0 | mm | 0 | mm | 0 | mm | 0 | mm |
| with | Rinse | | | | | | | | | | | |
| PRMI_IHMA_827374 | Manual | 42 mm | 30 | mm | 0 | mm | 0 | mm | 0 | mm | 0 | mm |
| | Wash | | | | | | | | | | | |
| | Auto Prep | 35 mm | 32 | mm | 0 | mm | 0 | mm | 0 | mm | 0 | mm |
| | Rinse | | | | | | | | | | | |
| | Auto Prep | 39 mm | 30 | mm | 0 | mm | 0 | mm | 0 | mm | 0 | mm |
| | Wash | | | | | | | | | | | |
| MDF_106 lawned | Manual | 18 mm | 0 | mm | 0 | mm | 0 | mm | 0 | mm | 0 | mm |
| with | Rinse | | | | | | | | | | | |
| SAUR_ATCC_29213 | Manual | 18 mm | 0 | mm | 0 | mm | 0 | mm | 0 | mm | 0 | mm |
| | Wash | | | | | | | | | | | |
| | Auto Prep | 18 mm | 0 | mm | 0 | mm | 0 | mm | 0 | mm | 0 | mm |
| | Rinse | | | | | | | | | | | |
| | Auto Prep | 18 mm | 0 | mm | 0 | mm | 0 | mm | 0 | mm | 0 | mm |
| | Wash | | | | | | | | | | | |
| BAN_2646 lawned | Manual | 29 mm | 0 | mm | 0 | mm | 0 | mm | 0 | mm | 0 | mm |
| with | Rinse | | | | | | | | | | | |
| ECOL_ATCC_25922 | Manual | 29 mm | 14 | mm | 0 | mm | 0 | mm | 0 | mm | 0 | mm |
| | Wash | | | | | | | | | | | |
| | Auto Prep | 29 mm | 0 | mm | 0 | mm | 0 | mm | 0 | mm | 0 | mm |
| | Rinse | | | | | | | | | | | |
| | Auto Prep | 29 mm | 0 | mm | 0 | mm | 0 | mm | 0 | mm | 0 | mm |
| | Wash | | | | | | | | | | | |
| PITT_282 lawned | Manual | 34 mm | 18 | mm | 0 | mm | 0 | mm | 0 | mm | 29 | mm |
| with | Rinse | | | | | | | | | | | |
| ECOL_ATCC_25922 | Manual | 36 mm | 29 | mm | 22 | mm | 12 | mm | 0 | mm | 6 | mm |
| | Wash | | | | | | | | | | | |
| | Auto Prep | 34 mm | 24 | mm | 20 | mm | 13 | mm | 6 | mm | 6 | mm |
| | Rinse | | | | | | | | | | | |
| | Auto Prep | 32 mm | 28 | mm | 17 | mm | 0 | mm | 0 | mm | 0 | mm |
| | Wash | | | | | | | | | | | |

The rinse showed the same performance as the wash strategy for all but one of the fresh specimens, PITT_282. While the wash approach fully removed inhibition and the rinse did not, the automated sample preparation instrument system performed better than the manual preparation method.

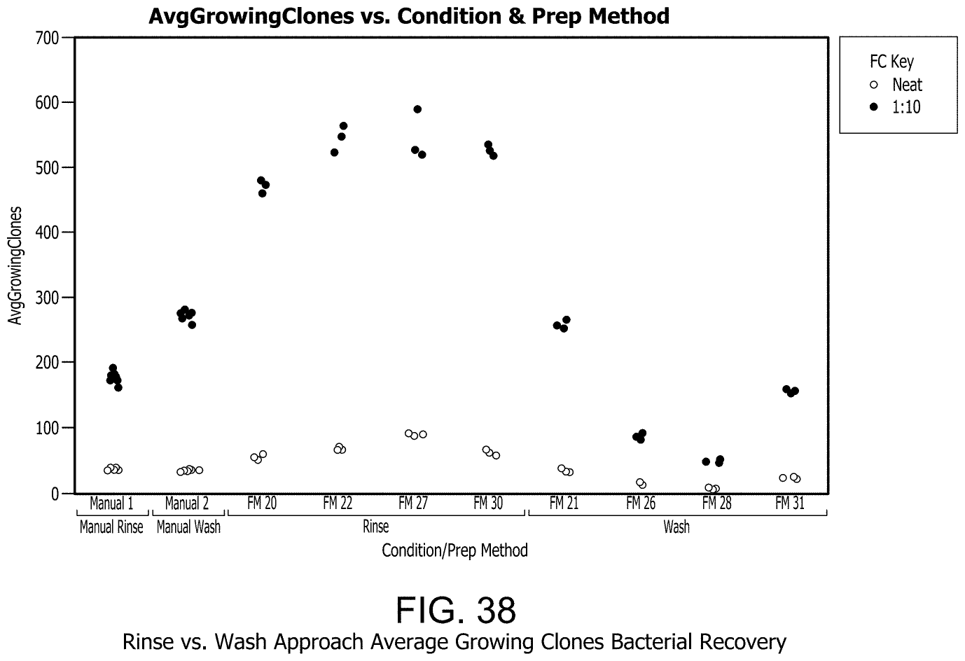

FIG. 38 shows the number of average growing clones using manual rinse, manual wash, FM rinse, and FM wash preparation methods at neat and 1:10 dilution concentrations. Thus, the image in FIG. 38 shows the difference in recovery of bacteria using a rinse and wash approach. The rinse approach has many more recovered bacterial counts than the wash.

Conclusion

Fresh specimens, both positive and negative, contain interfering substances that need to be removed prior to identification and antibiotic susceptibility testing. Out of 23 positive specimens tested, 14 showed inhibition, which is a 65% rate of inhibition in positive specimens. Out of 20 negative specimens tested, 15 showed inhibition, which is a 75% rate of inhibition in negative specimens. Given that the majority of specimens will have some level of inhibitory substances, the exemplary sample preparation assay was designed to remove the majority if not all interfering substances in a specimen. Despite the rinse approach not cleaning inhibition quite as efficiently, the bacterial count recovery is substantially superior using this approach, thereby providing more growing clones to a downstream sample testing platform. Thus, it was selected as the approach for cleanup in implementations of the automated sample preparation system. Further testing in a verification study will prove that the rinse approach removes enough inhibition in positive specimens to produce an identification and antibiotic susceptibility response that is not hindered by inhibition innate to the specimen.

Experimental Design #7: Sample Processing Automation Consistency Using Internal Standard Beads

An internal standard which can track complete cell loss in the automated sample preparation system is necessary to determine whether preparation of a sample fails, and therefore would result in no microorganisms (such as bacteria or fungi) being delivered to a downstream sample assay instrument. In each automated sample preparation run undertaken, a RAM pellet former with 4 μm beads is added at the start of the run and is mixed with the sample. The beads serve as an internal control that are retained during preparation and a threshold can be set within the exemplary automated sample preparation assay which will fail a run if no beads are present in the loaded specimen.

Methods

All samples were run across a single spin and resuspension assay on automated sample preparation instrument FM modules with a manual control. The 4 μm beads were spiked into 1 mM L-Histidine at the same concentration as used in conjunction with the RAM in previous tests. In these runs, no RAM was added in the first step.

Each automated sample preparation system run contains beads, and therefore can be analyzed for any run that is loaded onto a downstream sample analysis platform. The second experiment shows bead count as well as growing clone reproducibility across automated sample preparation FM modules. These experiments utilized a sample containing either ECOL_ATCC_25922 or SAUR_ATCC_29213 spiked at 1×10⁵ cfu/mL into 4× RAM and ran through the full five spin automated sample preparation procedure. Bead counts in this experiment were from 1:10 dilution channels within a growth assay (Growth Only Assay5).

Summary of Data and Results

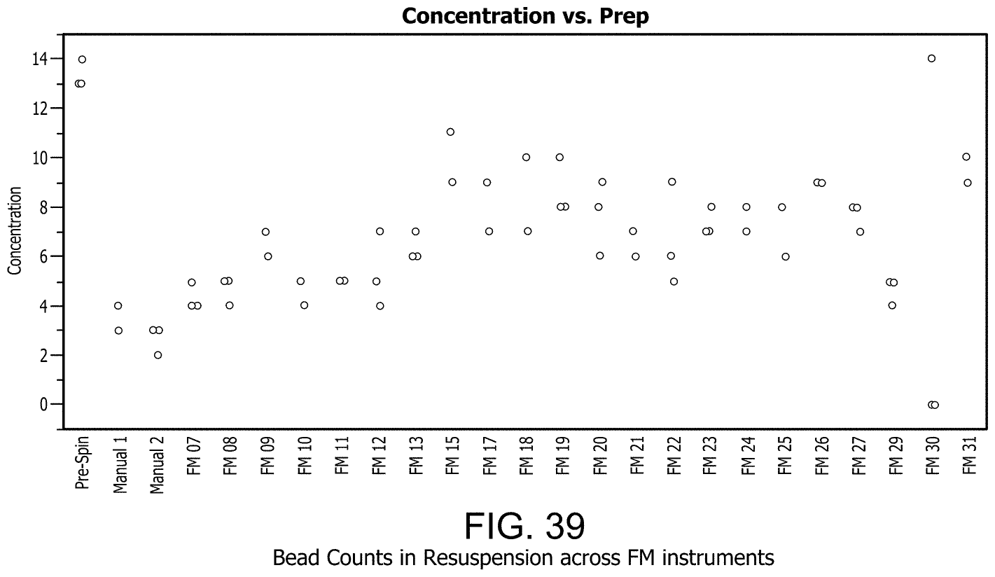

The plot in FIG. 39 shows bead counts present in the resuspension after the exemplary assay performed in the automated sample preparation system pre-spin, using manual preparation, and FM preparation methods. Bead concentrations across FM instruments in the 1:10 dilution channels are overall low and matched or better than manual preparation experiments, as depicted in FIG. 39.

Conclusions

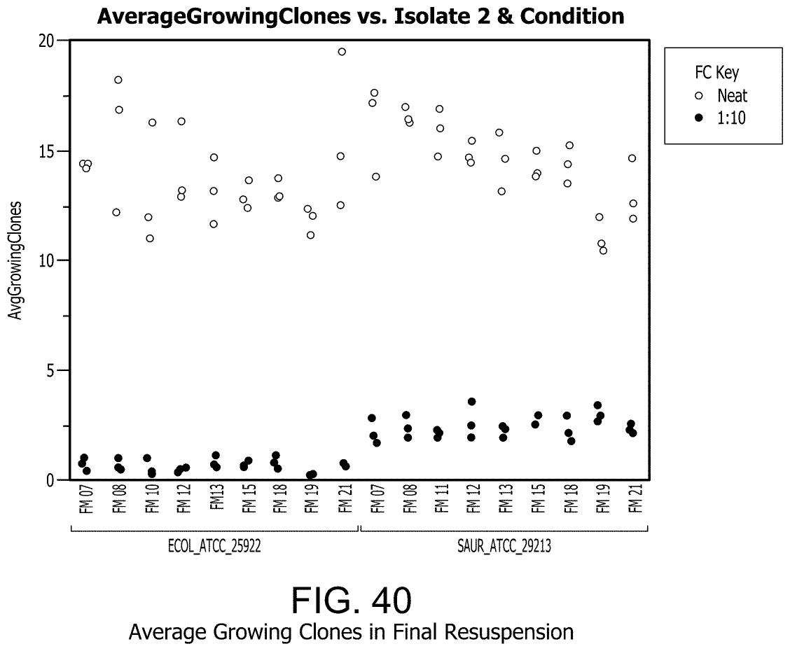

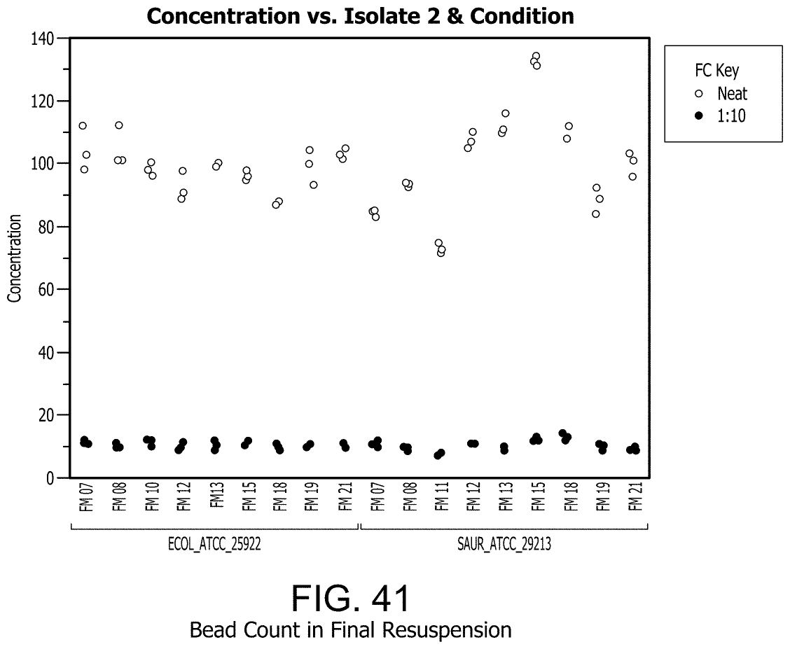

Bead counts coming out of the automated sample preparation system module produce trends that correlate with average growing clones' performance in commercially available ID/AST assay systems, as depicted in FIGS. 40 and 41. FIG. 40 shows the average growing clones at neat and 1:10 dilution concentrations in various FM instruments for ECOL_ATCC_25922 and SAUR_ATCC_29213. FIG. 41 shows the bead count (concentration) at neat and 1:10 dilution concentrations in various FM preparation runs for ECOL_ATCC_25922 and SAUR_ATCC_29213. This indicates that the beads serve as an internal control that will indicate a total failure within a given sample preparation process. Additionally, these experiments show similar performance across various prototype automated sample preparation FM instruments.

Experimental Design #8: Instrument Biosafety

Respiratory specimens, which can contain BSL 2 and BSL 3 organisms, must be properly handled to avoid aerosolization risk to the laboratory technician processing the specimen. In many laboratories all respiratory specimens are processed within a biosafety cabinet, however with the automated sample preparation system module, a HEPA filter is installed which allows for air filtration during normal centrifugation steps. This prevents risk to the user of the module as well as provides a sample preparation system that does not require the need for the sample processing to occur within a biosafety cabinet.

Methods

Testing occurred using the Azbil BioVigilant IMD-A®-350 system which is able to measure particles≥0.5 microns. The BioVigilant system is able to detect both biologic and non-biologic particles. A series of tests were completed with both yellow 1.3 μm beads at 1×10⁸/mL as well as Lactococcus lactis ATCC-11454 at 1×10⁸ cfu/mL. The testing parameters were the following:
Removal of aerosols using HEPA filter while pelleting
Delay needed before opening chamber post pelleting
Aerosol generation by capping/uncapping
Aerosol generation by pipetting and resuspending
Positive (beads and bacteria) and negative (water) controls each day of testing

Results

The following tables show the tests completed targeting each step of the exemplary assay and the associated aerosol risk for each.

TABLE 13
Removal of Aerosols using HEPA filter while pelleting

| | | | HEPA | | | | | |
|---|---|---|---|---|---|---|---|---|
| | | | filter | Average IMD-A | | | IMD-A | |
| Sample | | | in | Counts/min | | | Probe | |
| ID | Day | Test | place? | ≥0.5 μm | Bio | ≥5 μm | Location | Notes |
| 75 | 1 | Water on | Yes | 2 | 2 | 0 | Exhaust | Counts from |
| | | outside | | | | | line | contaminated |
| | | of | | | | | | pump and |
| | | capsule | | | | | | tubing |
| 74 | 1 | Beads on | Yes | 2 | 2 | 0 | Exhaust | Counts from |
| | | outside | | | | | line | contaminated |
| | | of | | | | | | pump and |
| | | capsule | | | | | | tubing |
| 78 | 1 | Beads on | Yes | 1 | 1 | 0 | Exhaust | Counts from |
| | | outside | | | | | line | contaminated |
| | | of | | | | | | pump and |
| | | capsule | | | | | | tubing |
| 76 | 1 | Bacteria | Yes | 1 | 1 | 0 | Exhaust | Counts from |
| | | on | | | | | line | contaminated |
| | | outside | | | | | | pump and |
| | | of | | | | | | tubing |
| | | capsule | | | | | | |
| 83 | 1 | Water on | No | 157069 | 116362 | 490 | Exhaust | |
| | | outside | | | | | line, | |
| | | of | | | | | HEPA | |
| | | capsule- | | | | | bypassed | |
| | | No | | | | | | |
| | | HEPA | | | | | | |
| | | filter | | | | | | |
| 85 | 1 | Beads on | No | 132317 | 100128 | 4 | Exhaust | |
| | | outside | | | | | line, | |
| | | of | | | | | HEPA | |
| | | capsule- | | | | | bypassed | |
| | | No | | | | | | |
| | | HEPA | | | | | | |
| | | filter | | | | | | |
| 86 | 1 | Bacteria | No | 156525 | 116635 | 1 | Exhaust | |
| | | on | | | | | line, | |
| | | outside | | | | | HEPA | |
| | | of | | | | | bypassed | |
| | | capsule- | | | | | | |
| | | No | | | | | | |
| | | HEPA | | | | | | |
| | | filter | | | | | | |
| 119 | 2 | Water on | Yes- | 2 | 0 | 0 | Exhaust | |
| | | outside | New | | | | line | |
| | | of | | | | | | |
| | | capsule | | | | | | |
| 120 | 2 | Beads on | Yes- | 0 | 0 | 0 | Exhaust | |
| | | outside | New | | | | line | |
| | | of | | | | | | |
| | | capsule | | | | | | |
| 121 | 2 | Bacteria | Yes- | 0 | 0 | 0 | Exhaust | |
| | | on | New | | | | line | |
| | | outside | | | | | | |
| | | of | | | | | | |
| | | capsule | | | | | | |

TABLE 14
Delay needed before opening the chamber post pelleting

| | | | | | | | | | IMD-A 350 after chamber | | | |
|---|---|---|---|---|---|---|---|---|---|---|---|---|
| | | | | | Average IMD-A 350 | | | | opens | | | |
| Sample | | | Delay | | Counts/min | | | Probe | | | | % |
| ID | Day | Test | Time | | ≥0.5 μm | Bio | ≥5 μm | Location | ≥0.5 μm | Bio | ≥5 μm | Bio |
| 90 | 1 | Beads on | 5 | min | 143296 | 4211 | 39 | Parting | 1 | 0 | 0 | 0% |
| | | outside | | | | | | line | | | | |
| | | of | | | | | | between | | | | |
| | | capsule | | | | | | lid and | | | | |
| | | | | | | | | chamber | | | | |
| 91/92 | 1 | Bacteria | 5 | min | 56225 | 1542 | 14 | Parting | 0 | 0 | 0 | 0% |
| | | on | | | | | | line | | | | |
| | | outside | | | | | | between | | | | |
| | | of | | | | | | lid and | | | | |
| | | capsule | | | | | | chamber | | | | |
| 93 | 1 | Beads on | 1 | min | 19623 | 576 | 5 | Parting | 1 | 0 | 0 | 0% |
| | | outside | | | | | | line | | | | |
| | | of | | | | | | between | | | | |
| | | capsule | | | | | | lid and | | | | |
| | | | | | | | | chamber | | | | |
| 94 | 1 | Bacteria | 1 | min | 13984 | 166 | 1 | Parting | 3 | 1 | 0 | 33% |
| | | on | | | | | | line | | | | |
| | | outside | | | | | | between | | | | |
| | | of | | | | | | lid and | | | | |
| | | capsule | | | | | | chamber | | | | |
| 110 | 2 | Beads on | 30 | sec | 1422 | 36 | 0 | Parting | 1 | 0 | 0 | 0% |
| | | outside | | | | | | line | | | | |
| | | of | | | | | | between | | | | |
| | | capsule | | | | | | lid and | | | | |
| | | | | | | | | chamber | | | | |
| 111 | 2 | Beads on | 30 | sec | 1716 | 22 | 0 | Parting | 1 | 0 | 0 | 0% |
| | | outside | | | | | | line | | | | |
| | | of | | | | | | between | | | | |
| | | capsule | | | | | | lid and | | | | |
| | | | | | | | | chamber | | | | |
| 112 | 2 | Bacteria | 30 | sec | 3162 | 46 | 0 | Parting | 1 | 0 | 0 | 0% |
| | | on | | | | | | line | | | | |
| | | outside | | | | | | between | | | | |
| | | of | | | | | | lid and | | | | |
| | | capsule | | | | | | chamber | | | | |
| 105 | 2 | Beads on | 10 | sec | 30524 | 1700 | 60 | Parting | 15 | 9 | 0 | 60% |
| | | outside | | | | | | line | | | | |
| | | of | | | | | | between | | | | |
| | | capsule | | | | | | lid and | | | | |
| | | | | | | | | chamber | | | | |
| 107 | 2 | Beads on | 10 | sec | 1905 | 69 | 1 | Parting | 12 | 8 | 0 | 67% |
| | | outside | | | | | | line | | | | |
| | | of | | | | | | between | | | | |
| | | capsule | | | | | | lid and | | | | |
| | | | | | | | | chamber | | | | |
| 109 | 2 | Bacteria | 10 | sec | 9990 | 136 | 1 | Parting | 8 | 7 | 0 | 88% |
| | | on | | | | | | line | | | | |
| | | outside | | | | | | between | | | | |
| | | of | | | | | | lid and | | | | |
| | | capsule | | | | | | chamber | | | | |

TABLE 15
Aerosol Generation by Capping/Uncapping

| | | | Average IMD-A 350 | | | |
|---|---|---|---|---|---|---|
| Sample | | | Counts/min | | | Probe |
| ID | Day | Test | ≥0.5 μm | Bio | ≥5 μm | Location |
| 115 | 2 | Water | 0 | 0 | 0 | Capsule in |
| | | inside | | | | cap/uncap |
| | | capsule | | | | position |
| 116 | 2 | Beads | 0 | 0 | 0 | Capsule in |
| | | inside | | | | cap/uncap |
| | | capsule | | | | position |
| 117 | 2 | Bacteria | 0 | 0 | 0 | Capsule in |
| | | inside | | | | cap/uncap |
| | | capsule | | | | position |

TABLE 16
Aerosol generation by pipetting and resuspension

| | | | Average IMD-A 350 | | | |
|---|---|---|---|---|---|---|
| Sample | | | Counts/min | | | Probe |
| ID | Day | Test | ≥0.5 μm | Bio | ≥5 μm | Location |
| 135 | 3 | Water | 0 | 0 | 0 | Capsule/ |
| | | inside | | | | Pipette tip |
| | | capsule | | | | |
| 137 | 3 | Beads | 0 | 0 | 0 | Capsule/ |
| | | inside | | | | Pipette tip |
| | | capsule | | | | |
| 138 | 3 | Bacteria | 0 | 0 | 0 | Capsule/ |
| | | inside | | | | Pipette tip |
| | | capsule | | | | |
| 141 | 3 | Bacteria | 0 | 0 | 0 | Capsule/ |
| | | inside | | | | Pipette tip |
| | | capsule | | | | |

Conclusions

All the above results from biosafety testing show that the HEPA filter serves to eliminate any aerosols that may have been generating within the instrument during both the pipetting and resuspension portions of the assay. This testing was meant to stress the system having sample loaded on the outside of the capsule and in all cases the HEPA filter was able to remove the aerosols generated. Pipetting and capping/uncapping portions of the assay pose no risk of aerosol generation based on this testing. In addition, there is a one-minute delay between pelleting and any pipetting steps as a risk mitigation in the event that an aerosol is generated as it will settle within a minute.

Additional Description

According to one aspect, electronic control of the automated sample preparation system can be accomplished by a control circuit that also communicates with a second instrument, such as an automated microbial identification and antimicrobial susceptibility instrument. In this way, sample that has been prepared in the automated sample preparation system can be transferred to the second instrument, such as via the same sample container, and electronic identification of the sample container can be maintained while processing takes place in the second instrument, which reduces the chances of misidentifying a sample and increases throughput.

According to one method of preparing a patient sample for microorganism analysis, the method comprises:
a. introducing a patient sample to a capsule rotor of an automated sample preparation system;
b. introducing one or more reagents to dilute the patient sample;
c. introducing an internal standard suitable for tracking loss of the patient sample during centrifugation; and
d. centrifuging the patient sample through an acceleration and deceleration cycle in one direction and then again in the reverse direction to pellet the sample on an equatorial plane of the capsule rotor, thereby separating the sample from the dilution reagent.

Thereafter, the dilution reagent may be removed from the capsule rotor.

The dilution and centrifugation steps may be performed once or may be repeated one or more times, followed by resuspending the pelleted patient sample in a liquid medium and assessing the amount of sample lost using the internal standard.

The resuspended patient sample then may be removed from the capsule rotor. Optionally, the resuspended patient sample may be incubated in the capsule rotor for a period of time sufficient to increase a microbial cell population to a threshold level in the sample before removal.

The method can also comprise transferring the resuspended patient sample to an automated system configured to identify one or more microorganisms from the patient sample, and, optionally, to obtain antimicrobial susceptibility of the one or more identified microorganisms.

According to another aspect, a kit comprises a single-use disposable capsule rotor, one or more reagent cartridges containing reagents and pipette tips. The kit can be adapted and configured for use in the automated sample preparation system. In some implementations, one or more components of the kit can be encoded with an RFID tag, and the RFID tag can be updated to reflect a change in status, such as after the kit is opened or after a component of the kit is used.

1. An automated sample preparation system comprising:
a centrifuge station having a capsule rotor seat shaped to receive a capsule rotor and configured to cause the capsule rotor to rotate at high speeds during centrifuging, the centrifuge station having a vertical common rotation axis and a chamber member that can be moved along the vertical common rotation axis to open and close an area surrounding the capsule rotor during centrifuging;
a movable stage having a reagent cartridge receiving area configured to receive a removable reagent cartridge;
a pipettor unit having a base and a movable pipetting section;
a capper mechanism having a movable distal end that is controllably movable in a vertical direction along the vertical common rotation axis; and
a control circuit with a controller programmed to control operation of the centrifuge station, the movable stage, the pipettor unit and the at least one capper mechanism during operation of the automated sample preparation system.

2. (canceled)

3. The automated sample preparation system of claim 1, wherein the movable stage further comprises a sample container receiving area positioned radially outward of the capsule rotor seat and configured to receive a removable sample container, the removable sample container including a removable cap.

4. The automated sample preparation system of claim 3, further comprising a second capper mechanism configured to uncap and recap the removable sample container.

5. The automated sample preparation system of claim 1, wherein the removable reagent cartridge comprises a plurality of reagent receiving wells having different reagents contained therein, and wherein the reagent wells are rotatable into alignment with the pipettor unit.

6. The automated sample preparation system of claim 5, wherein the pipettor unit is further configured to controllably transfer waste liquid from the capsule rotor to a reagent receiving well on the removable reagent cartridge.

7.-12. (canceled)

13. The automated sample preparation system of claim 1,
wherein the movable pipetting section is controllably movable in a horizontal plane perpendicular to the vertical common rotation axis among at least first and second pipetting positions aligned above the reagent cartridge receiving area and the capsule rotor seat, respectively.

14. The automated sample preparation system of claim 1, wherein the pipettor unit and the capper mechanism are configured to move together towards and away from the movable stage along a horizontal track.

15. The automated sample preparation system of claim 1, wherein the pipettor unit and the capper mechanism are configured to move vertically together along a vertical track.

16. The automated sample preparation system of claim 1, wherein the movable stage has a rounded forward side and a partially cylindrical shape, and wherein the vertical common rotation axis is distanced from a geometric center of the partial cylindrical shape.

17.-19. (canceled)

20. The automated sample preparation system of claim 13, wherein the movable pipetting section is movable horizontally by translation and rotation about a vertical axis, and further moveable vertically at the first and second pipetting positions to withdraw and deliver liquid.

21.-24. (canceled)

25. The automated sample preparation system of claim 1, wherein the removable capsule rotor further comprises a removable cap; wherein
the movable stage is controllably movable in two directions along an operation path among at least a load position, a centrifuging position aligned with the centrifuge station and a pipetting position;
wherein the movable stage in the pipetting position is positionable below the movable pipetting section such that pipetting actions can be carried out between the reagent cartridge and the capsule rotor;
and wherein the movable distal end of the capper mechanism is controllably movable between a lowered position in which the movable distal end is positioned for uncapping and recapping the capsule rotor and a raised position in which the movable distal end is raised to a height above the movable stage.

26.-29. (canceled)

30. The automated sample preparation system of claim 1, wherein
the movable stage is controllably movable in two directions along an operation path among at least a load/unload position, a centrifuging position aligned with the centrifuge station, a pipetting position and one or more uncapping/recapping positions;
and wherein the movable stage in the pipetting position is positionable below the movable pipetting section such that pipetting actions can be carried out between the reagent cartridge and the capsule rotor with the movable pipettor section moving in one or more of a Z-axis direction and a θ angle in a plane perpendicular to the Z-axis.

31. The automated sample preparation system of claim 4, wherein the removable capsule rotor is housed in and rotatably supported by a capsule rotor apron, the capsule rotor further comprising a removable cap; wherein the capsule rotor seat is configured to cause the capsule rotor to rotate at high speeds within the capsule rotor apron during centrifuging while maintaining the apron in a stationary position.

32.-36. (canceled)

37. The automated sample preparation system of claim 31, wherein at least one of the two capper mechanisms comprises a pair of grippers configured to passively encompass the capsule rotor cap when the capsule rotor is placed into position via movement of the movable stage, the pair of grippers being controllable to move vertically upward to remove the capsule rotor cap and vertically downward to install the capsule rotor cap.

38. The automated sample preparation system of claim 37, further comprising one or more reflective fiber optic LED units configured to indicate a location of the capsule rotor cap in relationship to the pipettor unit.

39. The automated sample preparation system of claim 1, further comprising an electrical shunt system configured to decelerate the capsule rotor upon completion of centrifuging by dissipating energy.

40.-63. (canceled)

64. The automated sample preparation system of claim 13, wherein the pipettor unit is controllably movable in the horizontal plane between a third pipetting position above the sample vial receiving area and the second pipetting position above the capsule rotor seat in sample transfer operations.

65. The automated sample preparation system of claim 1, wherein the movable stage is controllably rotatable independently of the capsule rotor seat about the vertical common rotation axis, and wherein the reagent cartridge receiving area is positioned radially outward of the capsule rotor seat.

66. The automated sample preparation system of claim 1, wherein the movable pipetting section is positioned above the rotatable stage such that the rotatable stage can be rotated to align the reagent cartridge receiving area below the movable pipetting section.

67. The automated sample preparation system of claim 25, wherein the movable distal end is controllably movable between a lowered position in which the movable distal end uncaps and recaps the capsule rotor and a raised position in which the movable distal end is raised to a height above the pipettor unit.
